(19) United States
(12) Patent Application Publication
(10) Pub. No.: US 2005/0268279 A1
(43) Pub. Date: Dec. 1, 2005

(54) Automated multimedia object models

(75) Inventors: Richard B. Paulsen, Pleasant Grove, UT (US); Chett B. Paulsen, Sandy, UT (US); Edward B. Paulsen, Draper, UT (US); Lawrence Richard Burmester, South Jordan, UT (US)

Correspondence Address: Parsons Behle & Latimer, 201 South Main Street, Suite 1800, P.O. Box 45898, Salt Lake City, UT, 84111, US

(73) Assignee: Sequoia Media Group, LC

(21) Appl. No.: 11/051,616

(22) Filed: Feb. 4, 2005

Related U.S. Application Data
(60) Provisional application No. 60/542,818, filed on Feb. 6, 2004.

(51) Int. Cl. G06F 9/44

(52) U.S. Cl. 717/110

(57) ABSTRACT

Disclosed herein are systems and methods for creating multimedia presentations from presentation templates and/or multimedia object models. Detailed information on various example embodiments of the inventions are provided in the Detailed Description below, and the inventions are defined by the appended claims.

### CROSS REFERENCE TO RELATED APPLICATIONS

This Application claims the benefit of the U.S. Provisional Application No. 60/542,818 filed Feb. 6, 2004, which is hereby incorporated by reference in its entirety.

### BACKGROUND

In recent years, computer manufacturers have focused their development, design and marketing resources on providing hardware and/or software to consumers of “multimedia” (photographs, videos and audio recordings, document and text files). FIG. 33 shows the many hardware and software components, as well as many of the user areas of expertise and contribution, required to produce a final multimedia production. Typical industry have focused enhancements or technical solutions on the hardware aspects of the media production process 3301, with random and disjoint efforts on the software processes 3302, leaving little effort and automation to the user's contributions 3303.

Referencing FIG. 33, Hardware 3301 describes the physical part of the computer system, the machinery and equipment. This represents devices such as digital cameras, scanners, printers and other media related equipment. These hardware components produce raw digital media that can be processed and refined by specialized software solutions, such as photo and video editors.

Software 3302 contains the computer program or application that tells a computer what to do. In the case of multimedia, this may include video and photo editing capabilities and the ability to burn various forms of output media. Nonetheless, very few software tools offer a complete start-to-finish solution that relieves the user from becoming an expert in multimedia editing and processing.

The User 3303 brings various capabilities, media, and knowledge to the production process. This primarily includes creativity, vision, organization, motivation, and ability contributed through learning and personal expertise of the user. The automation of this area remains largely unsolved and is an area where the systems and methods described herein provide an innovation for the comprehensive and complex needs of multimedia consumers that allow the simple organization and construction of finished multimedia productions.

Last, Final Production 3304 is the resulting output from the combination of hardware, vendor software, and user input. A product may access the latest innovations in hardware with underlying software component drivers, via a well-populated and complex set of methods, to alleviate the complex user input decisions and produce final multimedia productions.

### BRIEF SUMMARY

Disclosed herein are systems and methods for creating multimedia presentations from presentation templates and/or multimedia object models. Detailed information on various example embodiments of the inventions are provided in the Detailed Description below, and the inventions are defined by the appended claims.

### BRIEF DESCRIPTION OF THE DRAWINGS

FIG. 1 depicts a conceptual view of an exemplary heirarchical structure of media data classes.

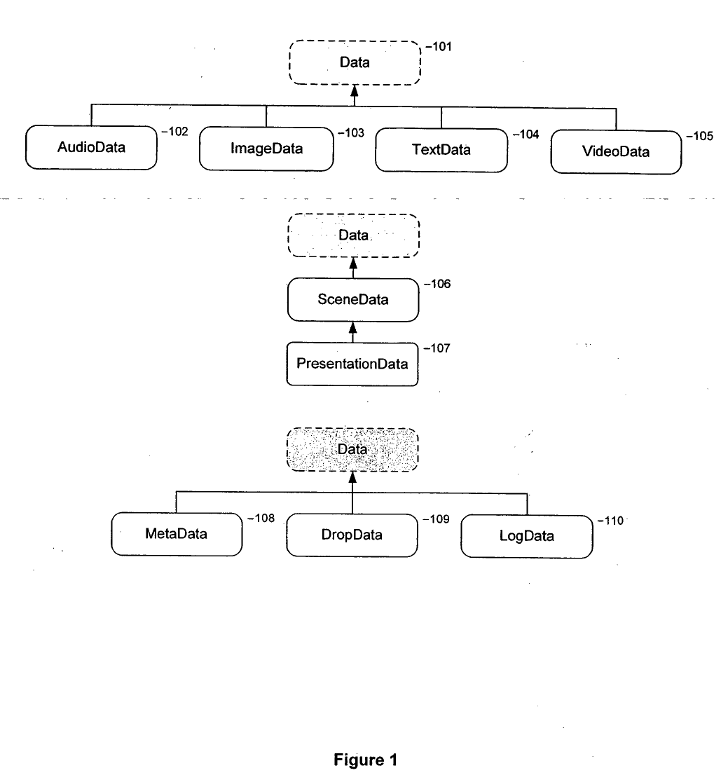

FIG. 2 depicts a conceptual view of an exemplary heirarchical structure of render effect classes.

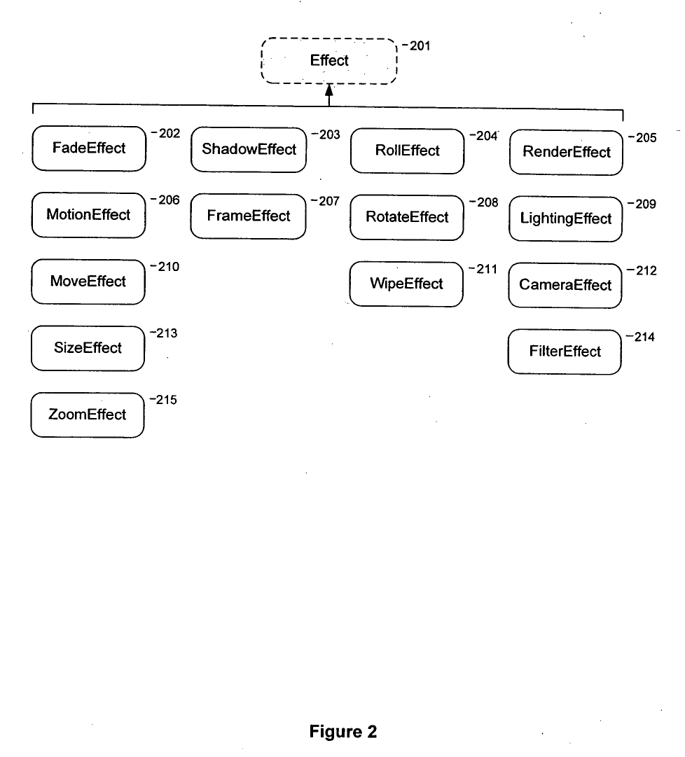

FIG. 3 depicts a conceptual view of an exemplary heirarchical structure of media element classes.

FIG. 4 depicts a conceptual view of an exemplary heirarchical structure of render subgraph classes.

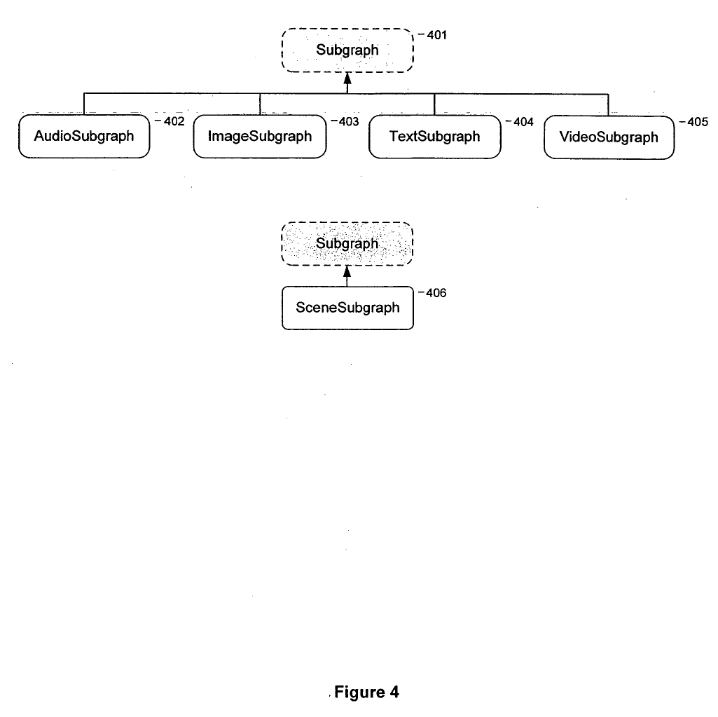

FIG. 5 depicts a conceptual view of an exemplary heirarchical structure of media requirements classes.

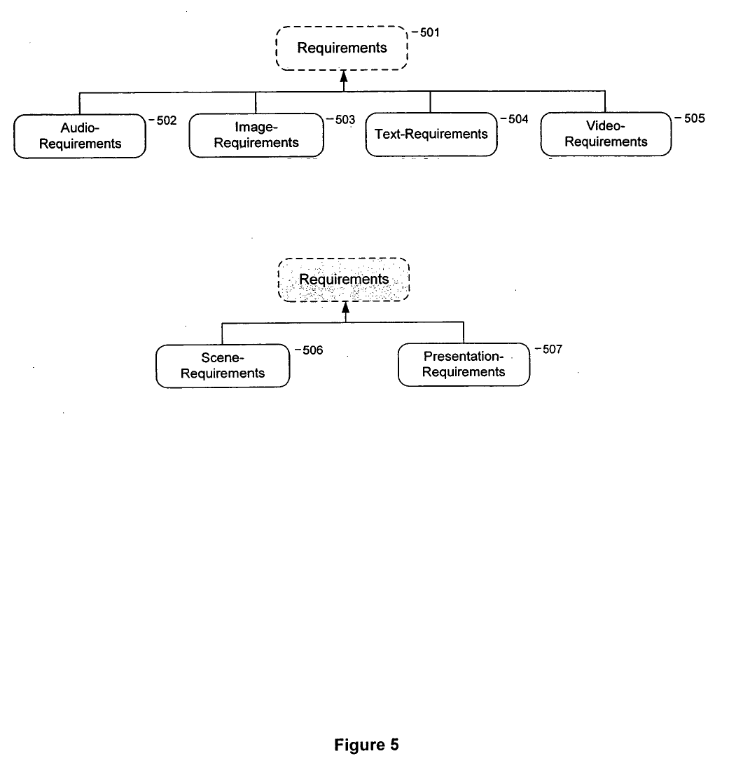

FIG. 6 depicts a conceptual view of an exemplary organizational layout of primitive multimedia elements.

FIG. 7 depicts a conceptual view of an exemplary organizational layout of advanced elements.

FIG. 8 depicts a color identification scheme for multimedia objects

FIG. 9 depicts a process flow for processing raw media to a finished production.

FIG. 10 depicts an exemplary hierarchal structure associated with the loading and storing of system and user media.

FIG. 11 depicts a sample theming of cruise presentations.

FIG. 12 depicts a generic element assembly hierarchy for applying a template to completion.

FIG. 13 depicts a progressive theme management categorization with categories, sub-categories and themes.

FIG. 14 depicts a detailed layout of an exemplary render module.

FIG. 15 depicts a detailed layout of an exemplary package hierarchy, including server media, client media, application components, theme trees and database modules.

FIG. 16 depicts a conceptual layout of presentation templates.

FIG. 17 depicts a conceptual layout of production templates.

FIG. 18 depicts a conceptual layout of scene templates.

FIG. 19 depicts a detailed design of a database control module.

FIG. 20 illustrates a presentation of an exemplary distributed architecture for automated multimedia objects.

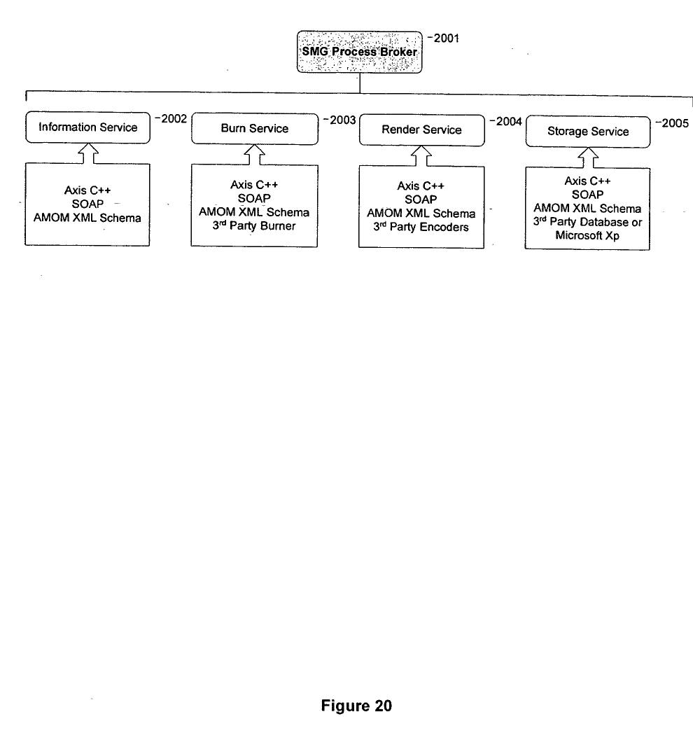

FIG. 21 depitcts a sample presentation layout with blank media slots.

FIG. 22 depicts a sample presentation layout with filled user media.

FIG. 23 depicts in detail a burn process module.

FIG. 24 depicts a generic five step production creation process.

FIG. 25 depicts a sample DVD layout with blank media slots.

FIG. 26 depicts a sample DVD layout with a wedding theme.

FIG. 27 depicts a sample DVD layout with a volleyball theme.

FIG. 28 depicts an exemplary presentation media editor.

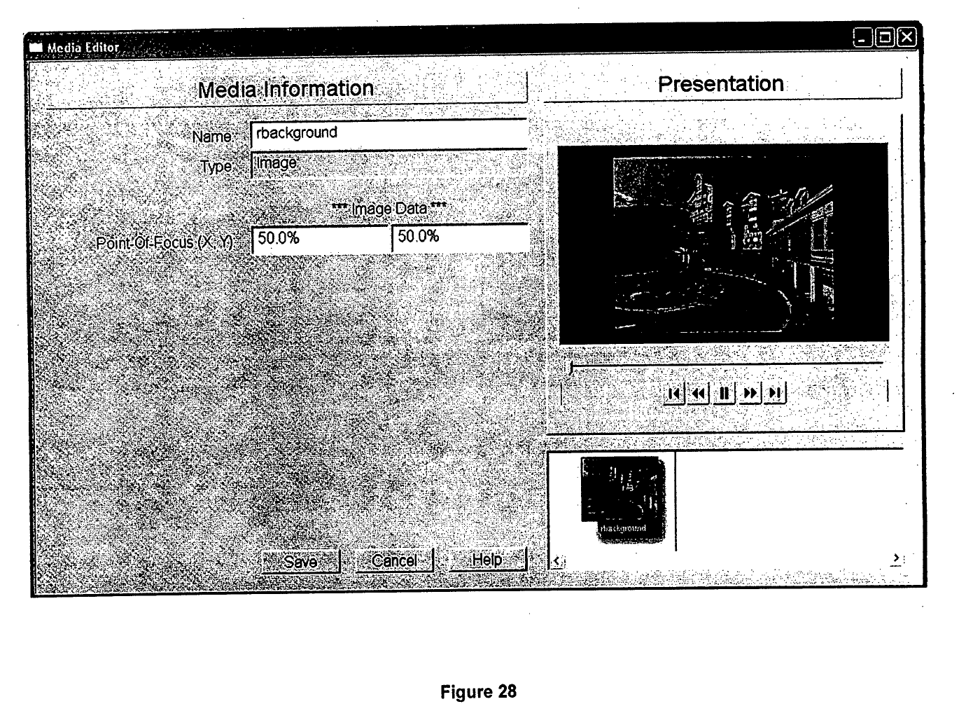

FIG. 29 depicts a sample media with pixel shaders.

FIG. 30 depicts the control and interaction of presentation scenes.

FIG. 31 depicts sample media with an applied roll effect.

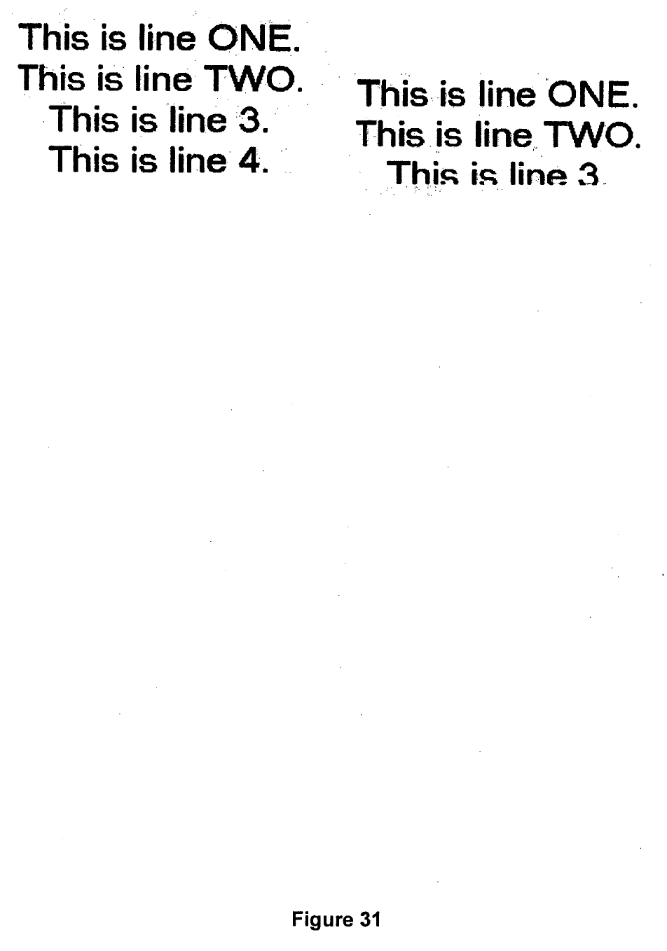

FIG. 32 depicts a sample presentation with blank media slots.

FIG. 33 depicts industry identified multimedia components with user, hardware and software inputs.

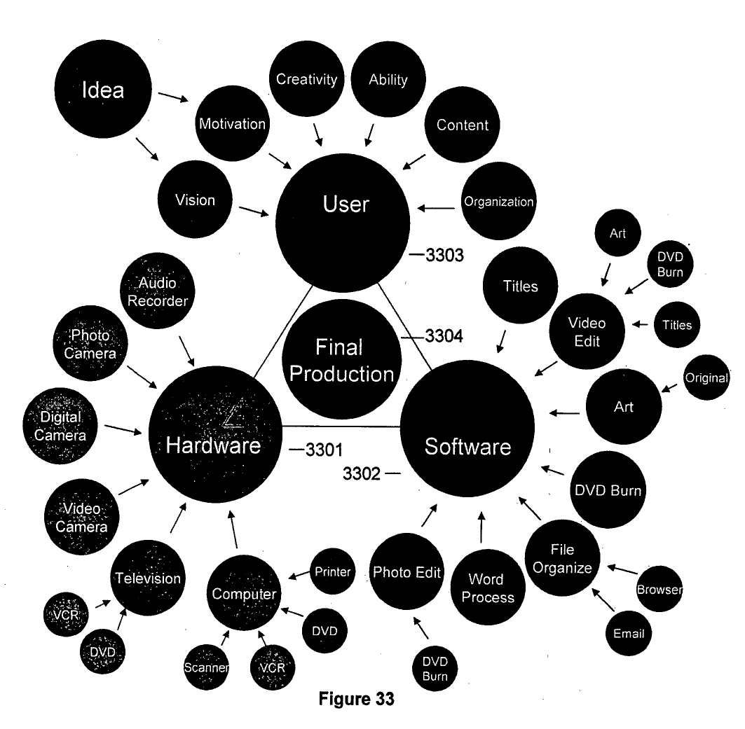

FIG. 34 depicts multimedia components addressed by an automated mutimedia objects architecture and methods.

FIG. 35 depicts a reference implementation of a burn process module.

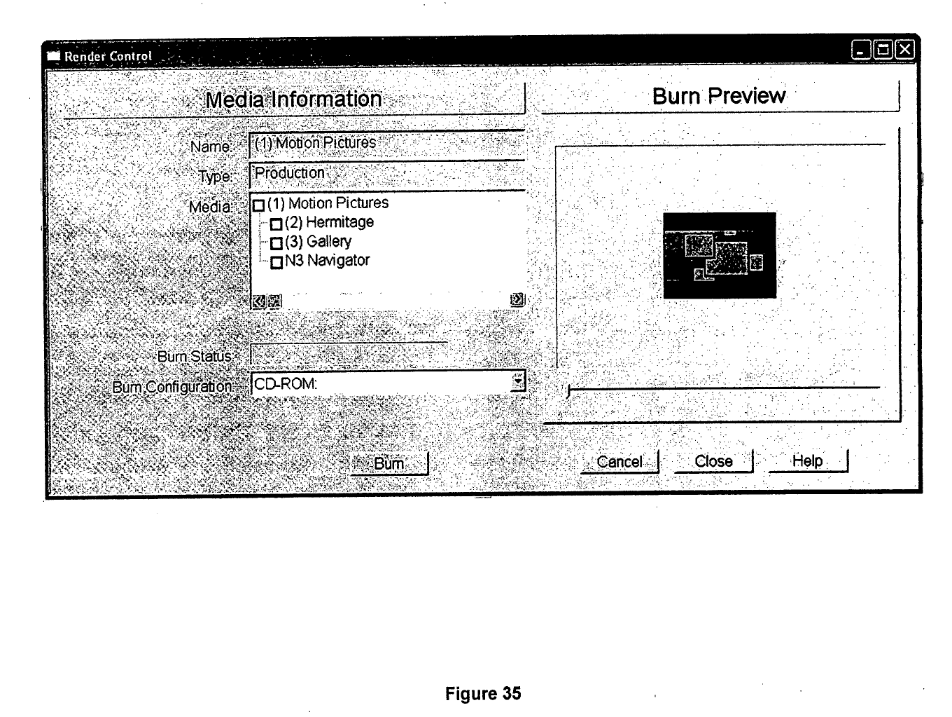

FIG. 36 depicts a reference implementation of multimedia editing.

FIG. 37 depicts a sample presentation with a school days theme.

FIG. 38 depicts a reference implementation of DVD layout selection and creation.

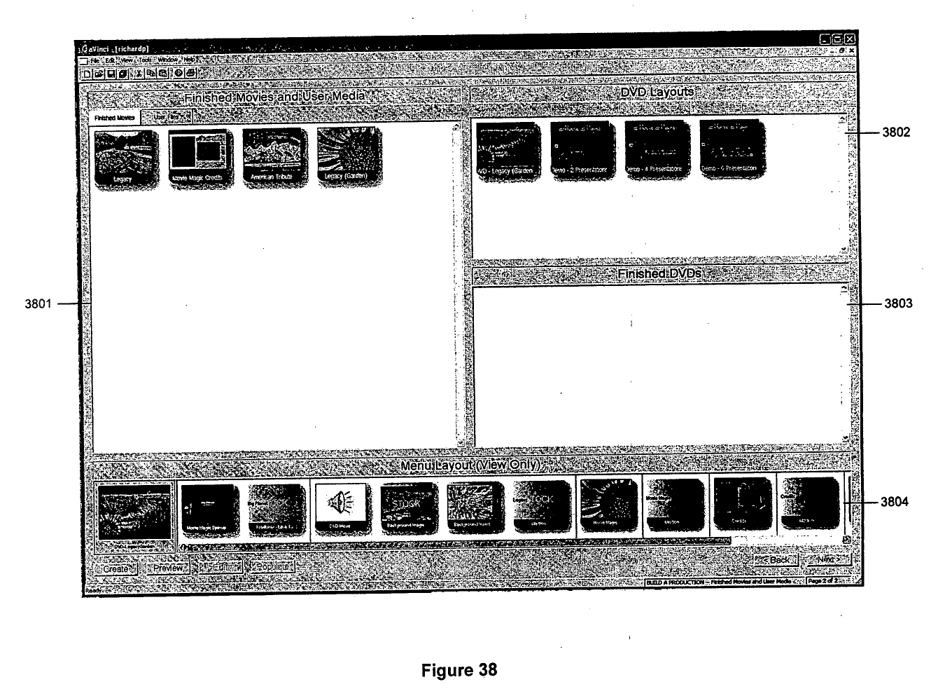

FIG. 39 depicts a sample media with applied fade effect.

FIG. 40 depicts a sample media with applied frame effect.

FIG. 41 depicts a sample media with applied rotate effect.

FIG. 42 depicts a sample media with applied motion effect.

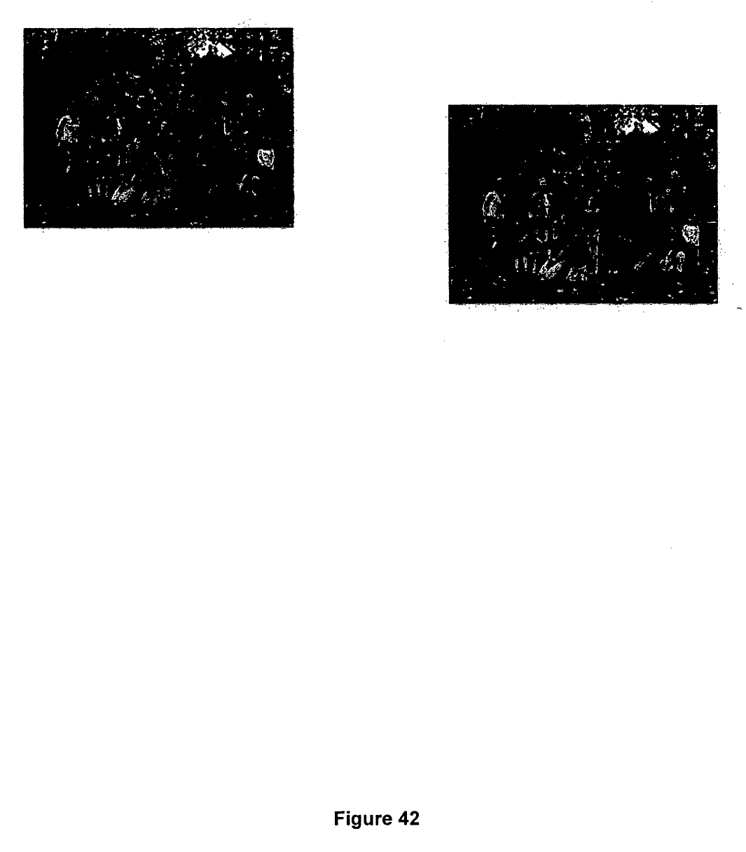

FIG. 43 depicts a sample media with applied shadow effect.

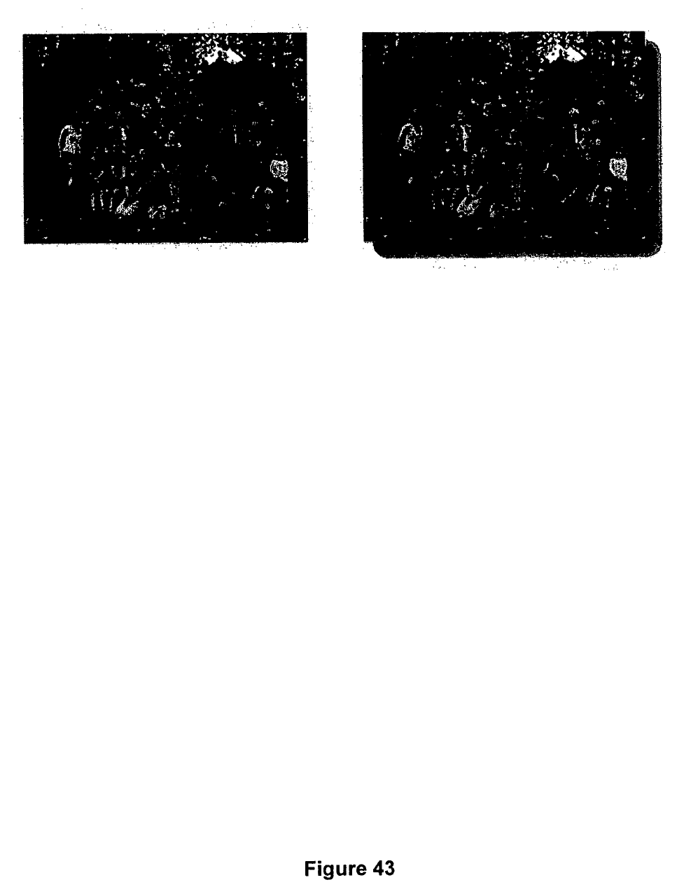

FIG. 44 depicts a sample media with applied size effect.

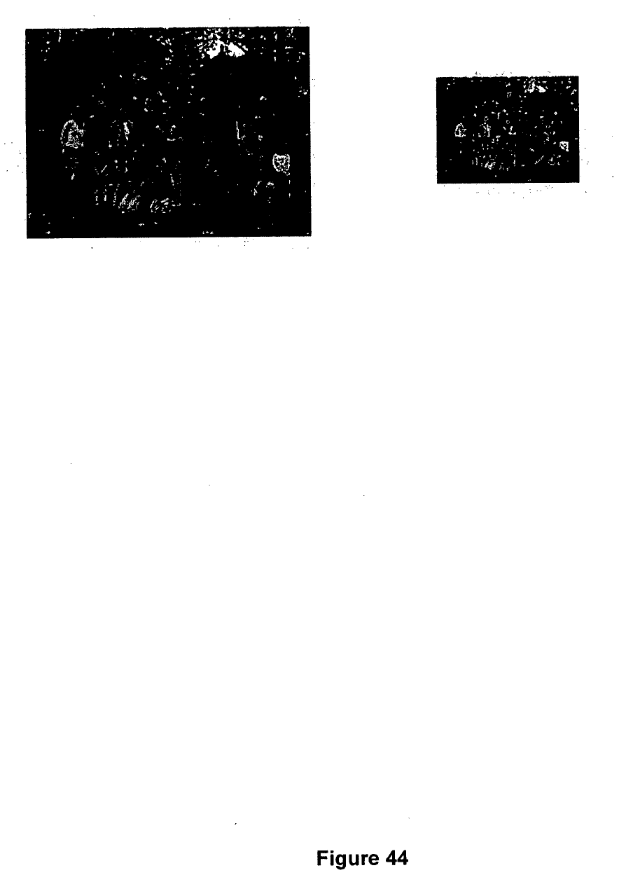

FIG. 45 depicts a sample media with applied zoom effect.

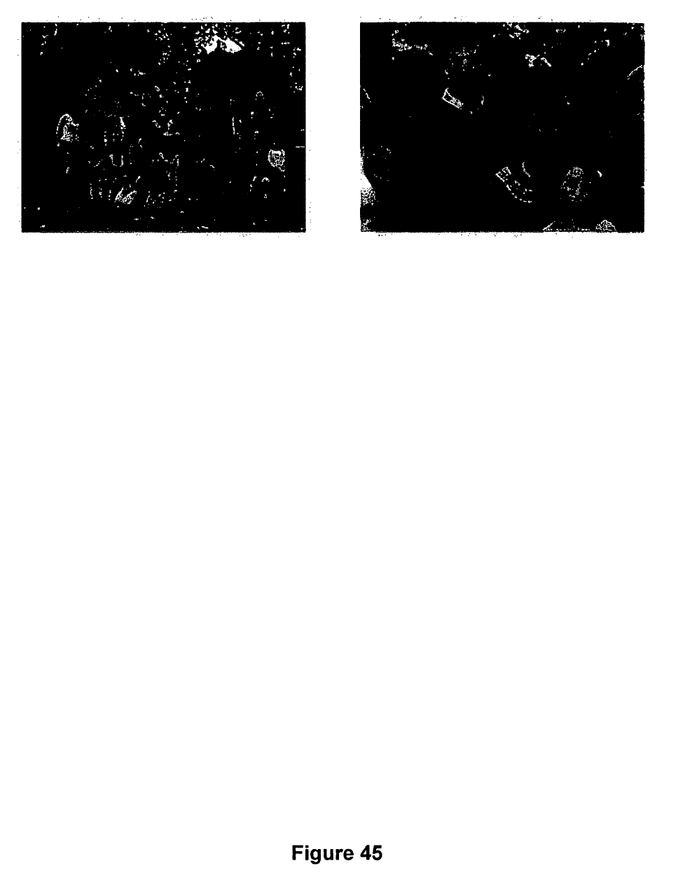

FIG. 46 depicts a sample media with applied wipe effect.

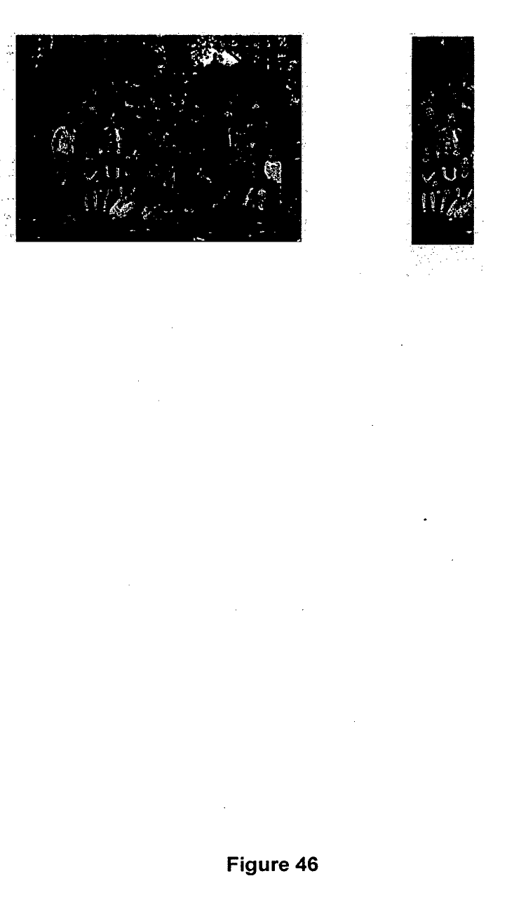

FIG. 47 depicts a reference implementation of a render process module.

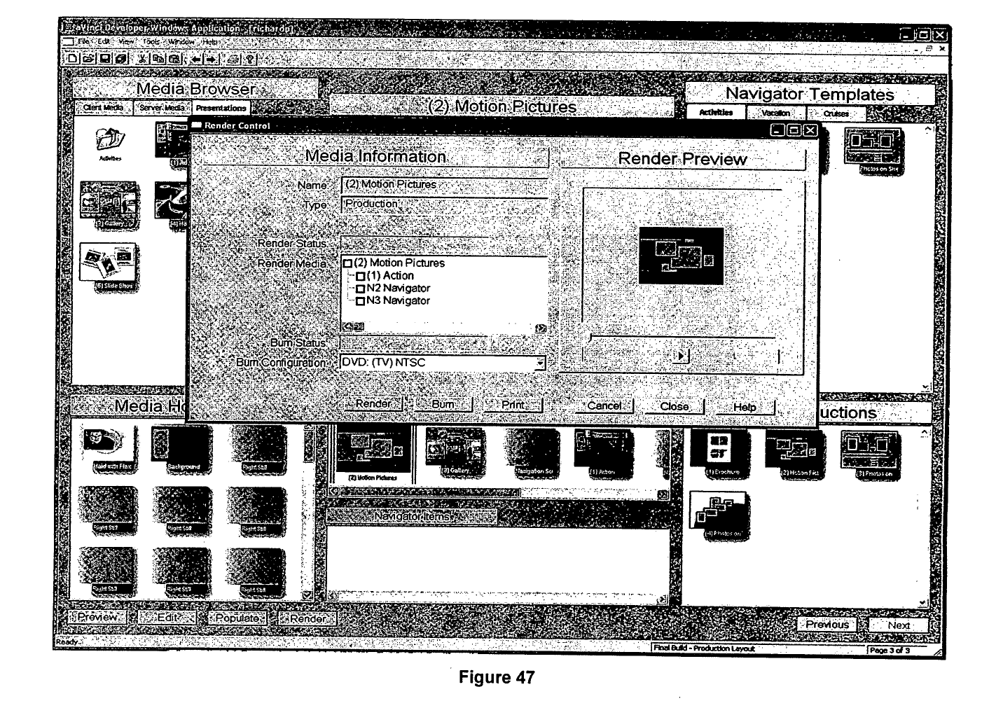

FIG. 48 depicts a sample program group categorization.

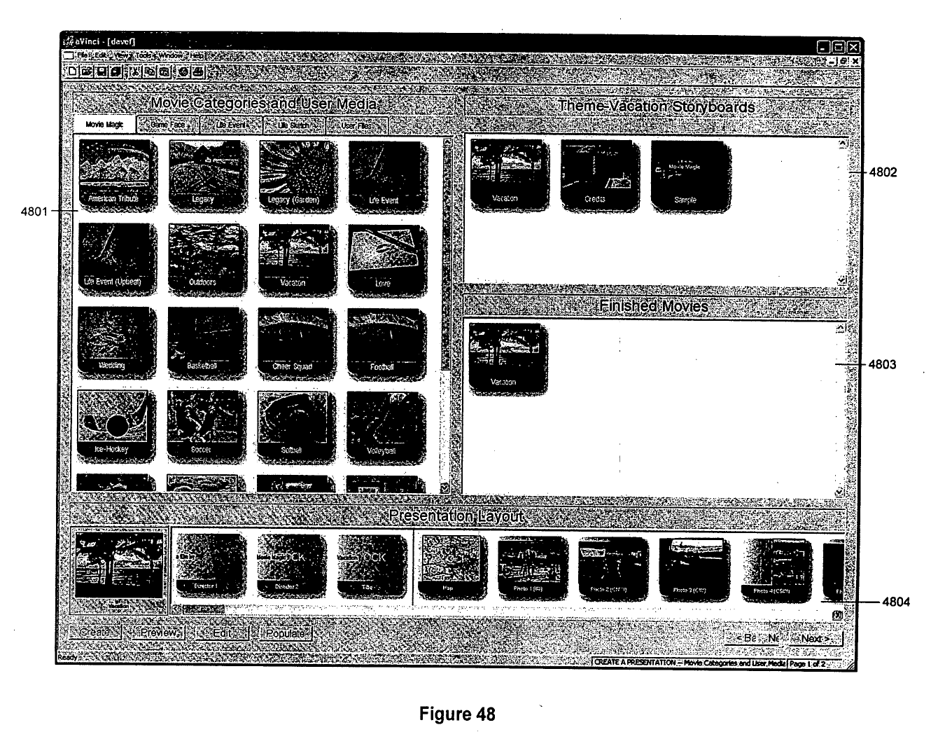

FIG. 49 depicts a sample ‘game face’ group categorization including a sports hierarchal structure.

FIG. 50 depicts a sample ‘life event’ group categorization.

FIG. 51 depicts a sample ‘life sketch’ group categorization.

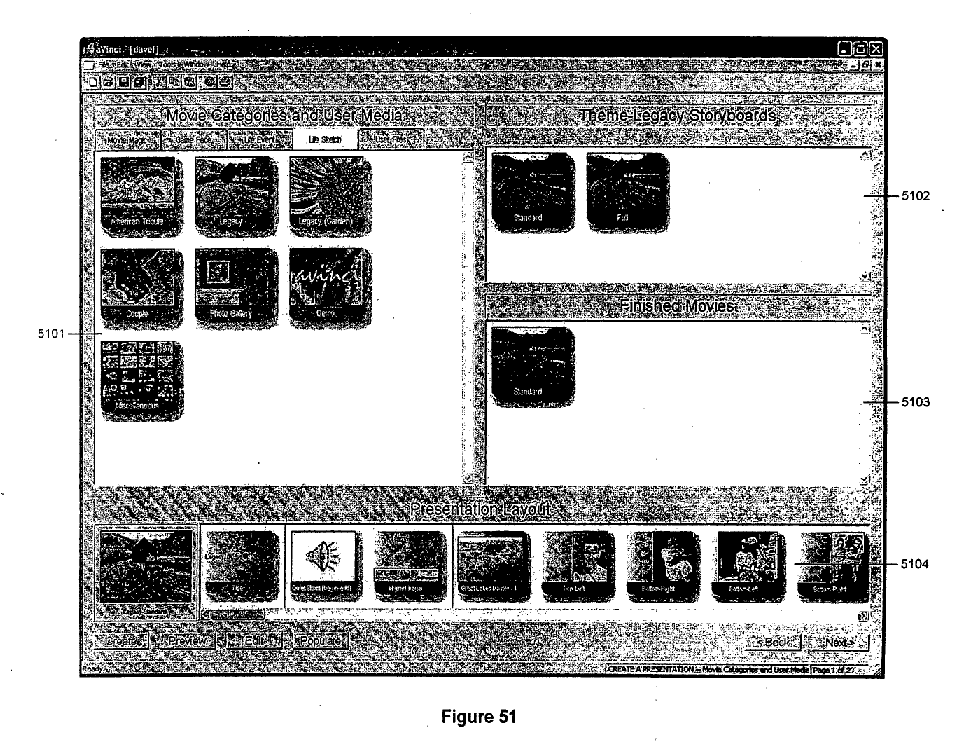

FIG. 52 depicts a reference implementation of a production building process.

FIG. 53 depicts a sample presentation with an outdoors theme.

FIG. 54 depicts a sample presentation with a legacy theme populated with user data.

FIG. 55 depicts a sample presentation with a golf theme containing textual information.

FIG. 56 depicts a reference implementation of a primitive elements characteristics editor.

FIG. 57 depicts a reference implementation that browses user media within the context of presentations and productions.

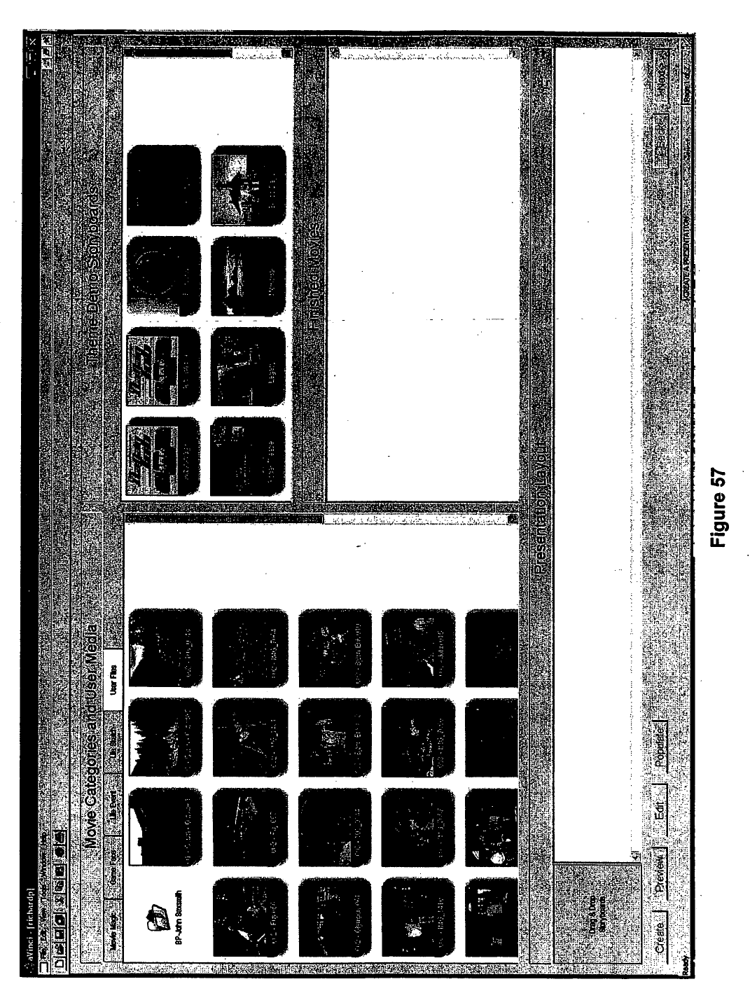

Reference will now be made in detail to electronic conferencing systems incorporating pods which may include various aspects, examples of which are illustrated in the accompanying drawings.

### DETAILED DESCRIPTION

To facilitate the understanding of concepts related to the disclosure below, several phrases are now introduced. The definitions or meanings noted here are merely exemplary or conceptual in nature, and are not given to limit the discussion below. Rather, the reader may apply meanings to any of the terms introduced which agree with the discussion or provide objects that serve similar functions or purposes, as understood by one of ordinary skill in the art. Additionally, the introduced terms may be used in a number of contexts, and may take on meanings other than those listed below.

Assembly: methods used to combine user media with other system assemblies. These assemblies form primitive elements, and ultimately, the combination of primitive and advanced elements form finished presentations and productions.

Audio: music or spoken audio either in the form of tapes, or digitally captured files that can be incorporated into a multimedia production, including industry standard extensions including .aif, .mp3, etc.

Auto-Populate: ability of the application to execute a predetermined ‘populate’ algorithm, or set of instructions, to insert user elements into a presentation template, resulting in the finished presentation and/or production with minimal intervention by the user.

Branding: the combination of imagery and message used to define a product or company. The method of combining elegant but simple software solutions with unique methods or presentation items (including colors, background images, corporate look-and-feel) that are seen as reinforcing or producing a corporation's identity.

Bug: identifying mark superimposed with an element in a scene to comment on or identify a producer, owner, or creator.

Caption: brief description accompanying an image expressed as text or color alphabet objects in a dominant layer to comment on, add context or identify what is happening in a scene.

Category: first order method of organizing themes based on specific areas of interest or relevance.

Choose: initial activity in an application where the User chooses a presentation or production to build from a themed presentation template. The method includes selecting a broad category, a more refined sub-category, and an associated set of specific themed presentations.

CD-ROM: Compact Disc Read-Only Memory. An optical disc that contains computer data.

Cinematic Language: the juxtaposition of shots by which the film's discourse is generated. The cognitive connection of shots is conveniently based on a set of rhetorical patterns which provide coherence to the linear chain of shots assisting the viewer in recognizing the articulation of a discourse.

Cinematic Templates: templates that are designed to reproduce a specific cinematic ‘look and feel’ by using only editing techniques such as cut, dissolve, flash and traveling matte.

Color Alphabet: a digital representation of fonts with the added ability to add color, opacity, style and animation.

Credits: presentation similar to movie credits where participants (e.g., director, editor) in the creation of the production are identified.

Document: written information presented in various rich text or html formats.

DVD: Digital Versitile Disc or Digital Video Disc. An optical storage medium which can be used for multimedia and data storage.

Element: basic combination of multimedia items; such as photographs, images, video clips, audio clips, documents, and textual captions, with defined programmed behavior and characteristics.

Element Attributes: consist of the type, behavior and characteristic of the individual element.

Element Behavior: describes the way elements, scenes and presentation templates including movement, transition in, transition out, timing, duration, rotation, beginning and ending position.

Element Characteristics: describes the file type, size, resolution and added attributes like frames, drop shadows, opacity, and color of the element, scene, presentation, production or navigation.

Element Object Model: specification of how elements in a production are represented, it defines the attributes associated with each element and how elements and attributes can be manipulated.

Encapsulation and Object Orientation: method of organizing concepts into objects and concepts into hierarchal structures. Object orientation may be used to represent themes and theme categories, to construct primitive elements, and to produce components that represent, present, render, and burn finished presentations and productions.

Encryption: putting data into a secret code so it is unreadable except by authorized users or applications.

Global Message, Local Voice: catch phrase used to represent the ability of the application to customize and personalize a Corporation's widely distributed marketing messages by inserting messages or media at a local level.

Granularity: describes the level of specificity contained in a Category, Theme or Presentation.

Fonts: a complete set of type characters in a particular style and size specifically the digital representations of such characters.

Images: a picture. Images on a computer are usually represented as bitmaps (raster graphics) or vector graphics and include file extension like .jpg, .bmp, .tif

Immediacy: the need to produce something within a short period of time.

Introduction: a specific type of presentation meant to act in a manner to a cinematic trailer or advertisement of ‘coming attractions.’

Kiosk: multi-media enabled computer, monitor, keyboard and application housed in a sturdy structure in a public place.

Layers: hierarchical organization of media elements determining field dominance and editability. Layers contain individual Element Object Models.

Main Production: a specific type of presentation designed to tell or advance the storyline in a more complete, in-depth or focused form.

Modules: Object structures and associated lines of code the provide instruction and definition of behavior, characteristics, and transitions for multimedia elements, presentations, navigators, productions, and program process flow.

Multimedia: communication that uses any combination of different media. Multimedia may include photographs, images, video and audio clips, documents and text files.

Multimedia Navigation: ability to select, move forward or back, play fast or slow within a production or presentation.

Narrative Structure: storyline in a play or movie, the sequence of plot events.

Navigator: specific type of presentation inserted into the production that provides the user with the ability to link to specific portions of the production through predetermined hyperlink instructions provided in the program. Navigators may also contain DVD instruction sets that include Chapters and Flags.

Non-Secure Layer: an Element Object Model where the element can be replaced or edited by the User.

Object: data item with instructions for the operations to be performed on it.

Package: a software collection of Element Object Model components including theme trees, stock media collections, databases, project defaults, etc. Packages may be combined to produce multi-pack projects.

Personal Selling: a sales method where the transaction is completed between two more individuals in a personal setting.

Populating Multimedia: a method or process where multimedia elements (photos, images, audio clips, video clips, documents, text files) are automatically introduced into Element Object Models that have been organized as presentation templates. Source media may be introduced by any data transfer method including memory sticks, wireless or wired networks, directories on a computer, or other hardware. Organization of digital media files can be by name, date, theme, or other advanced media analysis technique.

Presentation: a Presentation Template that has been populated with User contributed elements and context.

Presentation Template (Storyboard): a number of predefined scenes organized together with scene transitions using artistic, cinematic or narrative structure.

Presentation Types: includes introduction, main body, credits and navigator presentation types.

Production: a production template that has been populated with User contributed elements and context. Completed productions can be saved, rendered or burned to CD-Rom or DVD

Production Template (Layout): a collection of presentation types which may contain an introduction, main body, navigator, and credits.

Recent and Relevant: issues that are of interest because they are considered current (recent) or of specific interest (relevant).

Render: faithfully translate into application-specific form allowing native application operations to be performed. The method of converting polygonal or data specifications of an image to the image itself, including color and opacity information.

Scene: a collection of any number of Element Object Models, working in layers together or juxtaposed to create artistic or narrative structure.

Secure Layer: an Element Object Model that cannot be changed or modified by the User

Shoebox: a method of storing images, a cardboard container or its digital equivalent in an unstructured or random framework.

Skins: an alternative graphical interface such as the ability to personalize or customize the applications User Interface (UI) to a specific need, implementation or User requirement.

Template: describes the ‘state’ of a production prior to User contributed elements.

Theme and Theming: a second order method of organizing presentations based on specific areas of interest or relevance.

ThemeStick: removable, portable digital media (CompactFlash, SmartMedia, Memory Stick etc.) identified by theme that contains vendor-defined preloaded theme specific templates that are automatically populated as Users take digital photos or videos.

Titles: written material in the digital form of text or color alphabet to give credit, represent dialog or explain action.

Video: a series of framed images put together, one after another to simulate motion and interactivity, motion pictures, home video, that can be digitally reproduced, including industry digital signature of .avi, .m2v, .mp4, etc.

Viral Marketing: the business method whereby Users of the method distribute the company's application by creating copies of their own finished productions and distributing them without the necessity of the company intervening.

Virtual Templates: templates using computer generated artificial 3D virtual environments.

Web: the World Wide Web or the Internet.

Introduction

Disclosed herein are systems and methods for utilizing automated multimedia object models (AMOM.) Using AMOM techniques, the creation of personalized multimedia productions may be automated from start to finish. Using AMOM expressions, designers may build persistent multimedia templates that a user may personalize and author a professional looking production using their own images, video, audio or documents sometimes with as little as a single mouse click. AMOM expressions may be designed to capture narrative structure and cinematic language while using stock media in the form of animations, video, audio, narration, special effects, documents, fonts and images to support and enhance user contributed media. AMOM techniques may be used to combine and automate the traditionally exclusive multimedia disciplines of production design, art direction, presentationing, editing, special effects, animation and media authoring into a single template driven theme specific format. AMOM techniques may permit the creation of complete multimedia productions that can be easily personalized by any end user. Through AMOM techniques persistent behaviors and characteristics may be assigned to individual multimedia elements, which may then be assembled into a well defined hierarchy of scenes, acts, presentations, and productions using a modular construct. The resulting expression provides an automated digital medium authoring product where individual personalized multimedia productions can be created and burned to digital media by a user with a minimal effort.

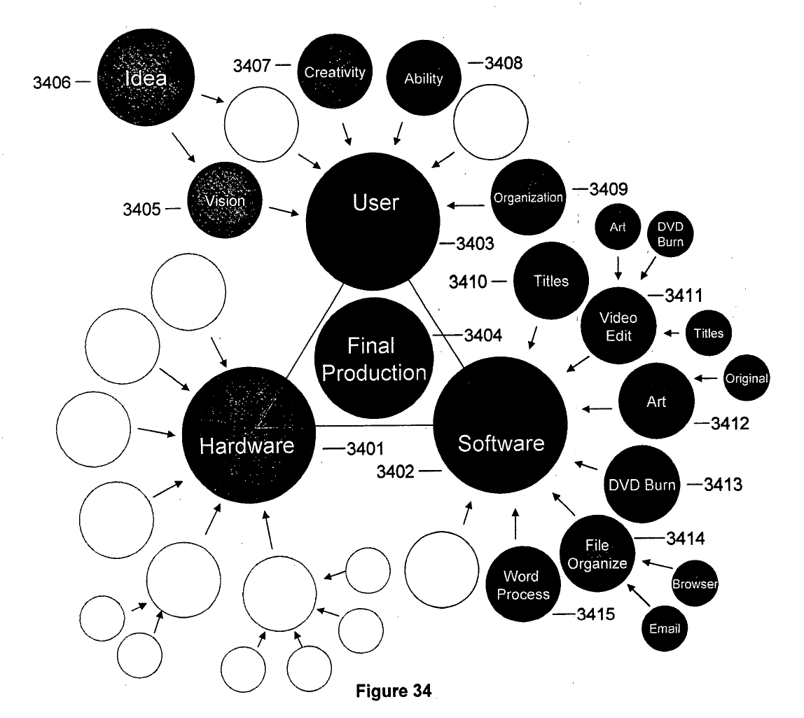

Also disclosed herein is an exemplary product that utilizes AMOM techniques including a set of methods that allow a consumer to view their personal media in a full motion video presentations and then save them on output media such as DVD, CD or Web optimized files. Referring to FIG. 34, an exemplary product optimizes, enhances or supplements several areas:

In the area of user contribution 3403, the exemplary product supplies the vision 3405, creativity 3407, ability 3408 and organization 3409 input requirements through themed presentations and productions that are pre-configured and produced for mass market consumption. The user keeps motivation and content aspects of their contribution, but no longer need to bring the expertise associated with most traditional final production solutions.

In the area of software 3402, the product defines an automated process that combines user media with pre-defined presentations and productions. These materials contain pre-defined titles 3410, theme specific stock art and music 3412, and script the interaction of photographs, images, drawings, captions, video, and audio clips. These materials are well-populated, except empty slots are scripted for user input such as photographs, video clips, captions, and audio sound tracks.

The exemplary product also provides automatic organization, with implied inference, through theme and presentation categorization 3414. Users continue to perform their own specialized photo and video editing, but simply “drop” or “populate” their media into pre-defined themed presentations and productions. Once the user material is added to pre-defined presentations, the software is able to categorize materials based on the theme of selected presentation.

The exemplary product uses existing hardware capabilities 3401, but organizes and harnesses these configurations through the creation, editing, rendering, and burning process. In addition, the product automates the process of assembling user multimedia materials, with pre-defined presentation definitions, software, and hardware capabilities to produce final production 3404.

AMOM techniques may provide and integrate the technical aspects of cinematic production development including scene transitions, special effects, graphic design and narrative structure, while leaving the motivation, content and context aspects of production to the user. These methods allow users to personalize important events from their lives in a professional, organized and sensory appealing manner that can be enjoyed for generations to come. Classic elements of storytelling and citematic production may be automated while yet retaining a professional look and feel.

Speaking at a high level, methods performed by the exemplary product may automate the following processes: (1) collection: the who, what, when, where, and why information and (2) creation: combining these organized materials easily with high quality cinematic Presentation Templates created by experienced graphic designers, videographers and professional storytellers. Presentation Templates may include photographic material, images, video and audio recordings, documents, and text material (multi-media).

Market and Technical Applications

The objectives described above are accomplished through three primary applications and various hardware/software configurations described below. An AMOM system may be configured to:

Capture the Emotion of the Moment—AMOM techniques may permit an ability to mix photographs, images, video and audio clips, document and text materials with professionally produced presentations, allows the customer to capture and present certain emotional settings that are appropriate for their material.

Capture the Narrative Structure—presentations may use methods of effective storytelling, providing structure and outline to the customer's content. This includes providing presentations and production navigation that contains an introduction, a body of presentations, and a conclusion (such as credits or ending scenes).

Raise the Production Quality of Individual Work—Expert work may be isolated into media components. The model is similar to that used by the motion picture industry where specialists are enlisted to perform specific steps associated with a particular method, rather than the whole set of methods. AMOM acts as the director and supplies experts that handle composition, scene transition, motion, special effects, etc. aspects of the media creation.

Use a Cinematic Language to Aid the Storyteller—presentations and software may contain the expertise and combined experience in using a cinematic language. Effects such as fades, dissolves, Ken-Burns effects, and so forth are professionally integrated so the customer can create more effective and emotional storylines and presentations.

Provide Recent and Relevant Experiences—software may allow the user to immediately preview productions using a run-time process control (the .xml file), rather than rendering the productions prior to review by the user. Other solutions require the user to wait until raw material and applied effects are ‘rendered’ before they can be previewed.

Present a Global Message with a Local Voice—a set of methods may allow global Businesses to create core marketing, sales, and presentation materials, but allows local control over certain aspects of presentation and production material. This permits the local branch or division to personalize the corporate message based on need and availability at the local market.

Software Implementations

In this writing, an exemplary software product is referenced and described. That product may be varied in many ways. For example, market and technical objectives can be met by producing and/or distributing the product in several implementations. In one implementation, the product's functions are separated into several component programs.

First, a “Director's Edition” application is responsible for the collection, integration, and mixing of presentation data, called presentation elements. These elements include audio, video, image, and textual information. The application let's users create presentations, and ultimately productions that can be rendered to DVDs, CD-Roms and computer storage. The automated method involves combining users' materials with professional backdrops.

Second, a “Scene Editor's Edition” application is responsible for the editing and integration of scenes, presentations, and presentation templates.

Lastly, “At the Movies” (DVD-Rom, CD-Rom, and PC editions) applications are responsible for the organized presentation of production materials on a given target media.

A software architecture may be used that combines with various Operating System, Windowing, and Target systems to form the following strategies:

Windowing Operating System Implementation—This is a combination of PC hardware and software capabilities (e.g., Microsoft Windows, Linux) with advanced windowing, rendering, display, and output burning mechanisms.

Internet Delivery—This is an internet distribution strategy where consumers preview sample or relevant themed presentations, select those presentations that are relevant to their interests, and download the raw presentation contents for a fee. In addition, new users can download basic versions of production software for use and evaluation.

Gaming Solutions—This is a process where Youth are able to introduce themselves, their art or creative creations into a professionally produced gaming environment. The hardware accommodates various methods of input from the user, allows the consumer to create environments and interactions that they create. The output from this strategy is an environment that brings creative style and learning to a gaming environment.

Internet Sharing—This is an internet sharing strategy where consumers register on-line, create presentations and productions then upload their presentations and raw material for use by themselves or other selected groups. The sharing is determined by the consumers listed relationships and sharing privileges. Although the original content of the presentations and productions belongs to the user, he/she may also allow sharing relationships to replace, share, or contribute to the presentation. The sharing model distributes media content and production processes between clients and servers throughout the total AMOM system, which may be local, enterprise, or universal.

Embedded System Implementations

Embedded system versions of production software are also fashionable in any number of varieties:

Embedded Operation System Implementation—This is a combination of specialized hardware (e.g., Kiosks, Handheld devices, Gaming devices, Cameras, Scanners) with embedded operating systems. This delivery method allows rapid deployment and fulfillment of market needs.

Kiosk—This is a retail distribution strategy where the product, associated presentations, and relevant stock media are placed on easy-to-use kiosks, which are available and immediately accessible throughout the world. Expectation is that the consumer brings materials, in raw or processed form, and within a very short time-frame, can create finished presentations and productions that can be burned to CD-Rom, DVD, or any other multi-media delivery mechanism. The Kiosk also stores basic applications and basic stock media with the delivery media.

An example of such an application is a local Kiosk. The Kiosk contains stock materials, presentation and production templates that are ‘themed.’ The customer brings in their raw content (photos, video clips, audio recordings, documents) where the Kiosk can read or accept the materials. A system then combines the customer content with a specified theme, or set of themes, to produce a final production (e.g, DVD, CD-Rom, or some other multimedia delivery product).

Comprehensive Embedded System Integration—This combination where digital cameras, scanners, wireless and internet communication allow organizations to retool and delivery a total solution, starting with input devices, processing through the internal and external methods discussed in other sections, and ending with DVD, internet, or some other multimedia item deliverable to the customer. Examples of such an implementation are Theme Parks, High End Resorts, Cruise Lines, Conventions, etc. The corporation or a vendor produce high-end presentations with production templates. Customer photo and video shots are taken periodically at specified or ‘scripted’ times and in candid or ‘fun’ moments.

Another example is the comprehensive integration of hardware and software delivery on Cruise lines. In this case, corporate scripts and produces high end productions of the corporate message, predefined excursion spots, and candid traveler spots. End productions are previewed in cabins or Kiosks, and DVDs are produced.

Media Delivery Implementations

Media other than common formats, such as DVD, can be used. A product may be configured to produce a presentation on any number of media formats, for example:

Theme Stick—This combines memory media (e.g., media disks, flash media, memory sticks) where the software, stock media, and empty presentation and production templates reside on the media but are not activated until placed in hardware that reads the media device. In these cases, the memory stick contains particular themes or theme categories, with related presentations. For instance, theme sticks could revolve around holidays and special occasions where the memory stick is purchased primarily because of the theme content (birthday, Christmas, wedding, anniversary, excursion, etc) instead of the pure memory capacity.

Hard Media Implementations—This is a distribution strategy where certain hardware solutions are packaged with authoring and presentation software. Items such as scanners, printers, multimedia conversion hardware, and memory reading devices contain drivers that call the necessary tools. In addition, portable memory devices such as USB devices, memory storage, etc. contain data as well as software applications.

Distribution Models

A product may use any number of distribution models aid in the fulfillment of market requirements and requests:

Retail Consumer—This is the method used to copy authoring and presentation software that are sold with selected “Themed” packages (e.g., holidays, special events, life sketch, etc.) in a retail setting.

Corporate Safety and Training Solution—This is the method where software and services are used to create basic training solutions that can be customized or localized for the intended audience. An example of this method sequence is the Insurance Industry, where safety concepts can be uniquely combined based on the customer need, and can also be localized for the intended audience (such as language, level of skill, etc).

Leveraged Media Assets (reuse)—The creation of templated presentations, navigators, and productions allow a vendor to create professional quality presentation templates (presentations) that can be used by a wide-range of customers. This allows the substantial cost of producing quality productions to be mitigated by a vast audience of customers.

An example of such application is a Theme Park. In this setting, the Theme Park produces professional settings of their attractions, but uses software as described herein to create slots where the attendee can take pictures and video clips, then place their multimedia content into the Theme Park Productions. The resulting product is a CD-Rom or DVD that combines the Theme Park experience for each customer, on a personal basis.

Focused Marketing Messages—The ability of a company to create branded productions, which have certain components locked-off, but where the company allows their distributors, resellers, etc to localize their message by inserting selected materials into designated slots. An example of this application is in corporate marketing. A real-estate marked, for example, may produce materials that can be used throughout the corporation to produce a corporate message. The local realtor may replace designated portions to show their expertise, a particular area of emphasis, or to accentuate their local flair.

Widespread Distribution—a distribution strategy may be intended to penetrate into most every home, creating an environment where storytelling and sharing are brought into homes, corporations, and societies.

Distribution of ‘Living Productions’—a component architecture may allow consumers to produce materials that can subsequently be modified, re-burned, and shared in a very short period of time. The ability to replace objects within a production allows the user to update and modify completed productions in order to keep their materials recent and relevant.

Point-to-point Service Delivery—This is a distribution strategy where a vendor provides hardware and software alternatives that allow OEM or professional groups to provide solutions, then to combine the basic authoring and presentation software with the final production.

An example of an OEM offering is a Kiosk system, where the OEM customer provides hardware, a vendor provides software, and the user contributes content and selection. The process result is the delivery of a multimedia item, such as a DVD, that contains the selected productions, the user's original multimedia content, and a copy of the basic authoring software and stock media.

Personal Selling—This is the business method where individuals take copies of production software, along with selected system hardware/software, and personally introduce and sell the production solution to a customer. The software may either be delivered ‘as is’, or may be combined with the personal seller's productions that are specifically used to help the customer with their multimedia needs.

Professional Services—Another example of this type distribution is where a professional, such as a photography or multimedia production company provides professional services to create and complete productions using production software and selected hardware, and delivers a final production CD or DVD to the customer. These multimedia production items also contain the basic production authoring and stock-media items, with help and instructions on how to obtain more presentations and production solutions from a vendor.

Club or Group Application—This involves a business method where parents or groups associated by a particular interest (e.g., baseball, dance, football) combine the production architecture with their group photographs, videos, and established memorabilia or icons. Groups personalize the media message by using ordering and populating techniques described herein to organize group activities and special occasions to produce high quality presentations and productions.

Production Hierarchy

In the exemplary product, manipulation by the user is simple. The product permits interaction with primitive objects, scenes, navigators, presentation and production assemblies. These constructs have an architectural design that is described in the following sections, along with XML and code software implementations that interpret the behavior and characteristic elements of the production assembly elements.

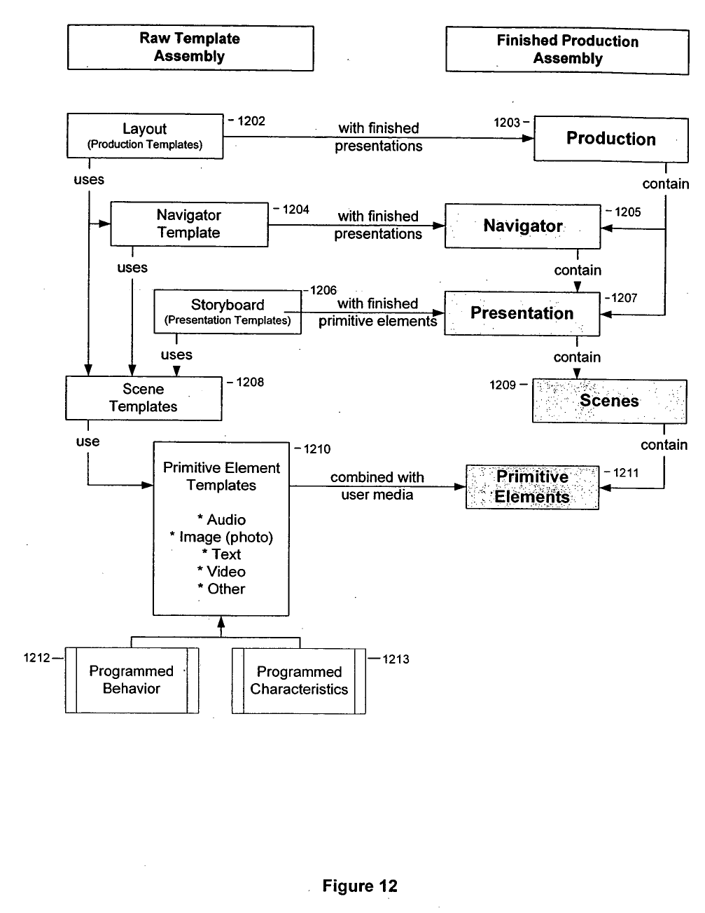

Referring first to FIG. 12, the most atomic level assembly is a Primitive Element 1211. Primitive Elements 1210 combine programmed behavior 1212 and programmed characteristics 1213 with user contributed media forming the basic assembly. Primitive Element Templates 1210 define the behavior and characteristics of all basic multimedia objects. These behaviors and characteristics are defined, and work independent of the user media. Thus, primitive element template provides a skeletal structure or definition of how media will be presented and then provides empty slots where the user media can be inserted. Primitive elements might contain any of the following items:

1. Where the original user media is stored, available for retrieval access. This may be on a local machine, on transient data sources, or in a distributed environment. A primitive element may also contain physical dimensions and location of the media, as it will be initially presented, stated in terms of 3-dimentional size and position.

2. The presentation style of the media, stated in terms of justification. This justification is scene relative, and stated in terms of horizontal (left, center, right, full), vertical (top, center, bottom, full), and depth (front, center, back, full) parameters. The initial opacity of the media, stated in terms of an alpha-transparency.

3. Initial enhancements to the media, such as framing effects, mattes, edges, shadows, ghost images, and special lighting or camera enhancements that modify the presentation of the user's media.

4. When the media is shown, or its longevity in the presentation. This includes defining a start-time, end-time, and duration, which time applies within the context of the parent scene 1208.

5. The introductory transitions, or how the element is first presented in the presentation. These transitions include any fade-in, spin-up, or other behavioral effects used at the beginning of the element's presentation.

6. The motion paths, or the location of the element within the presentation space. This is typically stated in terms of 3-dimentional coordinates.

7. The run-time transforms, which effect how the media is presented and any transitional effects that are to be applied, such as sizing, zooming, rolling, rotating, and wiping. Each of these effects is stated in terms of longevity, motion paths, and transitions within the context of the primitive element.

8. The exit transitions, or how the element is presented at the conclusion of it's life within a presentation. These transitions include any fade-out, spin-down, or other behavioral effects used at the end of the element's presentation.

In addition, many support methods may be defined that aid in the assembly process.

These methods may include:

1. Persistence. The manner in which a primitive element can reside outside a production application. This includes having a human readable design definition. Persistence also defines what media items are stock in nature (supplied by a vendor), which items cannot be modified (read-only), which items can be replaced by the user, and how the item has been changed or modified over time.

2. Dynamism. This defines how an element's time elements (start-time, end-time, duration) can be modified if the user contributes less items than specified in the presentation. It also identifies what should happen if a given element's time is longer or shorter than the supplied media (in the case of video and audio clips).

3. Layering. A method for describing an element's dominance factor in relationship to other elements or the method in which elements can be locked from user or programmer access.

4. Quality manipulation. Expressed in terms of process filters, such as motion, blur, ntsc-safe, color-correction, gray-scale, smoothing.

5. Hierarchy, construction, and interoperability. Defines basic parameters of how the element will interact with other elements.

6. User presentation. Defines how the user will see the multimedia object in a context of help, preview, rendering, or printing.

Once the user introduces media, in the form of photographs, audio or video clips, or textual information to a primitive element template, the product automatically constructs a Primitive Element 1211. Primitive Element Assemblies combine raw media from user in the following media formats:

1. Animation—wire-frame files that can be rendered and manipulated by an underlying 3d graphics package.

2. Audio—music or spoken audio either in the form of tapes, or digitally captured files, including industry standard extensions including .aif, .mp3, etc.

3.Document—organized text in the form of rich text, word documents, etc.

4. Images—a picture. Images on a computer are usually represented as bitmaps (raster graphics) or vector graphics and include file extensions like jpg, .bmp, tif

5. Text—written material in the digital form of text or color alphabet to give credit, represent dialog or explain action.

6. Video—a series of framed images put together, one after another to simulate motion and interactivity, motion pictures, home video, that can be digitally reproduced, including industry digital signature of .avi, .m2v, .mp4, etc.

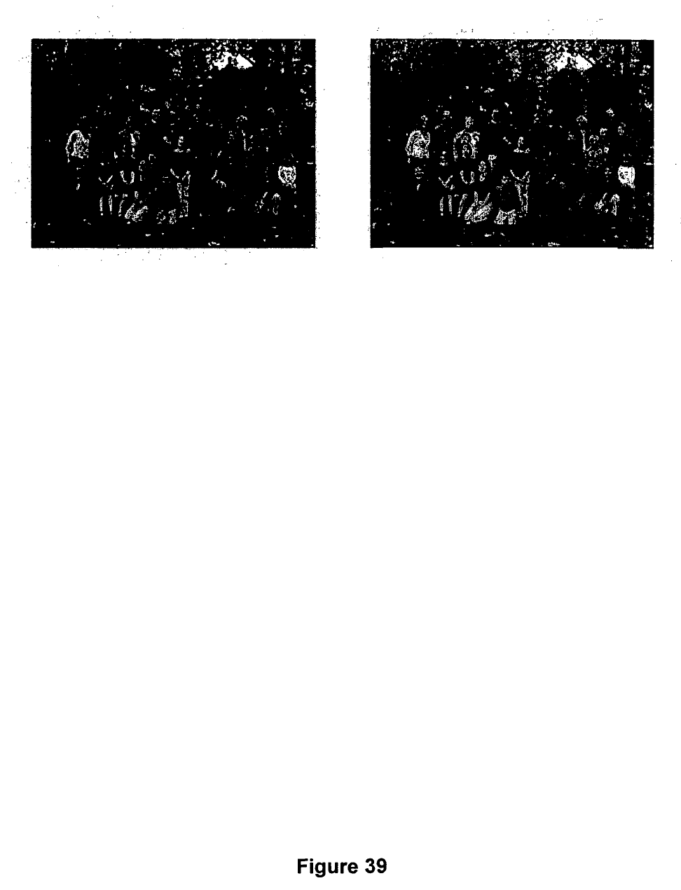

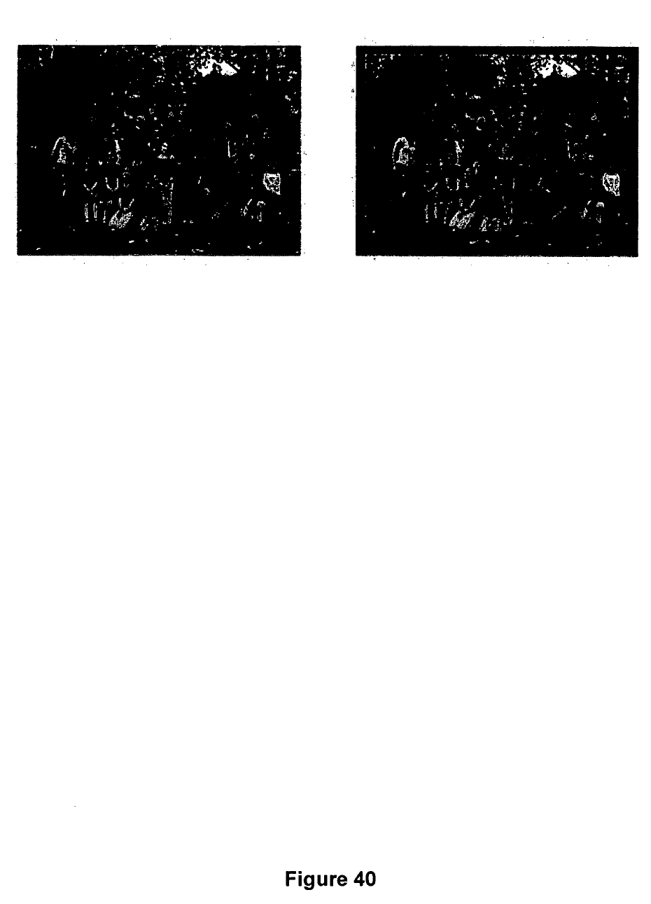

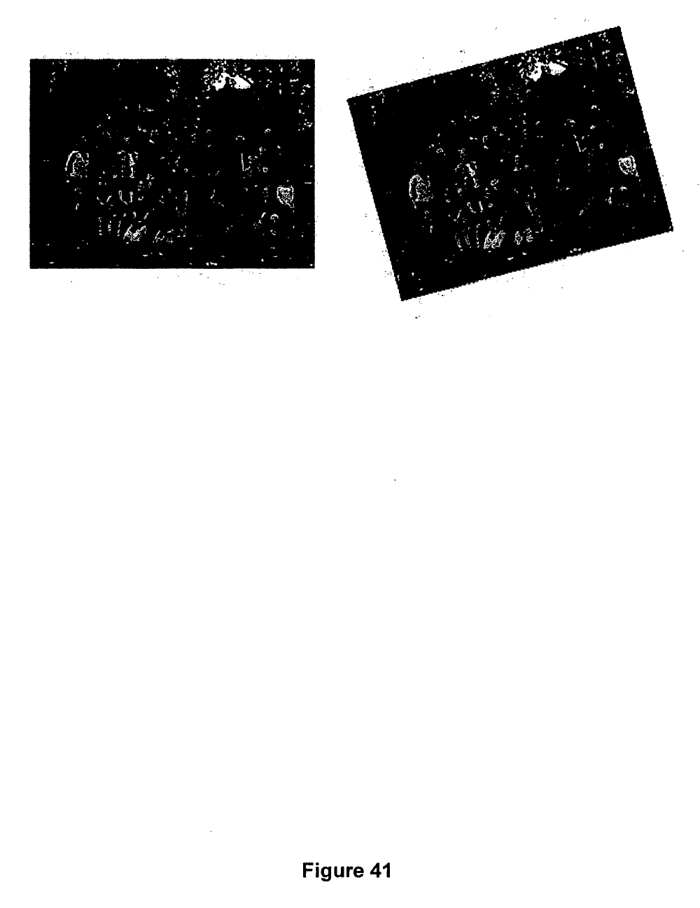

A Primitive Element assembly may be as simple as a combined photograph with a single simple effect, or a photograph combined with many complex and interactive effects. For example, original media can be faded by defining a fade behavior as shown in FIG. 39. Original media might also be framed by defining a frame behavior, as shown in FIG. 40. Original media might additionally be rotated by defining a rotate behavior, as in FIG. 41. In those examples, templates may be used to define the behavior, interaction, and characteristics of a primitive element.

Scene Assemblies

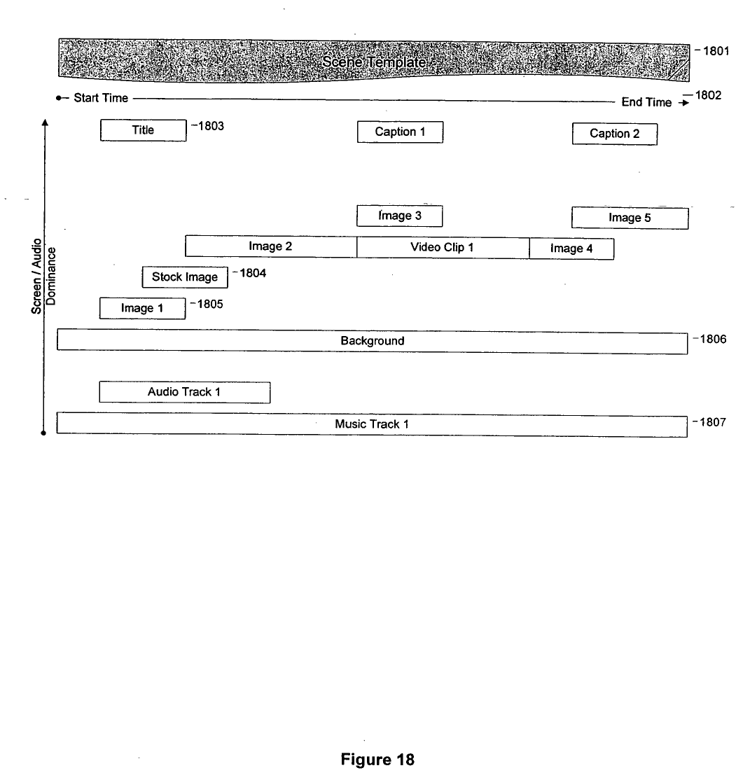

The next higher-level assemblies are Scene Templates 1208. Referring to FIG. 18, completed scenes encapsulate a short single thread or thought that will be used in a final presentation assembly. Scenes may be as short as a few seconds, or as long as several minutes.

Scene behavior is programmed on a specific scene-by-scene basis, but may be reused in higher level presentation assemblies. A typical scene template may contain many primitive elements that have been assigned behavior and characteristics through code level instruction sets. Scenes define controlling time elements and may add special effects that will apply to all contained primitive elements. They contain all the behavior and characteristic capabilities of primitive elements, but define a hierarchal containment for any primitive elements.

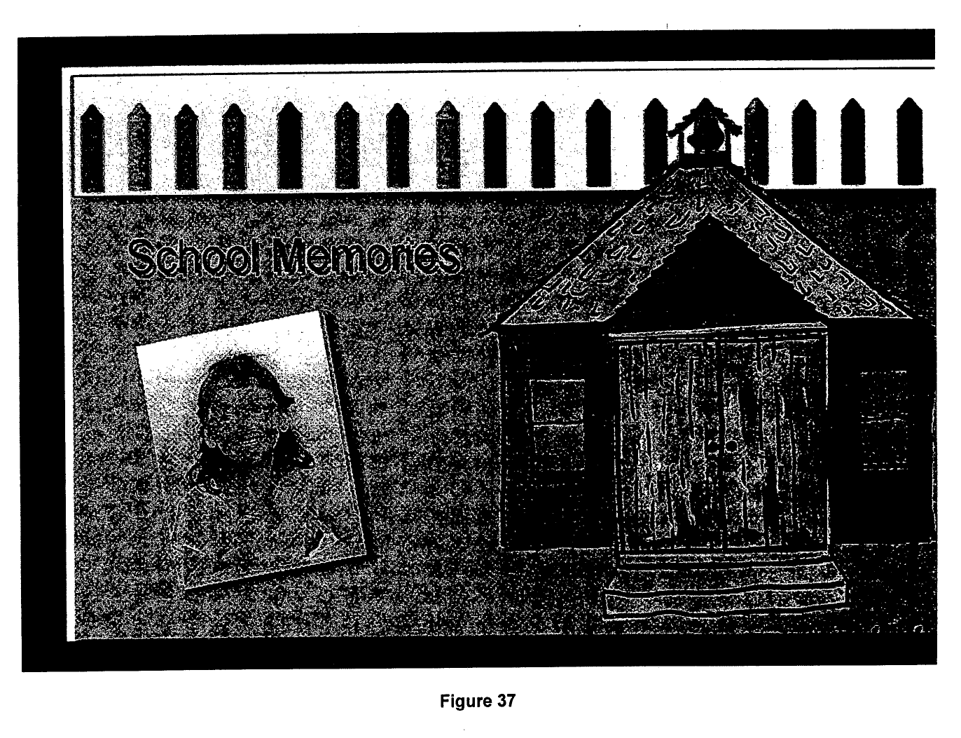

For example, in FIG. 37 a school based scene presentation is shown that manages the interaction and presentation of a photograph, a picture of a school, some school text, and a crayon wallpaper background. In this scene, all elements are presented the rolled across the screen.

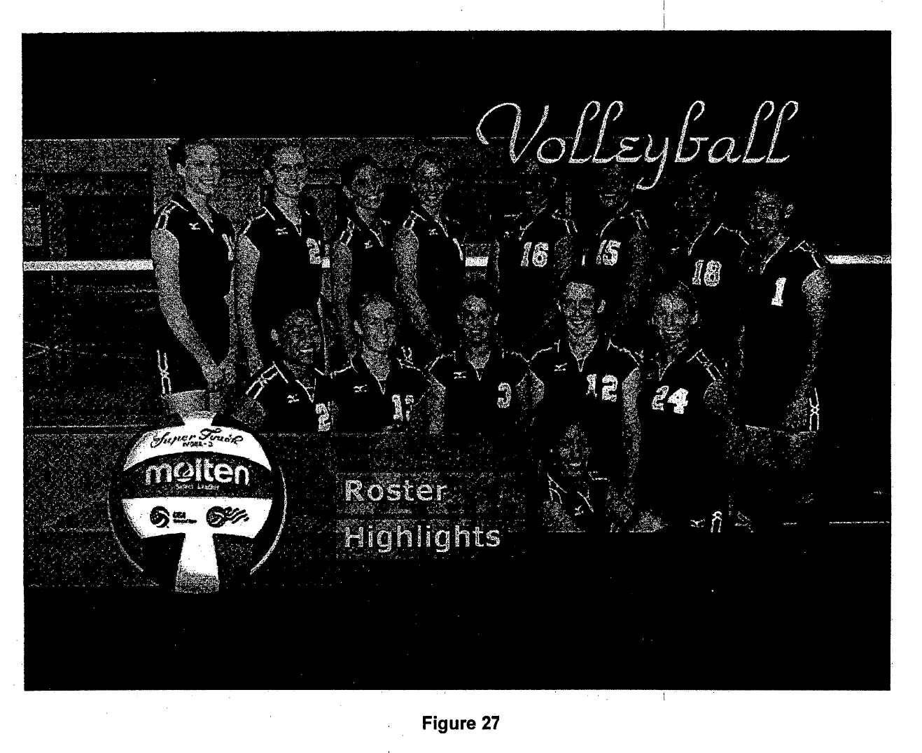

In another example, a sport based scene presentation that manages the presentation of several photographs, but instead of rolling the content, the scene stacks the individual photographs along a team based logo background, as in FIG. 27.

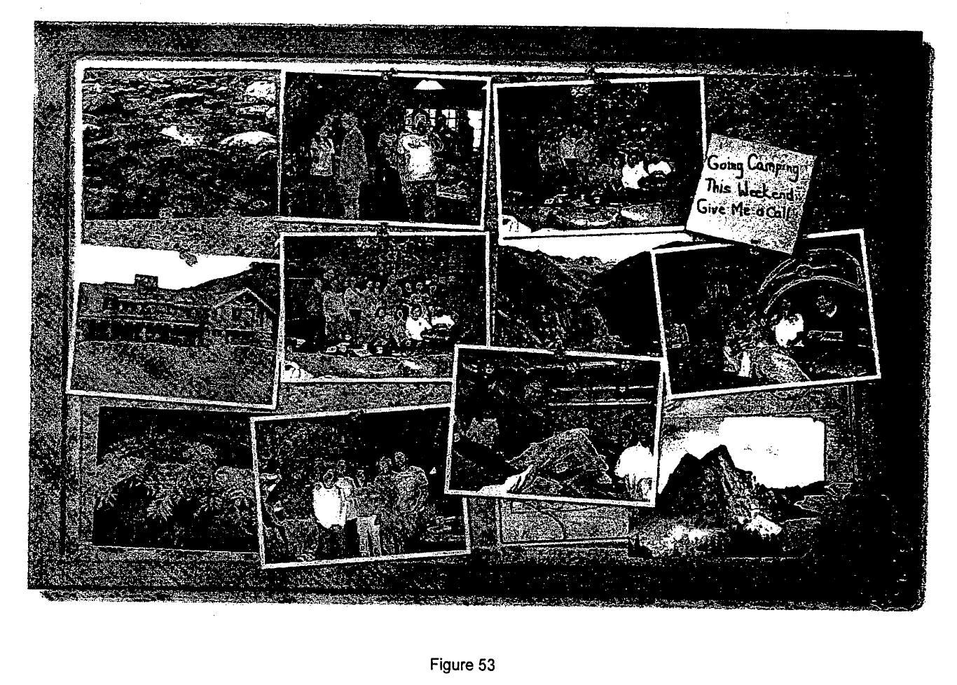

In a further example shown in FIG. 53, an outdoor based scene presentation manages a collection of user photographs, presented in a rotated and stacked fashion. This shows how scenes can define dominance of primitive elements in relationship to one-another.

Scene assemblies can be very complex in nature. They can mix programmatic AMOM and primitive elements while defining field dominance, interaction and timing parameters. These assemblies are required to regulate and mix elemental behavior while giving the completed presentation a professional look and feel and guaranteeing consistent performance.

Presentation Assemblies

The next higher-level assemblies are Presentation Templates 1206. Completed presentations may also encapsulate a single thread or idea from the user, much like scenes. Presentations are typically 3 to 10 minutes in length, representing a single story line or cinematic effect. On the other hand, a typical production template may contains several presentation sub-assemblies consisting of miscellaneous stock and support elements that enhance the presentation artistically or by advancing the story line by providing effects and media that are not typically available to the user.

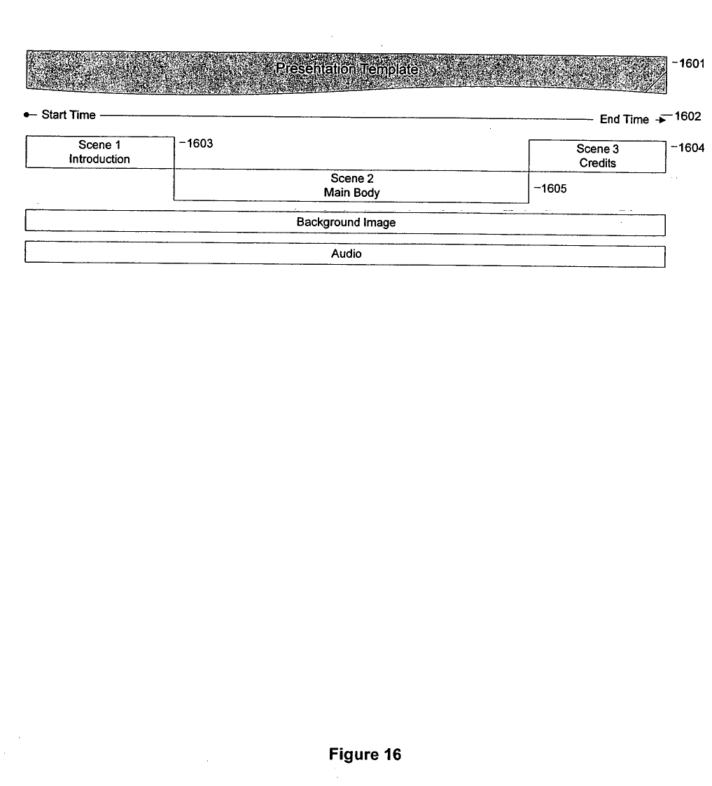

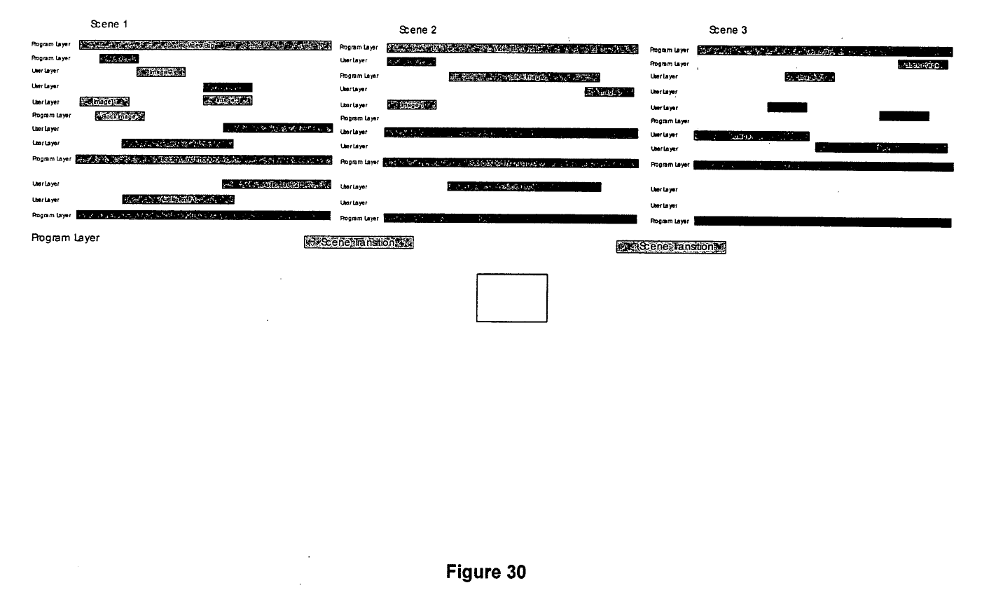

FIGS. 16 and 30 show how primitive elements and scenes can be arranged to form a completed presentation. In each case, the figure shows how the presentation defines a time context 1602 and an interactive layering of scenes with transitions 1603 and 1604. Stock elements may exist on any element layer depending on the dominance of the element prescribed in the original presentation template. Likewise, user media may be arranged according to their order and dominance in the scene. There is virtually no limitation to the number of elements that are possible in any given scene, unlike existing alternatives that traditionally consider the element to be the equal of the scene and are therefore limited to a single ‘like’ element in each scene.

The behaviors and characteristics of each element, whether contributed by the program or the user is predetermined by the template, and locked so that they cannot be changed by the users. Additionally, program elements may be exposed to user manipulation depending on a number of factors. This allows users to freely substitute the proscribed media into the predetermined position where it will assume the behaviors and characteristics that have been assigned to the program media originally in that position unlike existing alternatives that allow users to assign the behaviors and characteristics to the specific element with the consequence that once the element is changed, the instructions with regard to type, behavior and characteristic are lost.

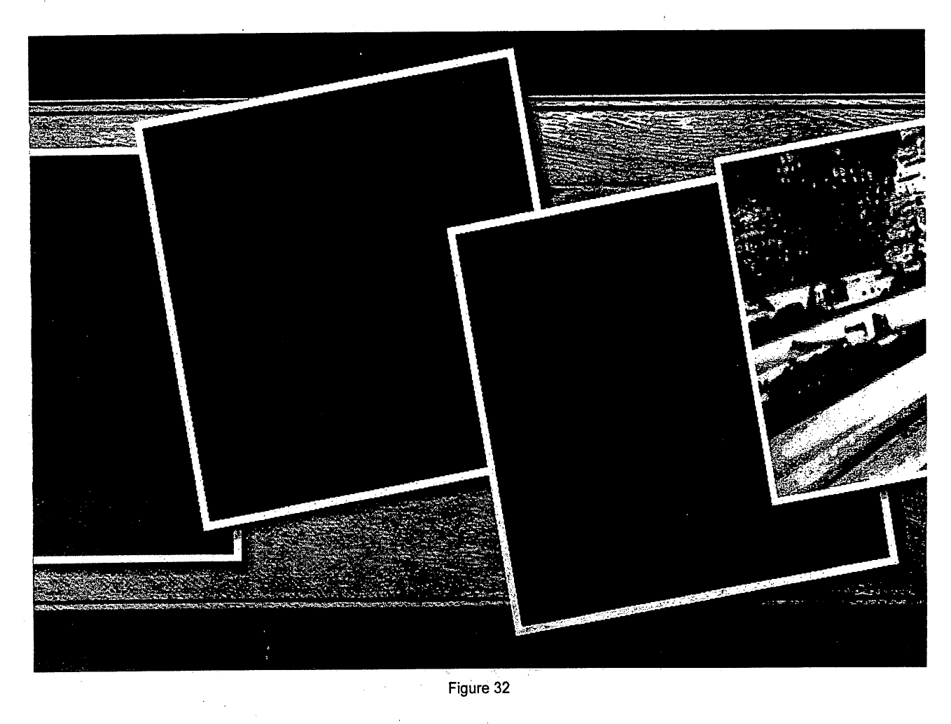

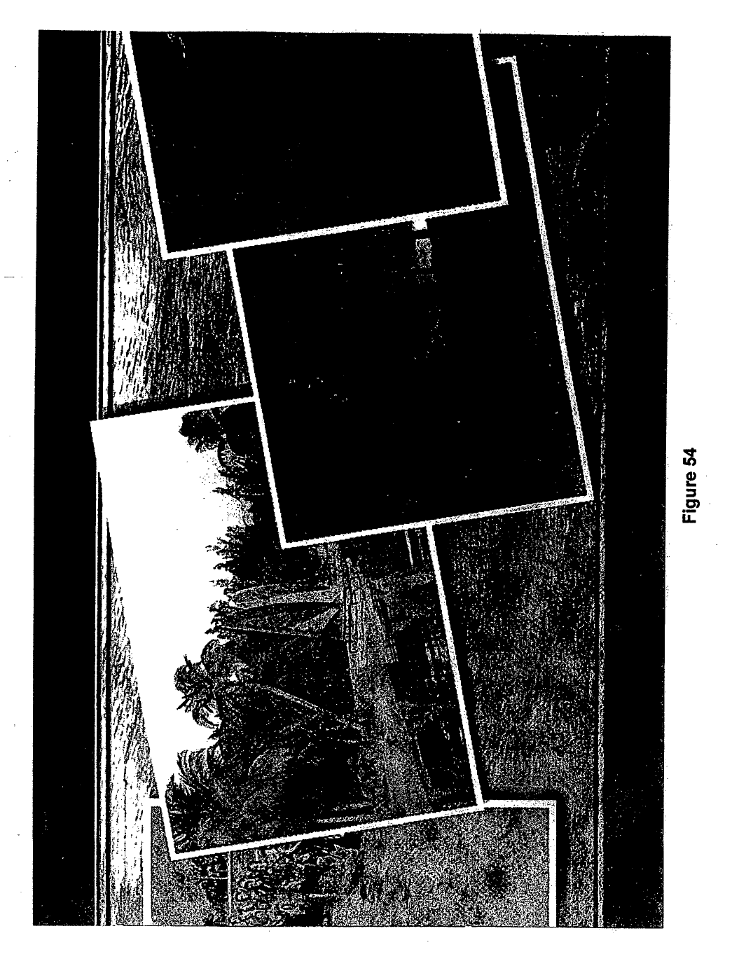

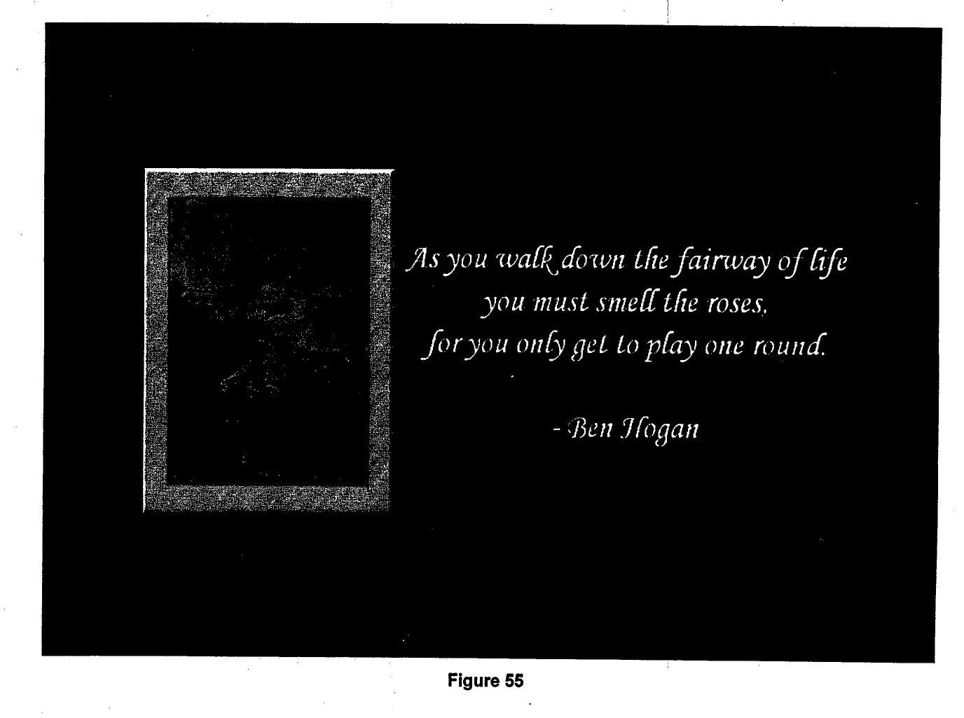

Referring to FIG. 32, a presentation template is shown before the user has inserted media. The template contains interactions necessary to present default information to the user, but it is the combination of user media, as shown in FIG. 54, that produces a complete presentation. Presentations may contain not only visual photographs specific to user content, but may also contain either stock or user supplied textual information, as shown in FIG. 55.

Presentation assemblies are the first level assembly that has an accompanying render output. The output is a standard multimedia video file, such as the mpeg television, DVD, web, and HDTV resolutions. At the software coding layer, computer class definitions and code provide the mechanisms for reading, writing, presenting, and rendering presentations.

Production Assemblies

The highest level assemblies are Productions 1202. Productions contain navigation information, selected presentations, and any other miscellaneous media that is required to produce a professional looking production that can be burned to CD, DVD or transmitted via the Web. Unlike other multimedia elements, Production templates only have loosely bound timing controls which are provided by completed presentations.

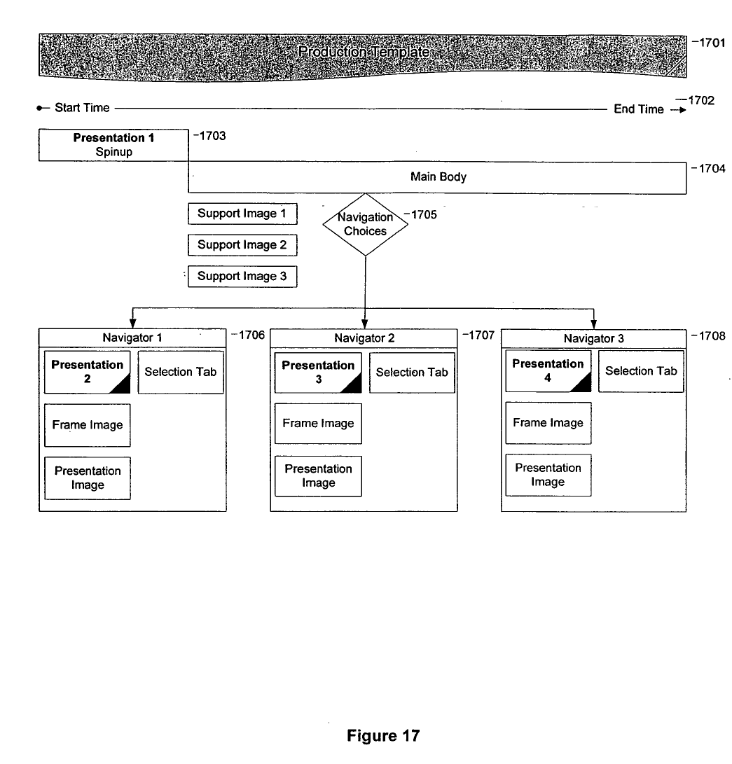

FIG. 17 shows how a comprehensive production template may contain timing features 1702, DVD spinup options 1703, Navigator controls from which the user can select 1705 and finally, individual Presentations that are played from the user requests 1708. A typical production template may contain several unique navigators, miscellaneous backgrounds, and support elements.

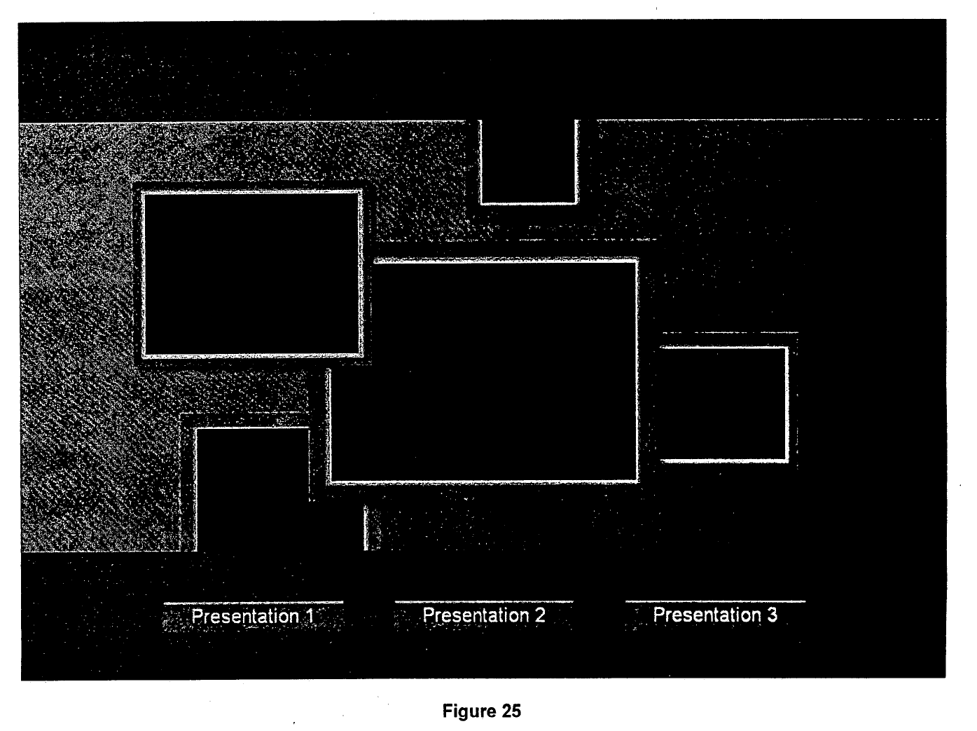

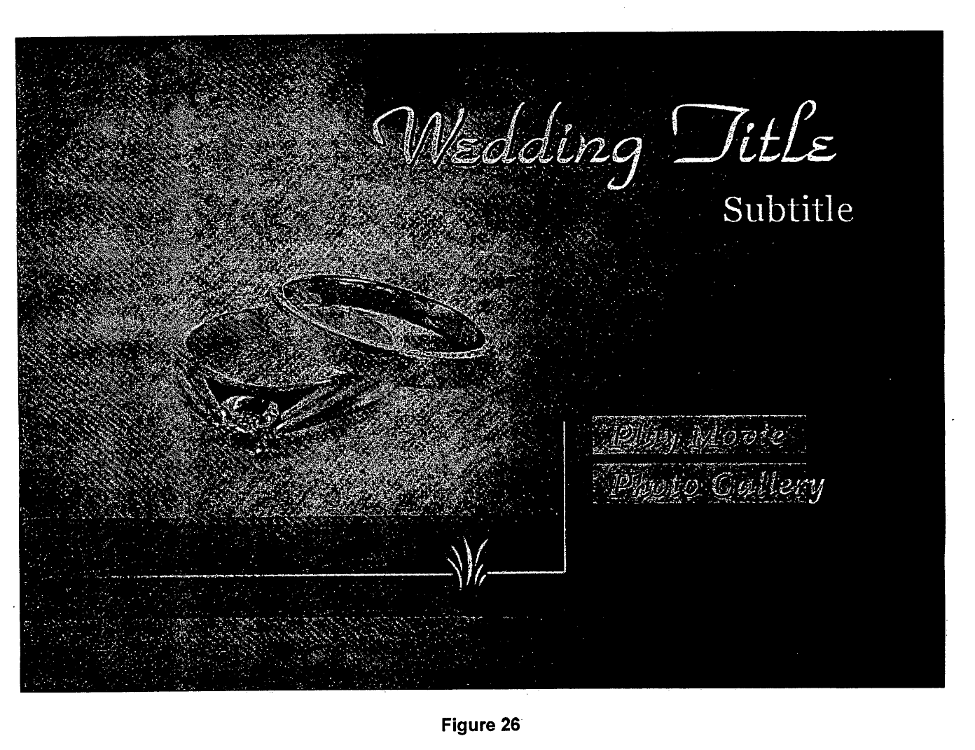

In one example shown in FIG. 25, a general DVD navigation is included where individual presentations are shown through picture frames. In another example, FIG. 26 shows a different DVD navigation system where a themed background is associated with navigator items. In a futher example, FIG. 27 shows a sports themed DVD navigator where users can insert content relevant backgrounds to replace stock media items.

At the software coding layer, computer class definitions and code provide the mechanisms for reading, writing, presenting, rendering, and burning completed productions.

Process Organization

The exemplary product's software component is a simple to use, multi-media authoring and presentation software, that captures and presents personalized user media in the context of thematic presentations and productions. The product provides a method of using professionally designed and pre-coded Presentation Templates where users can preview the conceptual interaction, behavior, and presentation of multimedia components. These templates contain open slots where user media and contextual information can be inserted either automatically by the application under the direction of the User.

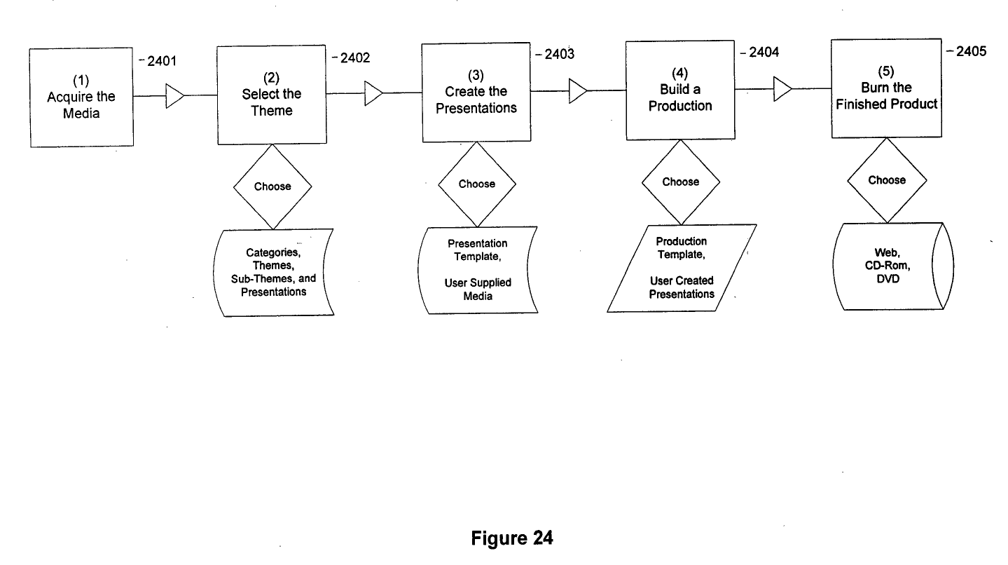

FIG. 24 shows five basic steps used in the exemplary product to produce final multimedia productions. Each of these steps contains comprehensive sub-systems that operate automatically.

First, users integrate their photos, journals, videos, audio clips, and other types of multi-media in the acquire phase 2401. This process is done in a manner that will not only preserve but also enhance and reinforce their contextual meaning for generations to come.

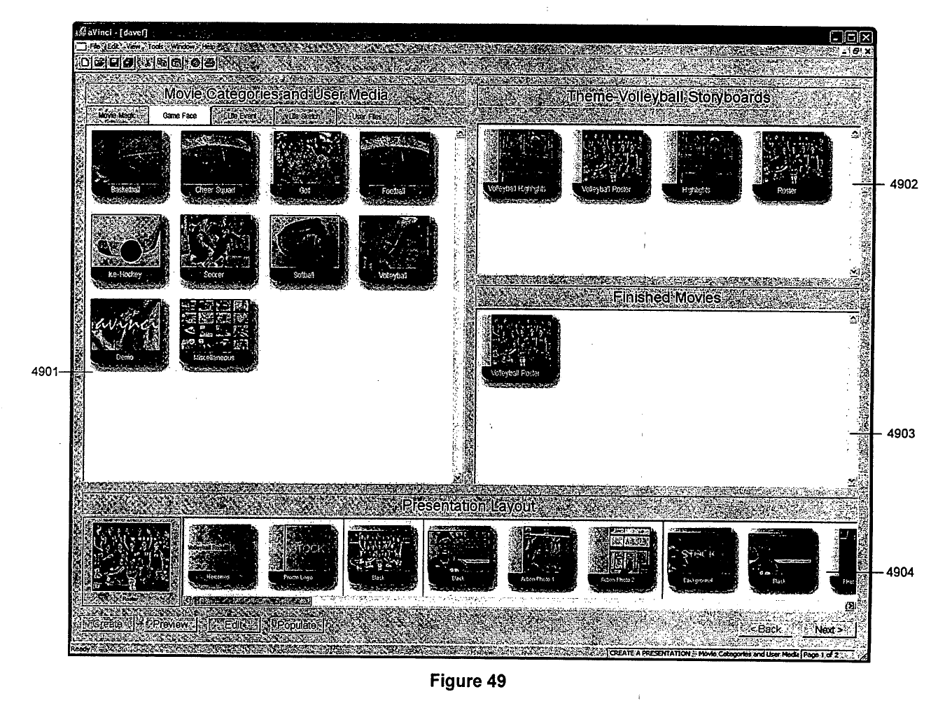

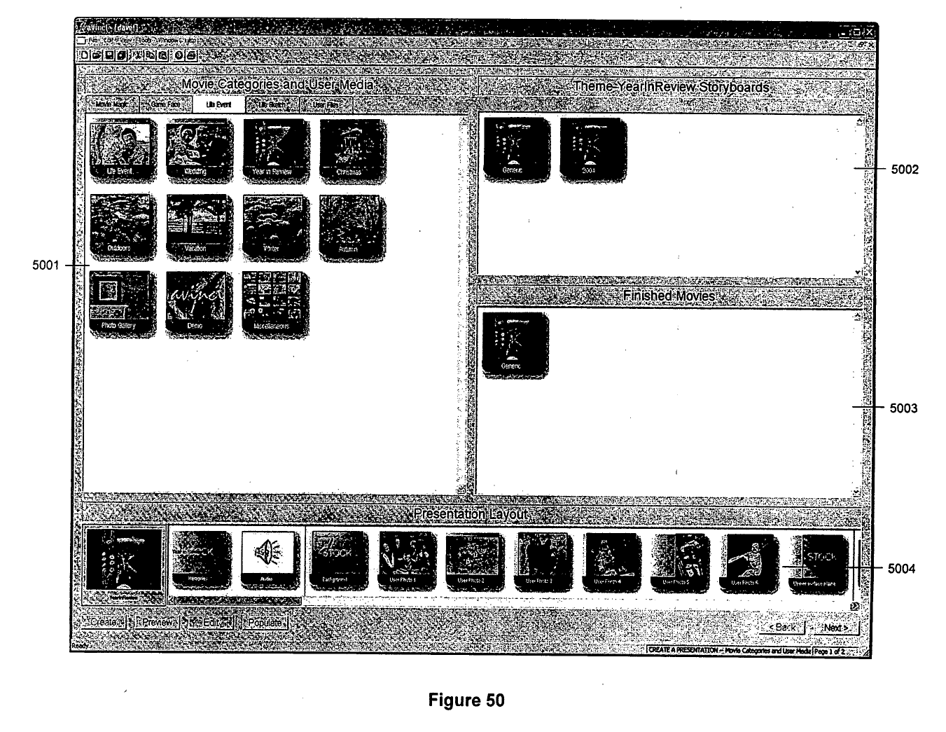

Second, users decide the theme or category of presentation in the selection phase 2402. The product pre-defines logical categories based on research in analysis of user multimedia. FIG. 50 shows a collection of “Life Event” type presentation possibilities where the main category selections are presented to the user 5001, then further refinement is accomplished by providing the user with various presentation options that focus on specific emotions and presentations that are desired by the user. FIG. 49 shows such refinement with the categorization of Sports 4901 including Basketball, Soccer, Softball, Volleyball, etc., with further refinement of Roster, Highlights, and Featured Athlete presentations 4902 that allow users to select specific types of presentation according to their needs.

Third, a user organizes during the Create phase 2403. Methods used provide an instructive and intuitive interface that automates and guides the user as they place their multi-media into presentations, without the need of defining special effects, consistent backgrounds, and pertinent captions.

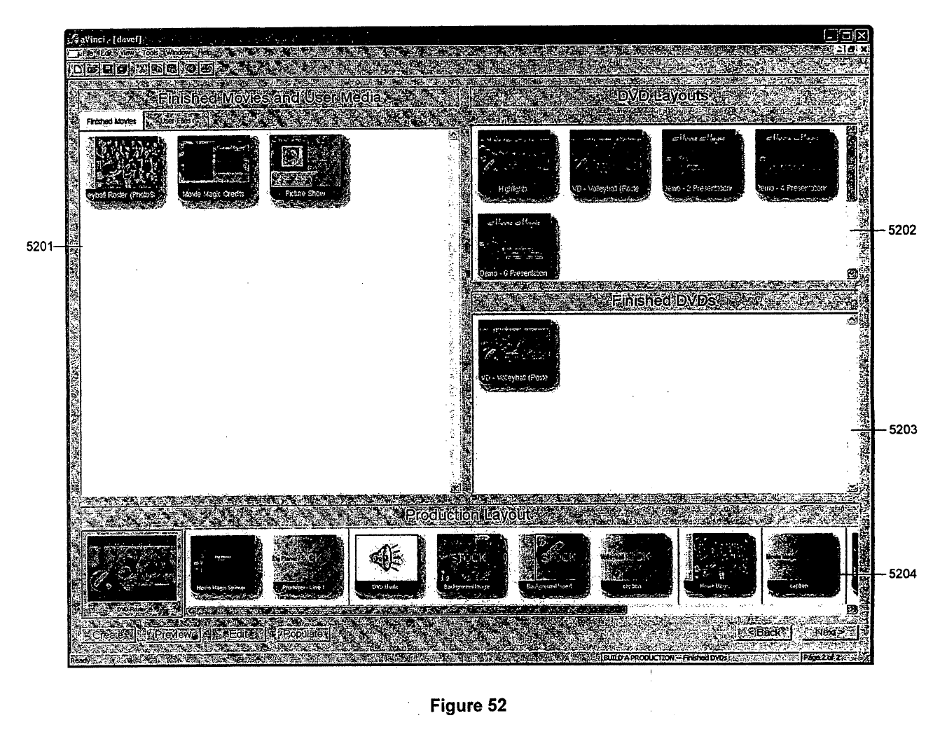

Fourth, a user builds a final multimedia production during the build phase 2404. FIG. 52 shows the user view on the assembly of a production, where the finished presentations 5201 are ‘dropped’ into pre-defined DVD productions 5204. The user again, does not need to supply special effects, interactions, and DVD navigator connections, rather, they simply choose from pre-defined thematic productions that simply connect presentations that were built in the prior step.

Lastly, a user produces distributable final media, such as DVDs or CDRoms during the Burn phase 2405. By using readily available digital media and completing the steps in the build method, users can distribute their productions using media that will be accessible and pleasing to themselves, their family, and their friends.

Acquire Media Phase

In this phase a user gathers and acquires media, such as audio clips, photographs, video clips and documents. These may already be in digital form, or may be scanned and organized into digital media that can be placed into AMOM presentation selections. The organization is not important at this stage, because automatic organization and inference identification is made when the presentation is created and user media is supplied.

Choose Presentation Phase

After acquiring media, a user may select the specific Presentation they would like to use. This is accomplished by guiding the user through an organized hierarchy of category, theme, sub-theme and finally presentation templates. Presentations may be organized into a hierarchy, located to categories, themes and sub-themes. For example, presentation themed to a particular unit of the armed forces might be located as follows in a hierarchy:

| Category | Life Events |
|---|---|
| Theme | Military |
| Sub-Theme | Army |
| Presentation | 308th Infantry Division |

The presentations that a user can choose may be designed and have design elements reflective of the user's area of interest, such as “Military,” and include application supplied multi-media common to both the Army and Navy. For instance, presentations at the “Army” level would have design elements reflective of the Army as a whole with no specificity with regard to divisions such as Infantry, Rangers or Paratroopers. A ‘308th’ specific presentation may contain additional design elements specific to that unit such as insignias, actual commanders and theaters of deployment.

Guided navigation through the progressive selection of categories, themes, and sub-themes using a well-thought out method of categorization helps users to a granularity or specificity while generating specific production ideas through example. The output obtained is the selection of themed presentations that best suit the end-users interests, needs, or production requirements.

The following is an exemplary presentation organization grouped into categories, sub-categories, and themes:

Category—Activities

Theme—Military
Subtheme—Airforce, Army, Coast Guard, Marines, Navy, Veterans

Theme—School
Subtheme—Activities, Dances, Friends, Graduation, Offices

Theme—Sports
Subtheme—Baseball, Basketball, Football, Golf, Soccer

Theme—Talent
Subtheme—Arts, Ballet, Crafts, Dance, Music, Vacation

Theme—Adventure
Subtheme—Cruises, Theme Parks, Summer, Winter, Other

Category—Events

Theme—Anniversary
Subtheme—1st, 10th, 25th, 50th, Other

Theme—Birthday
Subtheme—1st, Childhood, Teenage, Adult, Other

Theme—Holiday
Subtheme—Easter, July 4th, Halloween, Thanksgiving, Christmas, N Years

Theme—Reunions
Subtheme—Class, Family, Friends

Theme—Wedding
Subtheme—Engagement, Bride/Groom, Reception, Honeymoon

Users may also choose at any time to preview any presentation (for use in the next step in order to determine which is best suited for the user's needs. For example, previewing the Legacy presentation shown in FIG. 32 would result in a full motion video preview that presents stock media elements (in this case a wood background and stock video footage) showing the relative characteristics and behavior of the multi-media drop-slots that can be customized by the user.

Create Presentation Phase

In this phase, a user creates presentation by adding personalized media to a selected presentation template. Users are able to personalize presentations by inserting their media or context in the form of captions or titles into the specified user media slots.

Upon entering the presentation phase, potential user media is shown in the ‘Media Browser’ window and is automatically and easily identified by file type (photograph, image, video clip, audio clip, document, and text) by attaching a colored tag to the bottom of the application generated thumbnail.

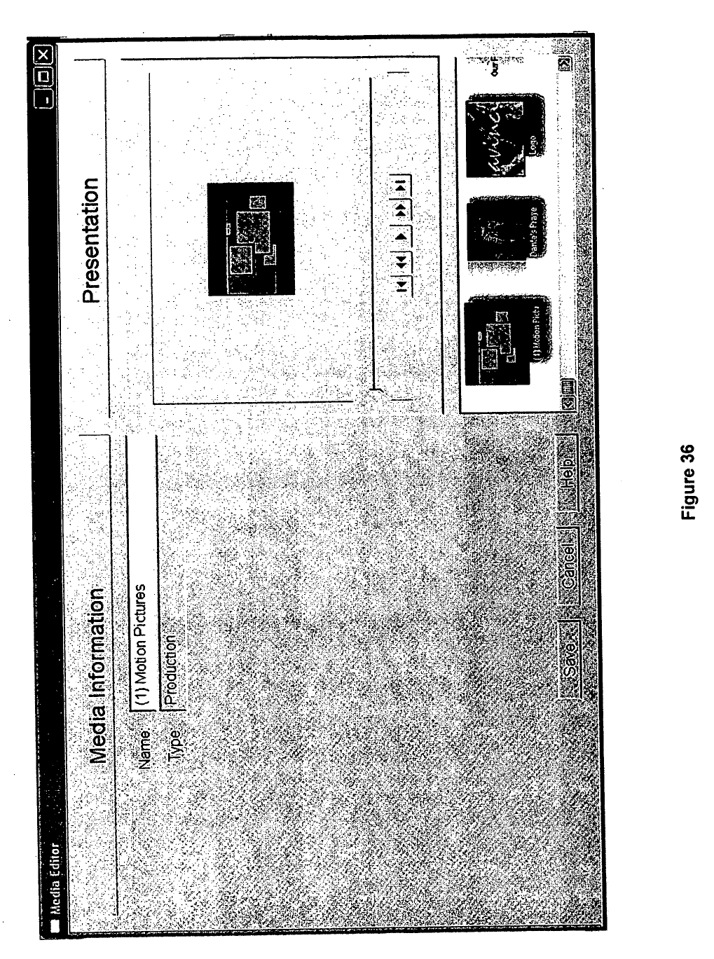

Users may automatically populate a presentation by selecting directories or media content folders (folders that contained managed photos, audio and video clips, etc.) and dragging and dropping the entire folder into the active ‘Presentation Layout’ window or by placing images and text in each available presentation slot. For example, the ‘Legacy’ presentation template shown in FIG. 32 contains blank slots where user would insert media, filling the scripted, but incomplete presentation assembly. Referring to FIG. 36, user places media into the presentation and edits individual elements for final placement and control.

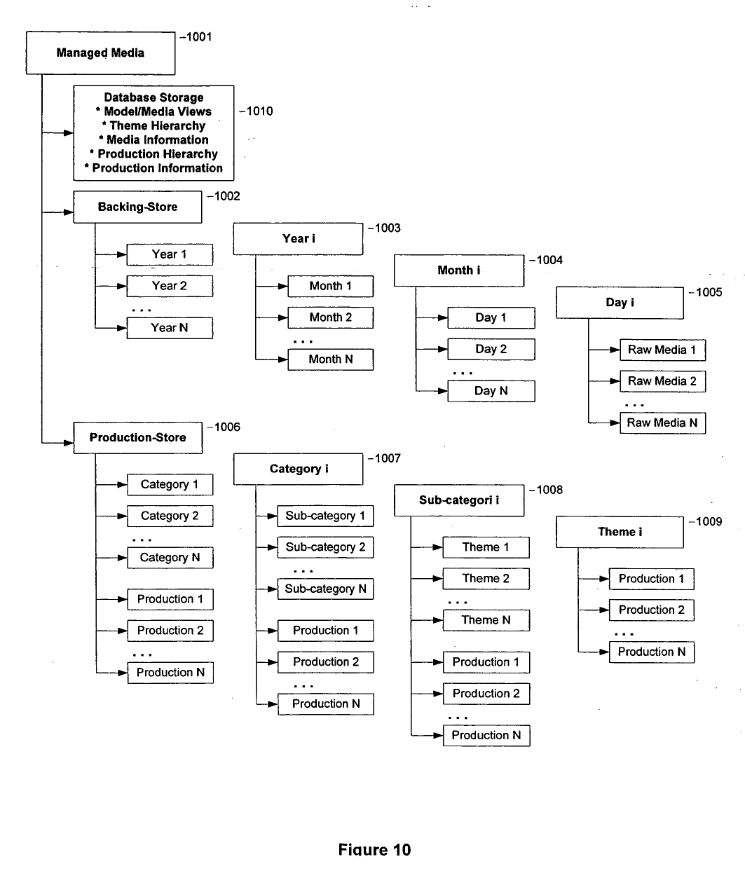

The product of this step is a completed presentation, where the exemplary product automatically combines user media with pre-defined presentations. Referring to FIG. 10, the application automatically creates an instruction folder in the Backing-store 1002 and populates it with information regarding the chosen presentation and links to the user supplied media elements. It also creates a folder in the production-store 1003 containing original user media organized based on the original navigation choices made by the user. This allows the application to ‘learn’ or make intelligent assumptions about the content, context and subject of the presentation.

Build Production Phase

In this phase a user finishes building productions by a) selecting a themed production in a manner similar to creating a presentation, b) browsing and selecting media from either a media browser, or select from a source outside of the application in the host environment's directory/file structure. c) selecting completed presentations for use in the final production, d) previewing the current production and its behavior, or edit individual presentations, and e) editing the respective object for final refinement.

Render/Burn/Print Production Phase

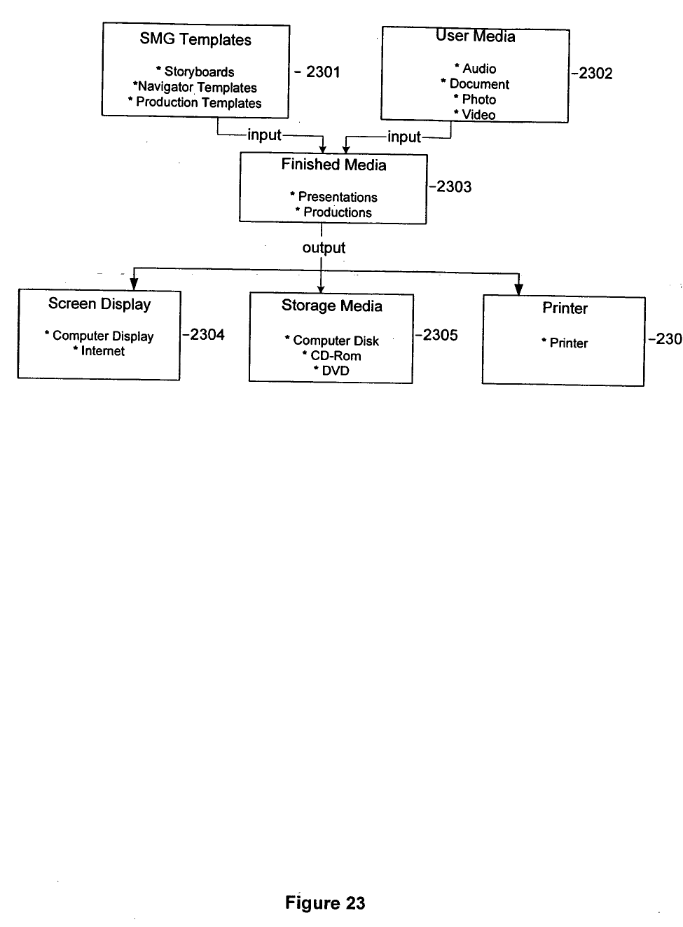

Finally, a user renders and burns the finished productions to DVD, CD-ROM, or Web. FIG. 23 shows the process of combining Templates 2301 with User Media 2302 to produce Finished Media 2303 which can be output either to the Screen Display 2304, Storage Media such as DVDs 2305, or to a Printer 2306.

Exemplary System Architecture

The exemplary product uses automatic methods (e.g., wizards, populating schemes, themed process flow) to automate the process of presentation and production creation. A particular method can be as short as the user simply loading their media and selecting the proper theme assembly, or as complex as constructing a full production from hundreds of sub-assemblies. The core methods of this architecture reside in the initialization, communications, and process flow of data, organization, and automated organization models (presentations and productions). Those elements include: (1) a read/write mechanism whereby media trees are managed from disk, memory, or alternative storage structure, (2) a core management and communication provided by an element management module, (3) pluggable service modules that are dynamically loaded and fully encapsulate the load/store/present/edit capabilities associated with specific categories of behavior, and (4) dynamic views into the data, whether by name, description, date, etc.

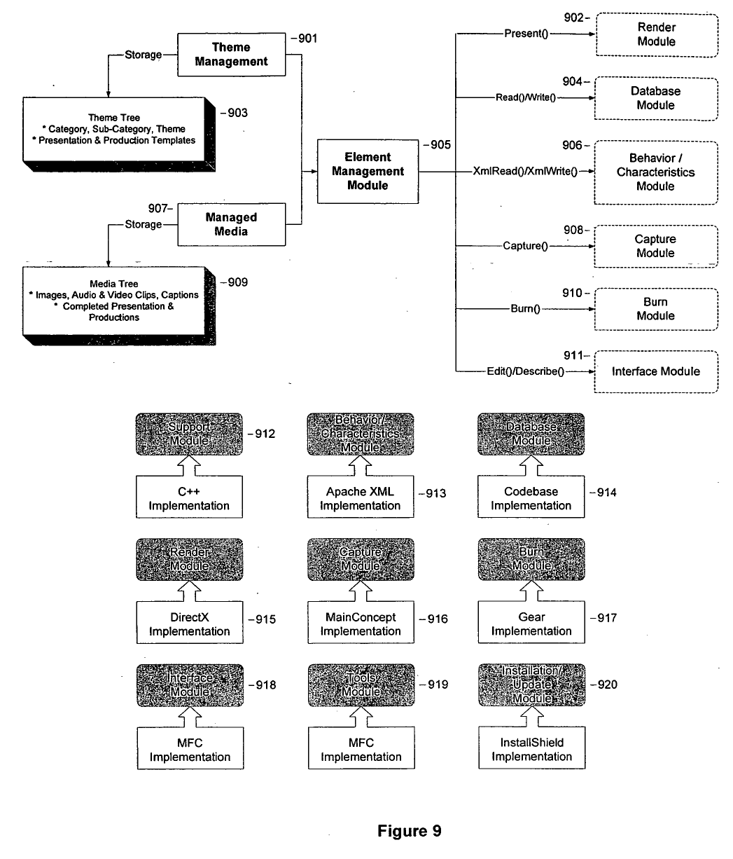

FIG. 9 shows the overall system architecture of the exemplary product that controls sub-methods and processes used to produce complete productions, as described in the prior paragraph. The process flow of this model starts with organization of the Theme Tree 903 which includes the category, sub-category, and theme categorizations. Next in the process flow is the User Media, which is represented and managed by the Media Tree 909. Once managed by the theme and managed media modules 901 and 907, the work process goes to the Element hierarchal management module 905. Work is distributed to the following modules and interactions:

1. An Element Management module 905. This module controls the presentation and modification of multimedia elements, and derived multimedia element classes. This module is central to other modules in the system.

2. A Theme Management module 901. This module controls the loading and presentation of theme classifications, presentation and production templates. This includes the CTheme, CPresentation, and CProduction classes.

3. A Managed Media module 907. This module controls the loading, presentation, modification, and storage of user and stock media. This includes primitive element classes and advanced element classes.

4. A Render module 902. This module controls the presentation and rendering of multimedia elements, along with any applied special effects.

5. A Database module 904. This module controls the storage of multimedia information, once the element has been managed by the system. This also manages the definition of family/friend relationships, corporate organizations, user sharing and modeling processes, and runtime system personal preferences.

6. A Behavior/Characteristic module 906. This module controls the loading, modification, and subsequent storage of behaviors and characteristics.

7. A Capture module 908. Acts as a recorder for element presentations on the display. The output is a fully mixed presentation that is stored in a single multimedia format (mpeg).

8. A Burn module 910. This module burns executables and materials necessary for the user to see a finished production on their destination media. Burning includes DVD, CD, and Web destinations.

9. An Interface module 911. This is the module that presents information (i.e., 4 page process control) to the screen. This module interacts with the user and performs sub-module requests.

10. A General Installation & Upgrade module 920. This may be an installation program that copies executables, associated DLLs, and materials needed to execute the system.

11. A Package Installation & Update module 920. This may be an installation program that only copies/integrates package installations.

12. A Support module 912. This module may include various tools that support the presentation, rendering, and interaction with users.

FIG. 24 shows the overall system control associated with the system which generalizes the system methods necessary for production creation. This includes the steps acquire, select, create, build and burn. In the acquire step 2401 the application shows the multimedia files and items available on the user's system. In the select step 2401 the application guides the user progressively by allowing them to select from “Category,” “Theme,” then “Presentation” groups that offer increasing granularity (specificity) to their desired Production. By the create step 2403 the user can easily build a Production by first selecting the appropriate Presentation Template and then populating it (i.e., inserts photo, image, video or audio recordings, documents, and text media) at the Primitive Element, Scene Template or Presentation Template level with their personal multi-media and contextual information to produce “Presentations.” In the build step 2404 the application guides the user in a similar method that joins Presentations together using Presentation Types (Introduction, Main, Credits and Navigators) resulting in “Productions.” Finally, in the burn step 2405 the user renders finished presentations and productions to multimedia files, CD-Rom, DVD, print, or other appropriate distribution ready media.

Each step in the system process model can be automated, split into ‘wizard’ like sub-components, or be pushed into progressively advanced modes where media presentation and production can be enhanced and refined.

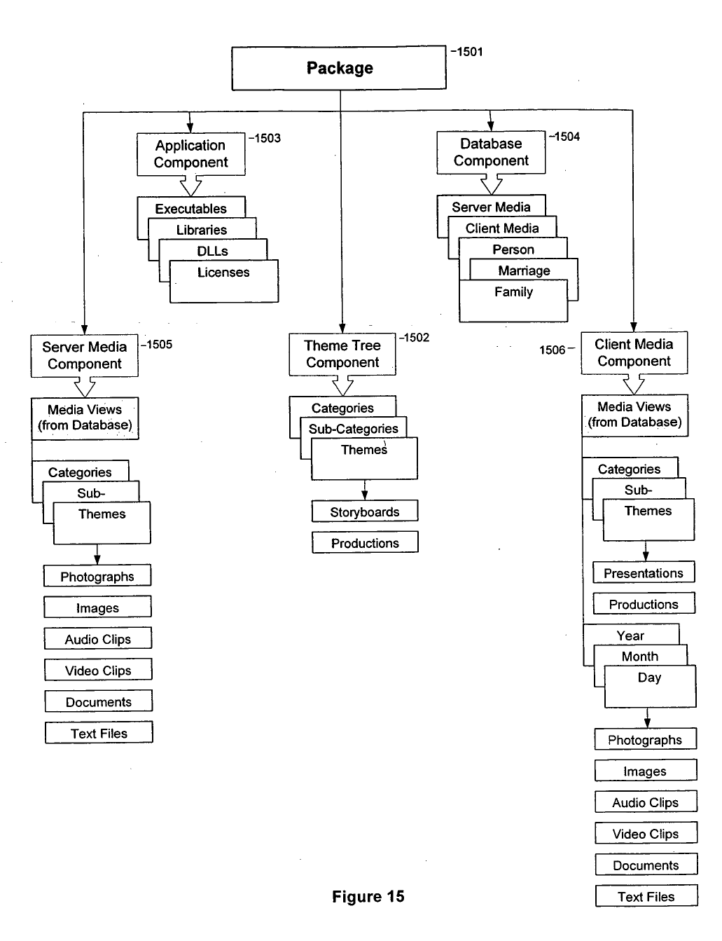

Data construction and hierarchal management methods associated with multimedia packages are handled by component definitions. Now referring to FIG. 15, a package component 1501 handles overall system data control. This component also systematically allocates aspects of the application by providing essential data components. In this manner, the system responds to data requests, or is ‘data driven.’

The theme tree component 1502 defines theme categories, sub-categories, contexts, presentations and production templates that will be accessible to the user. The application component 1503 defines executables, support DLLs and libraries, and license files necessary to run the system. A database component 1504 manages multimedia elements that have been stored into presentations or productions, and media managed by the user. A server media component 1505 defines defined multimedia primitive elements that are visible within the system. A client media component 1506 defines user multimedia primitive elements that are visible within the system.

Packages contain multiple pluggable components. This means component definitions may include common underlying multimedia elements, Presentation templates and production templates.

Multimedia Object Management Module

The multimedia Object Management Module controls the presentation and modification of multimedia elements and derived multimedia element classes. This module is central to other modules in the system.

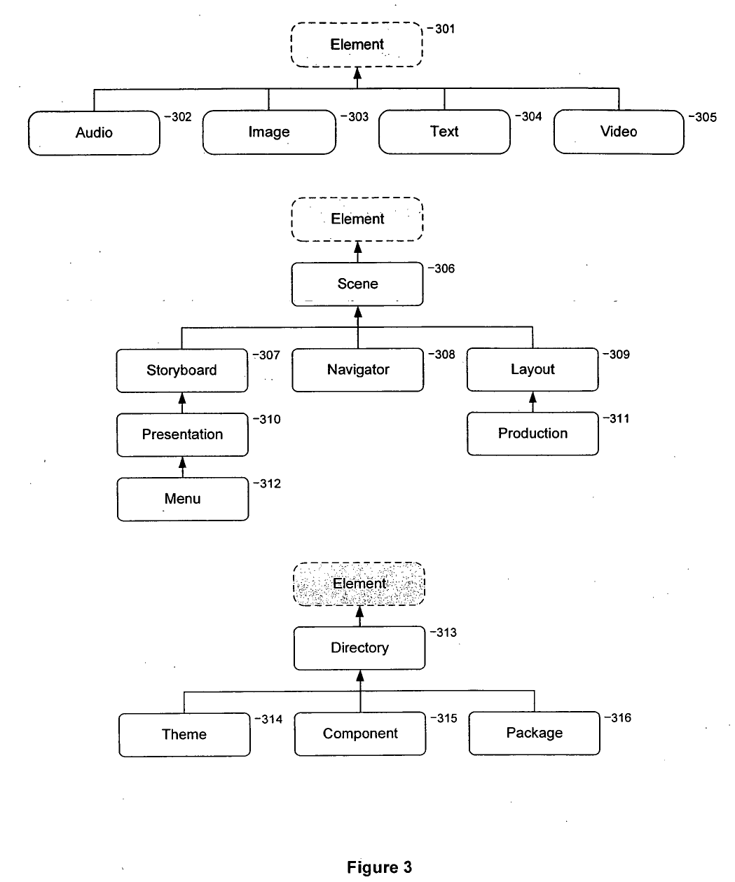

The core methods associated with this module are related to the class hierarchy and input/output protocols. Referring to FIG. 3 the base element class 301 defines the basic characteristics and behaviors of primitive multimedia objects. System assemblies adhere to a hierarchy and protocol process including two organizational elements. First, a class hierarchy defines the structural organization of classes. The base element defines core behavior and characteristics. Advanced elements add hierarchy containment. And package elements provide a ‘data-to-media element’ push model. Second, input/output protocols defines the input/output or request/fulfillment dynamics of class objects. Basic elements provide presentation and motion methods of interaction. Advanced elements add timing controls and media management, and package elements define categorization and high level production containment.

Packages provide element initialization and control information to system applications. Packages define a global theme tree, associated applications, an underlying database, and server and client media components.

Each component defines the data items (multimedia, executable, database, etc) that will either be accessible by the user or stored to Web, CD, DVD, or disk. For example, the following XML implementation code shows a partial package assembly associated with a product release where the Package contains several component sub-assemblies.

<Package

| | |
|---|---|
| title | = “SMG-MoviePro” |
| src | = “&smgmedia;” |
| thumbnail | = “&smgbin;♯SMG-MoviePro.jpg” |
| > | |

```
    <!-- (1) Theme Trees -->
    <Component
```

| | |
|---|---|
| id | = “SMGThemeTree” |
| title | = “Movie Magic” |
| src | = “&bpmedia;♯Component-MovieMagic.xml” |
| > | |

```
    </Component>
    <Component
```

| | |
|---|---|
| id | = “SMGThemeTree” |
| title | = “Game Face” |
| src | = “&smgmedia;♯GameFace♯Component- |

```
        GameFace.xml”
        >
    </Component>
    . . .
</Package>
<Component
```

| | |
|---|---|
| title | = “Movie Magic” |
| src | = “%BPServerMedia%” |
| > | |

```
    <!-- (2a) BASE PRODUCTIONS -->
    <Theme
```

| | |
|---|---|
| src | = “&bpamericantribute;/♯Theme- |

```
        AmericanTribute.xml”
    />
    <Theme
```

| | |
|---|---|
| src | = “&bplegacy♯Theme-Legacy.xml” |
| /> | |
| <Theme | |
| src | = “&bplegacygarden ♯Theme-LegacyGarden.xml” |
| /> | |
| . . . | |

</Component>

Base Elements

Base elements include: Audio, Document, Image, Text, and Video. These objects handle basic associations between operating system specific files (such as .txt, .png, mpg) and the internally managed multimedia items.

The core method associated with this class hierarchy is the structural organization and the definition of a key set of methods, including: reading and writing, rendering and capturing, presentation and interfaces. Element classifications contain internal drivers, interpreters, and encapsulation methods that dynamically categorize and present specific types of operating system dependent multimedia file formats. For instance, the SMGImageElement class recognizes many types of photographic image formats, including .png, tiff, bmp, jpg. Derived objects user either the base method implementation or override features for their own use.

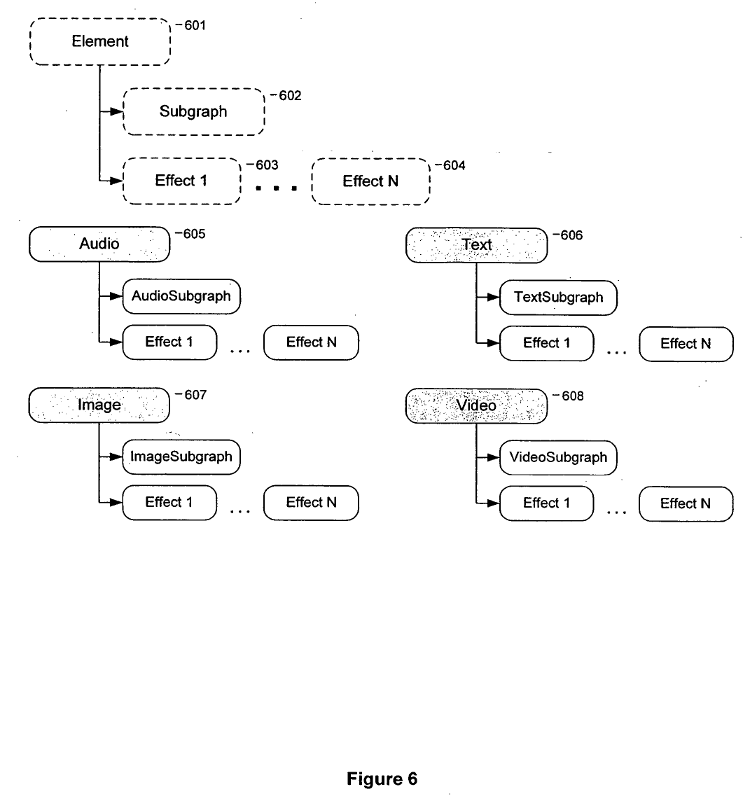

Now referring to FIG. 6, in addition to basic behavior and characteristic attributes, base elements contain one Subgraph 602 and one or more Effects 603. The implementation depends on the type of element and the desired features programmers want to add to the element object.

The following partial class definitions show this interface with a C++ implementation for the SMGElement, SMGImageElement, and SMGTextElement classes (where the ‘virtual’ declaration allows derived classes to replace the functional interface for that module):

```
class SMGElement
{
public:
    // class initialization
    static void ClassInitialize(void);
    static void ClassRestore(void);
    // read/write capabilities
    virtual void XmlRead(XmlBuffer &xml,
                        bool recurse = true);
    virtual void XmlWrite(XmlBuffer &xml,
                          bool recurse = true);
    // presentation interface
    virtual bool BeginPresentation(CRenderEngine *pRenderEngine);
    virtual bool EndPresentation(CRenderEngine *pRenderEngine);
    // windowing interface
    virtual CRect Draw(CDC *pDstDC,
                CRect dstRect,
                UINT visibleClasses,
                UINT action,
                UINT state);
    . . .
};
class SMGImageElement : public SMGElement
{
public:
    // override base presentation interface
    virtual bool BeginPresentation(CRenderEngine *pRenderEngine);
    virtual bool EndPresentation(CRenderEngine *pRenderEngine);
    . . .
}
class SMGTextElement : public SMGElement
{
public:
    // override read/write capabilities
    virtual unsigned long XmlMatchToken(XmlBuffer &xml,
                                          XmlToken *pToken);
    virtual void XmlWrite(XmlBuffer &xml,
                          bool recurse = true);
    // override windowing interface
    virtual CRect Draw(CDC *pDstDC,
                CRect dstRect,
                UINT visibleClasses,
                UINT action,
                UINT state);
    . . .
}
```

Advanced Elements

Advanced elements include: Scene, Presentation, Navigator, and Production. These objects add the following methods to the base SMGElement class definition: directory management (parent/child relationship), control timing elements (start-time, end-time), automated population of primitive element definitions, and navigation control.

These constructs do not have an operating system equivalent, but rather are composite objects that allow the organization and management of primitive, or other advanced elements. Each advanced element may be defined and operated in a separate, or reusable fashion.

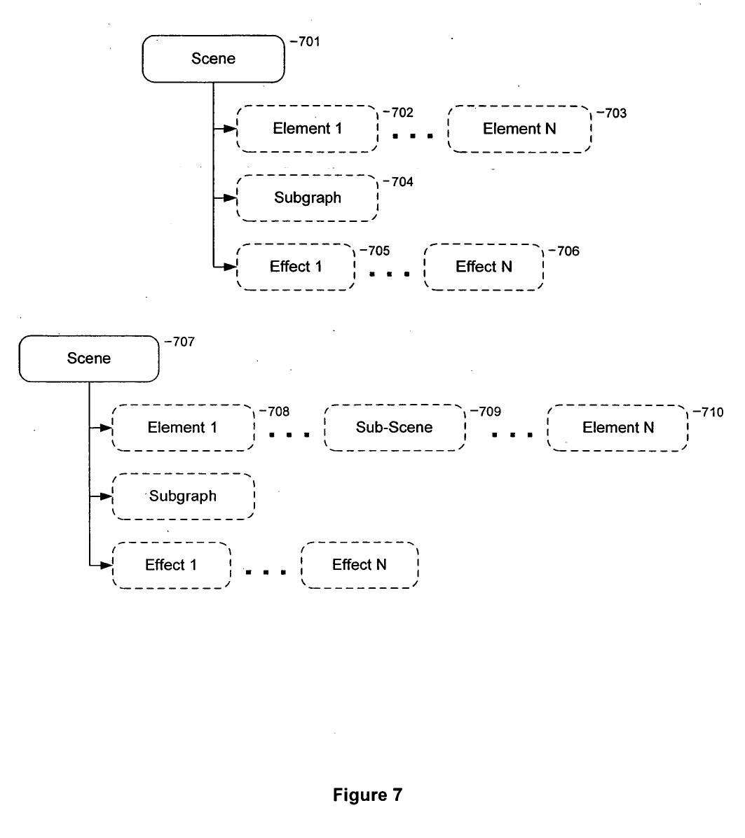

Referring to FIG. 7, in addition to basic behavior and characteristic attributes, advanced elements (encapsulated in Scenes) contain one Subgraph 704, one or more Primitive Elements or Scenes 702, and one or more Effects 705. The implementation depends on the type of element and the desired features programmers want to add to the advanced element object.

The following partial class definitions show this interface with a C++ implementation for the SMGElement, SMGSceneElement, and SMGProductionElement classes (where the ‘virtual’ declaration allows derived classes to replace the functional interface for that module):

```
class SMGElement
{
public:
    // advanced element/list support
    int Count(UINT visibleClasses = IDC_ALLELEMENTS) const;
    SMGElement *Find(const char *pName);
    SMGElement *GetFirst(void) const;
    SMGElement *GetNext(void) const;
    SMGElement *GetParent(void) const;
    SMGElement *GetRoot(void) const;
    virtual bool Insert(SMGElement *pInsertData,
                      SMGElement *pInsertBefore = NULL);
    virtual bool Remove(SMGElement *pData);
    . . .
};
class SMGScene : public SMGElement
{
    // override presentation interface
    virtual bool BeginPresentation(CRenderEngine *pRenderEngine);
    virtual bool EndPresentation(CRenderEngine *pRenderEngine);
    . . .
};
class SMGPresentation : public SMGScene
{
    // data access
    bool Populate(SMGElement *pSrcTree);
    // override presentation interface
    virtual bool BeginPresentation(CRenderEngine *pRenderEngine);
    virtual bool EndPresentation(CRenderEngine *pRenderEngine);
};
```

The exemplary product provides various algorithms for combining and filling the content slots made available through presentation and production templates. These algorithms are controlled by the behavior/characteristics module described later in this section.

Package Elements

Package elements include: File, Directory, Theme, Component, and Package. These objects add the following methods to the base SMGElement class definition: system organization and control, pre-defined user access to related sresentation and production modules, and finished production output control.

The File and Directory items have an operating system equivalent, but the Theme, Component, and Package constructs are composite objects that allow the organization and management of specified multimedia and application items. The Package element adds a powerful mechanism that allows a pluggable component methodology (meaning, components can be plugged into more than one package).

The following partial class definitions show this interface with a C++ implementation for the SMGElement, SMGDirectory, and SMGComponent (where the ‘virtual’ declaration allows derived classes to replace the functional interface for that module):

```
class SMGElement
{
public:
    // element/list support
    virtual bool Insert(SMGElement *pInsertData,
                      SMGElement *pInsertBefore = NULL);
    virtual bool Remove(SMGElement *pData);
    // read/write capabilities
    virtual void Read(bool recurse = true);
    virtual void Write(bool recurse = true);
};
class SMGDirectory : public SMGElement
{
public:
    // override element/list support
    virtual bool Insert(SMGElement *pInsertData,
                      SMGElement *pInsertBefore = NULL);
    // override read/write capabilities
    virtual void Read(bool recurse = true);
    virtual void Write(bool recurse = true);
};
class SMGComponent : public SMGDirectory
{
public:
    // override element/list support
    virtual bool Insert(SMGElement *pInsertData,
                      SMGElement *pInsertBefore = NULL);
    // override read/write capabilities
    virtual void Read(bool recurse = true);
};
```

Support Elements

There is only one support element: ExtendedInfo. This object adds the ability to read, modify, and write Database specific information, such as: captions, date a photograph was taken, element descriptions, etc.

The following partial class definitions show this interface with a C++ implementation for the SMGElement, SMGTextElement, and SMGExtendedInfo classes:

```
class SMGElement
{
    // data access and storage
    const char *GetDstLink(void);
    void SetDstLink(const char *pSrcLink);
    const char *GetSrcLink(void);
    void SetSrcLink(const char *pSrcLink);
};
class SMGTextElement : public SMGElement
{
public:
    // additional data access and storage
    const char *GetCaption(void);
    void SetCaption(const char *pCaption);
    const char *GetDescription(void);
    void SetDescription(const char *pDescription);
};
class SMGExtendedInfo : public SMGTextElement
{
public:
    // additional data access and storage
    const char *GetComment(void);
    void SetComment(const char *pComment);
    const char *GetHyperlink(void);
    void SetHyperlink(const char *pHyperlink);
};
```

Theme Management

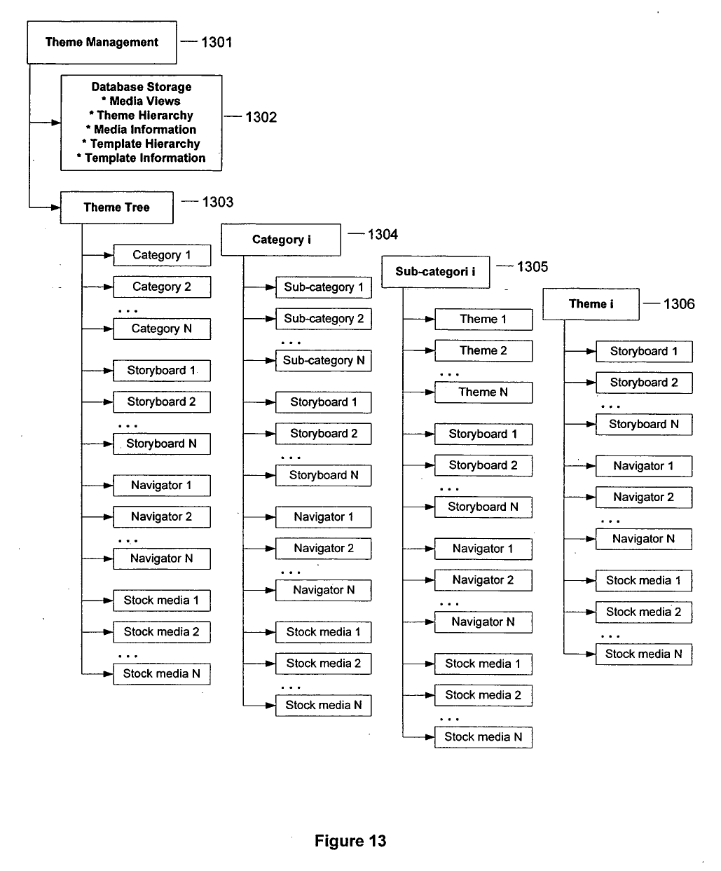

Theme categorization and presentation are handled by an N-level tree. FIG. 13 shows the root theme management module as well as database and theme tree organization, where sub-component assemblies contain categorization 1303, sub-categorization 1304, theme 1305, and ultimately the collection of presentations and productions 1306 with associated stock media.

Theme tree 1303 is the highest level theme definition. The theme tree defines major categories and generic sresentations, navigators, and generic stock media that are used in the system. Category 1304 provides a broad categorization of theme items. Categories act as hierarchal directory structures to sub-categories and more theme specific presentations, productions and stock media. Sub-Category 1305 is a narrowed categorization based on the parent category. Sub-Categories are similar to parent category classes, but contain theme structures rather than additional sub-category structures. Theme 1306 is a final categorization in the theme tree. Themes contain stock media, navigators, and presentations that are associated with specific concepts such as holidays, activities, etc. Database Storage 1302 permits media to be sorted and viewed in various models. The underlying data has an original implementation, then various views and models based on: 1) the categorization and high level view that the user sees, 2) the type of output that is desired such as resolution, format type, client-server media fragmentation, and 3) optimizations appropriate for particular delivery systems, such as encryption and media type.

Theme Trees

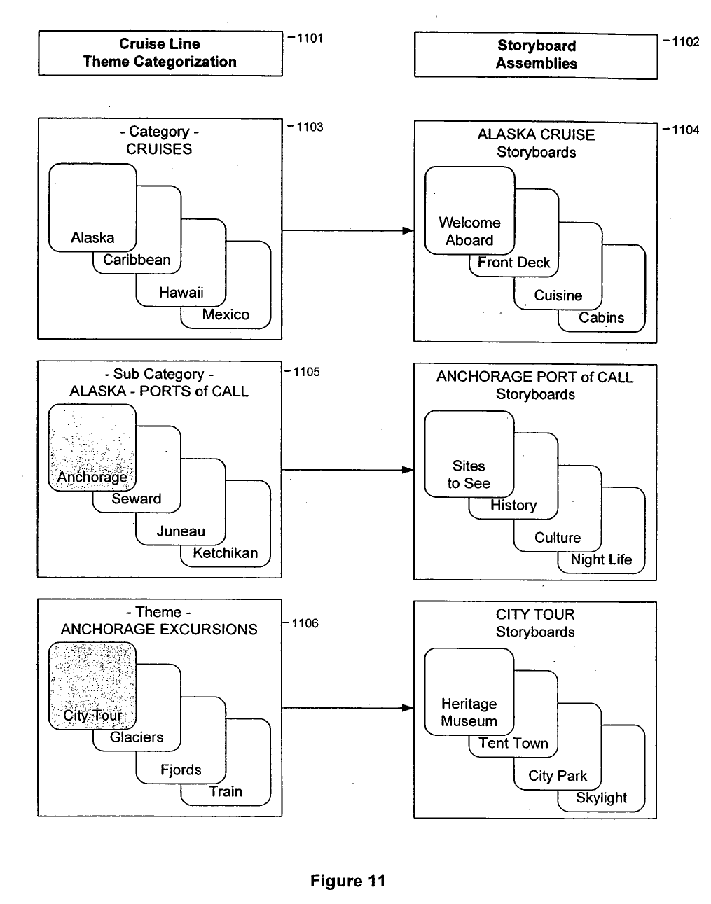

Production Templates, Navigator Templates, Presentations, Scenes, and Scene assemblies (i.e., the combination of multimedia elements) are professionally produced by a vendor and categorized based on theme. For instance, FIG. 11 shows a sample theme hierarchy (progressing from category 1103 to sub-category 1105 to theme 1106 organizations) and associated presentations 1104 that a vendor might create for the Cruise Industry.

The underlying system theme tree directory structure for the organization shown in the previous figure is represented by the following organization:

```
    ♯SequoiaMG♯Themes♯Cruises
♯Alaska
    Welcome Aboard
    Front Desk
    Cuisine
    Cabins
            ♯Anchorage
                Sites to See
                History
                Culture
                Night Life
                ♯City Tour
                    Heritage Museum
                    Tent Town
                    City Park
                    Skylight
                ♯Glaciers
                ♯Fjords
                ♯Train
            ♯Seward
            ♯Juneau
            ♯Ketchikan
    ♯SequoiaMG♯Themes♯Cruises♯Caribbean
    ♯SequoiaMG♯Themes♯Cruises♯Hawaii
    ♯SequoiaMG♯Themes♯Cruises♯Mexico
```

Theme organization allows the user to manage multimedia content, place their multimedia into themed presentations and productions. The exemplary system uses theme management to control the placement and view access to presentations and production templates, by pointing the user to a portion of the tree. At any given time, up to three levels of the tree may be viewed at any given time. FIG. 49 shows a sample hierarchal structure for the Sports Industry, including Sports Themes 4901 of Basketball, Soccer, Hockey, Football, etc., and finally Presentations 4902 that allow the User to present specific backgrounds and presentations according to the type of media they aquire.

The types of theme organization are unlimited. Abstract concepts such as moods, virtual reality, cinematic, and presentation concepts allow for additional theme tree organizations.

The method associated with theme management is a simple tree traversal, insertion and deletion mechanism that works on the globally accessible ThemeTree.

Packages

The Theme Tree Component defines the category hierarchy and associated presentation and production templates that are visible to the user. FIG. 15, item 1502 shows the Theme Tree assembly that contains Categories, Sub-Categories and Themes. The implementation of a Theme hierarchy is accomplished through implementation code. For instance, the following component describes the theme contents for a demo using XML hierarchal constructs:

<Theme

| | |
|---|---|
| name | = “Demo” |
| src | = “%SMGThemes%” |
| dst | = “%SMGThemes%”> |

<Theme

| | |
|---|---|
| name | = “SequoiaMG” |
| thumbnail | = “internet-access.jpg” |
| hyperlink | = “www.sequoiamg.com” |

```
  </Theme>
  <!-- Theme - Cinematic -->
  <Theme
    name  = “Cinematic”>
    <Presentation>“Action Image.xml”</Presentation>
    <Presentation>“Action Video.xml”</Presentation>
    <Presentation>“Active Image.xml”</Presentation>
    <Presentation>“Active Video.xml”</Presentation>
    <Presentation>“Slideshow Image.xml”</Presentation>
    <Presentation>“Slideshow Video.xml”</Presentation>
    <Presentation>“Storyteller.xml”</Presentation>
    <Presentation>“Storyteller-Natural.xml”</Presentation>
    <Presentation>“Life Sketch.xml”</Presentation>
    <Production>“%SMGThemes%♯Brochure.xml”</Production>
    <Production>“%SMGThemes%♯Motion Pictures.xml”</Production>
    <Production>“%SMGThemes%♯Photos on Shelf.xml”</Production>
    <Production>“%SMGThemes%♯Photos on Table.xml”</Production>
    <Production>“%SMGThemes%♯Transparent Frames.xml”</
    Production>
  </Theme>
  <!-- Theme - Virtual -->
  <Theme
    name  = “Virtual”>
    <Presentation>“Gallery.xml”</Presentation>
    <Presentation>“Hermitage.xml”</Presentation>
    <Presentation>“Legacy.xml”</Presentation>
    <Presentation>“School Years.xml”</Presentation>
    <Presentation>“Trad'nCards.xml”</Presentation>
    <Production>“%SMGThemes%♯Brochure.xml”</Production>
    <Production>“%SMGThemes%♯Motion Pictures.xml”</Production>
    <Production>“%SMGThemes%♯Photos on Shelf.xml”</Production>
    <Production>“%SMGThemes%♯photos on Table.xml”</Production>
    <Production>“%SMGThemes%♯Transparent Frames.xml”</
    Production>
  </Theme>
  <!-- Theme - Presentation -->
  <Theme
    name  = “Presentation”
    <Presentation>“Training.xml”</Presentation>
    <Presentation>“Relfections.xml”</Presentation>
    <Presentation>“Branding.xml”</Presentation>
    <Production>“%SMGThemes%♯Brochure.xml”</Production>
    <Production>“%SMGThemes%♯On the Course.xml”</Production>
    <Production>“%SMGThemes%♯Motion Pictures.xml”</Production>
    <Production>“%SMGThemes%♯Photos on Shelf.xml”</Production>
    <Production>“%SMGThemes%♯Photos on Table.xml”</Production>
    <Production>“%SMGThemes%♯Transparent Frames.xml”</
    Production>
  </Theme>
  <!-- Theme - Other -->
  <Theme
    name  = “Other”
    <Presentation>“Credits.xml”</Presentation>
    <Presentation>“ImageEffects.xml”</Presentation>
    <Production>“%SMGThemes%♯Brochure.xml”</Production>
    <Production>“%SMGThemes%♯Motion Pictures.xml”</Production>
    <Production>“%SMGThemes%♯Photos on Shelf.xml”</Production>
    <Production>“%SMGThemes%♯Photos on Table.xml”</Production>
    <Production>“%SMGThemes%♯Transparent Frames.xml”</
    Production>
  </Theme>
</Theme>
```

Managed Media

Managed media has a similar construct to Theme Management, but manages user media rather than pre-defined vendor created media. FIG. 10 shows the root media management module 1001 as well as database 1002 and media tree organization 1006. A production-store 1006 provides the highest media theme definition. Production store defines major categories like the theme tree, but only stores productions and production sub-assemblies (based on output resolution, default language, etc.) Backing-Store 1002 contains the core methodology for media storage (excluding productions and sub-productions). The backing-store architecture relies on a year-month-day-time stamp of the media. Database storage 1010 contains a database that relates theme hierarchies, alternative classifications (based on chronology, content of people, description, location, etc.). Database records point to media and production files located either in the production-store or backing-store directory hierarchies, but can be viewed by the user in various points-of-view.

Media Trees

Once a user's content media is used in a presentation or production, it is managed by the system. The management structure contains a reference to the original media item, allows various methods to categorize and describe the item, and stores multiple reference/link information in a database. These categorization techniques include viewing by name, by theme categorization and hierarchy, by chronological date, by content description, by family or corporate relationships, by Smithsonian style cataloging system or in raw form.

The back-end storage for media elements is done by a year/month/day sorting algorithm. For instance, the following shows the partial organization of a set of presentation items:

```
♯2004♯1
    ♯5
        MVI_065172.avi
    ♯15
        scan10021.jpg, scan10042.jpg, scan10013.jpg, scan10014.jpg
    ♯16
        image0103403.jpg, image0103022.jpg, image0103043.jpg
        video10001041.avi, video1002032.avi, video1002033.avi
        audio1230991.mpg, audio0130022.mpg
```

Media Encryption and Security

The exemplary product adds security features at every level of the assembly hierarchy, beginning at the primitive element level through the presentation and production levels. For instance, individual photo elements may be internally locked so down-stream users cannot unlock, replace or modify the individual photo contents. This feature may is also enlisted for scenes or even completed presentations and productions.

Security is implemented through a client/server encryption key method where the “behavior and presentation” aspects of the element are secured by the encryption key. A vendor maintains encryption key configurations, embeds a portion of the key with the managed media component and then ships the encryption unlocking component when it ships packages and components.

Media Sharing

Media sharing is accomplished through ‘virtual links.’ These links are maintained by the database, and point to media managed in the ‘Year-Month-Day-Time’ media tree organization described above. Primitive and Scene Media components are typically those most commonly shared by the user. The sharing model includes the following sharing privileges:

| | |
|---|---|
| PERSON | Only the user is allowed access to the media. |
| FAMILY | Only immediate family members, such as spouse, |
| | children, parents, (identified in the family portion of the |
| | database) are allowed to share media information. |
| MARRIAGE | Only those people identified as a ‘spouse’ in the marriage |
| | database are allowed access to the media. |
| EXTENDED | Allows immediate family members, as well as |
| FAMILY | relationships obtained through the marriage relationship, |
| | to share media. |
| FRIENDSHIP | Only pre-identified friends (identified in the person |
| | portion of the database) are allowed to share media |
| | information. |
| WORLD | Allows open sharing to users of related software |
| | applications. |

In addition, the following corporate organization sharing privileges exist:

| | |
|---|---|
| TEAM | A small group of individuals related by project |
| | or task. Similar to the FAMILY setting above. |
| DEPARTMENT | A section of an organization. Similar to the |
| | EXTENDED FAMILY setting above. |
| DIVISION | A major portion of the organization. |
| COMPANY | The complete organization. |

Stock and Specific Media

Stock and Specific Media are contained in the base Server SequoiaMG directory. It includes any specific stock photographs, images, video and audio clips, documents, or text files used during the application's presentation. Users can create and replace established stock media elements of a presentation with media they designate with stock-media access.

Media trees are defined within the package implementation. FIG. 15, items 1505 and 1506, shows how Server Media and Client Media are stored in relationship to the general Category, Sub-Theme and Theme constructs used previously in this section. For instance, the following describes both the client and server media component locations in terms of XML hierarchal constructs:

| <Package | |
|---|---|
| name | = “aVinci” |
| thumbnail | = “%SMGThemes%♯aVinci.jpg”> |
| ... | |
| <!-- Server Media --> | |
| <Component | |
| src | = “%SMGPackages%♯Component- |
| ServerMedia.xml” /> | |
| <!-- Client Media --> | |
| <Component | |
| src | = “%SMGPackages%♯Component- |
| ClientMedia.xml” /> | |
| </Package> | |
| <Component | |
| name | = “Stock Media” |
| src | = “%SMGServerMedia%” |
| add-setting | = “stock-media”> |
| </Component> | |
| <Component | |
| name | = “User Media” |
| src | = “%SMGClientMedia%”> |

</Component>

Client and Server components can define one or many root locations where media is located. The root element manages each of the definitions given within the package and defines a hierarchal tree of multimedia files and productions.

Interface Module

The Interface Module handles high level presentation, editing, and control of media elements. Media is presented through one of the general process method described in the general four-step process described above.

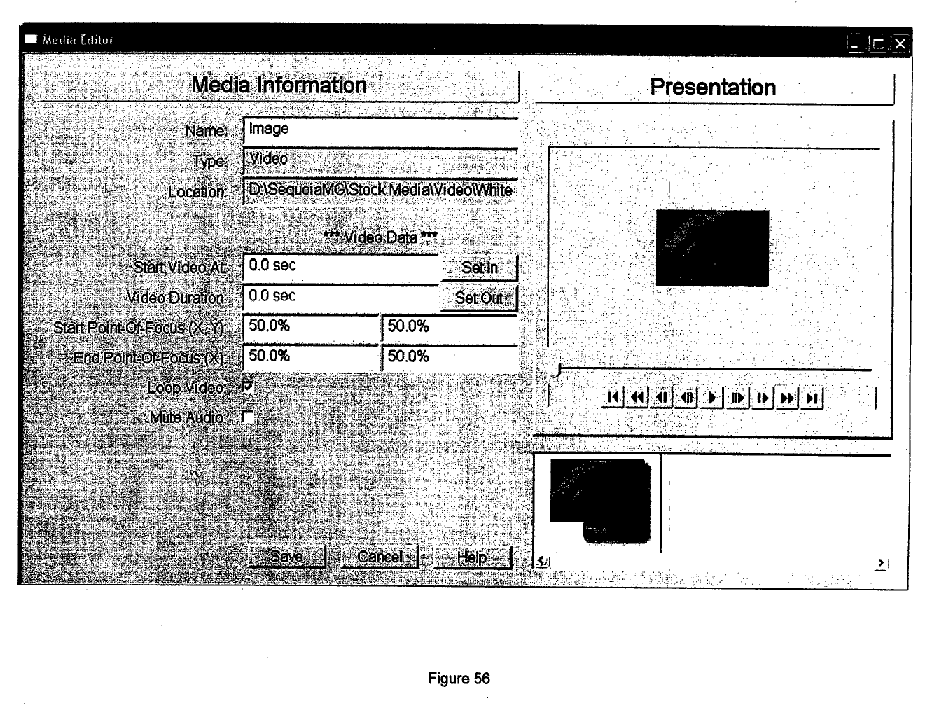

Presentations and authoring software allow the customer to digitally ‘frame’ their content. Just as Hallmark is associated with beautiful and effective card collections, a software product may create beautiful and effective backdrops and presentations where the customer can reflect their thoughts, ideals, and feelings. Presentations, Presentations, Productions and core primitive elements are presented and edited using various sub-systems within the architecture. Primitive multimedia object editing is handled by a simple dialog interface. Referring to FIG. 56, the interface for video multimedia is presented, which allows the user to edit the video name, the starting and ending times to be used during the controlling presentation, and the areas of user attention (eye focus on the video).

Element Palettes

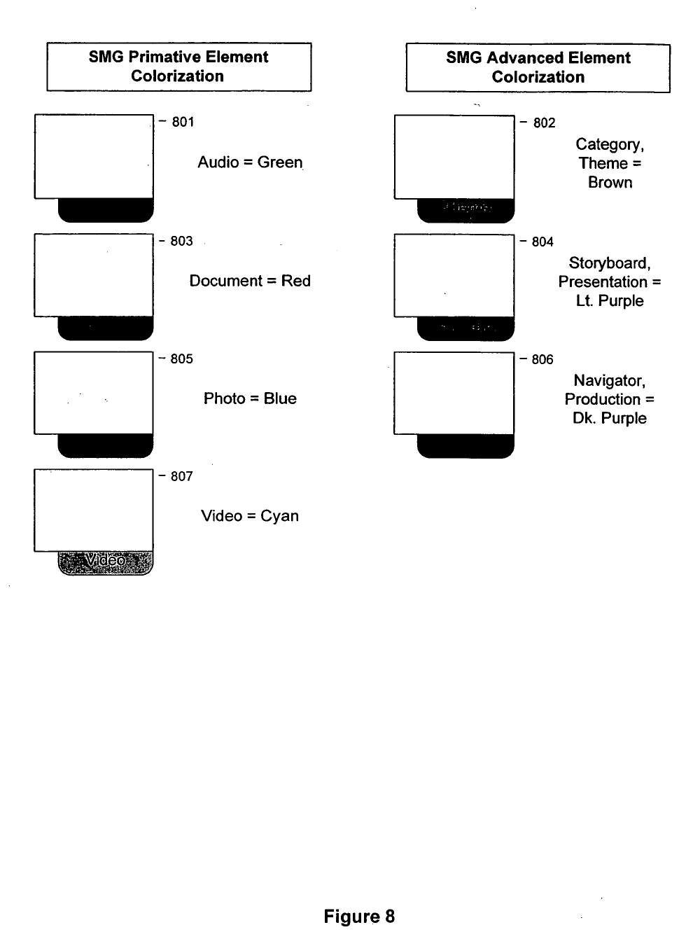

The exemplary system simplifies user interaction by providing “color coded” media stamps on user and production material. The color codes are employed for audio clips, images, photographs, video clips, documents, and captions and provided feedback between user media and the supplied presentation. FIG. 8 shows the color containment associated with hierarchal levels of presentation creation and multimedia presentation. In particular, Primitive Elements such as Audio 801, Document and Text 803, Photographs 805, and Video 807 have distinct coloration that users can easily identify in the creation process. In addition, advanced hierarchies, such as Themes 802, Presentations 804, and Navigators 806 also provide color combinations that immediately identify the context and nature of multimedia presentation.

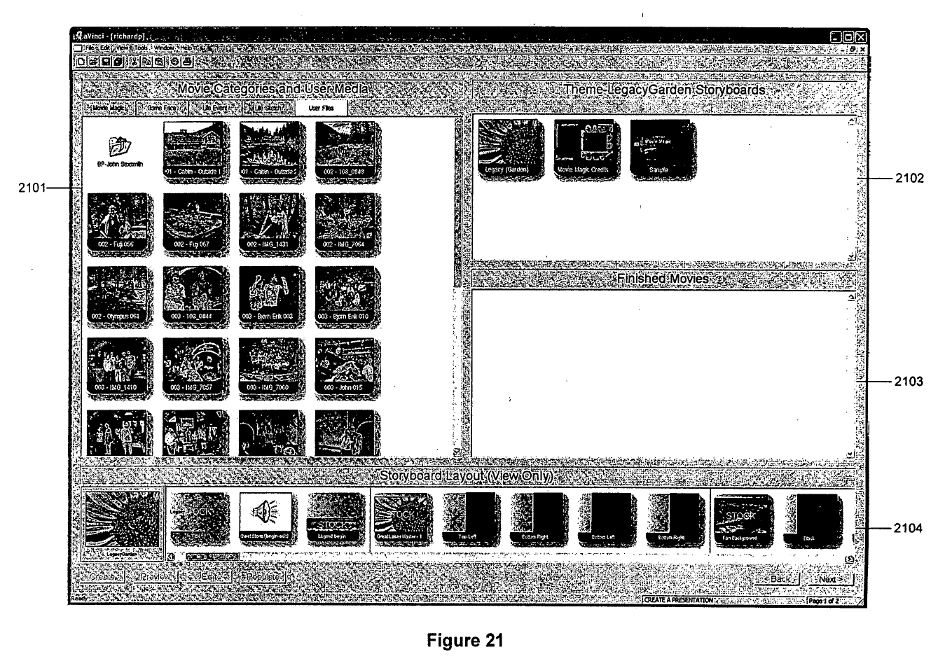

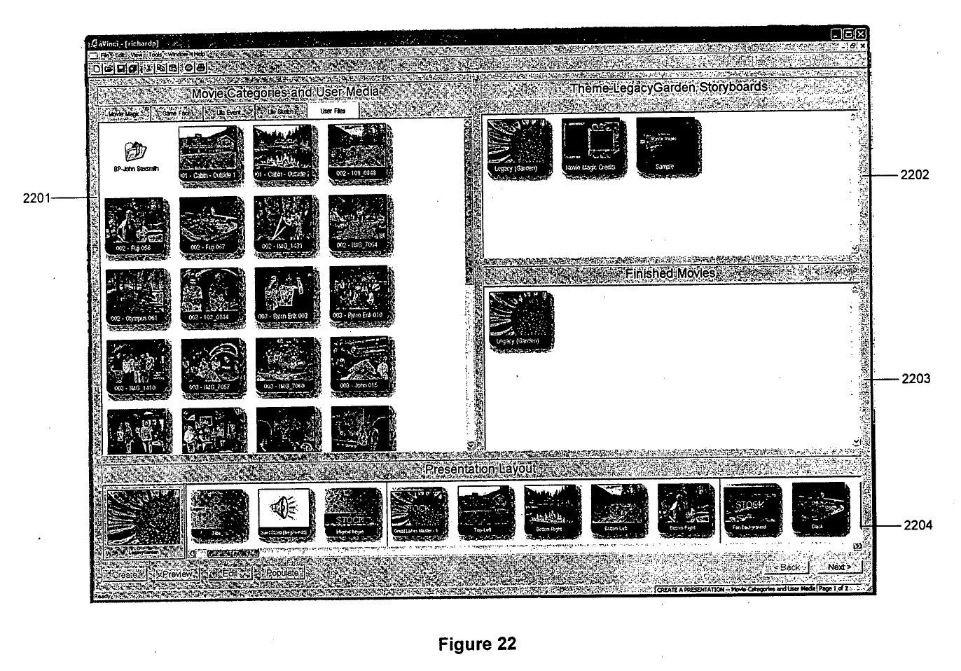

Color coordination is used when presenting media, when showing incomplete presentations and productions, and where the user matches media items with required presentation items. For instance, the following diagram shows user media in the left portion of the output page and empty media slots in the presentation layout, located on the bottom of the page. FIG. 21 shows the User interface associated with a Legacy Themed Presentation. The initial Presentation Layout 2104 shows several blank, or empty photographic slots where the user may contribute material. FIG. 22 shows the Layout 2204 once media has been dropped into matching blank slot entries. Users match raw media color items (photographs, video clips, audio clips, text) with matching empty media slots in the Presentation, which produces a filled and complete presentation ready for production.

In the above example, the presentation requires 1 audio element (green), 4 image/photo elements (blue), 1 video element (cyan), and 6 caption elements. Visible user media consists of 19 photo (blue) items.

Theme, Managed Media and User Media Trees

Three Media Trees are managed by the exemplary product: the Theme Tree, The Server Media Tree, and the User Media Tree. The presentation of these trees is allowed at various times in applications, and typically contains either a ‘directory-file’ or ‘flat-file’ type interface

Media presentation is managed by global tree pointers that contain the true-root, root, and current tree element. For instance, FIG. 13 shows how a media tree may contain layout pointers based on the Theme Tree root 1303, 1st Sub-Category 1304, and 1st level presentation 1306. Pointers maintain user context from a root, currently visible root, and current presentation.

Presentation Module

The Presentation Module renders image, video, audio, and textual information to the screen and ultimately mixes these inputs into an output presentation for use on Web, DVDs, CD, disk, and other computer multi-media access tools. The render engine uses operating system or specialized software components that render, present, and burn presentations and productions into a final delivery item.

The Render Control module is a complex system that defines hierarchal timing structures, three-dimensional presentation spaces, and control & interaction render components for various types of multimedia and various special effects. This module's core methods ‘mix’ multimedia components at run-time in a ‘real-time’ framework, which shortens typical render/burn operations.

Database Module

The Database Module collects and organizes the materials used in presentations, including: Audio, Video, Image, Text and Document elements. These elements are collected into higher-level organizations including Scenes and Presentations. The material has five important methods (1) where static information, such as a name, description, date, and location are tied to the generic multimedia materials, (2) where the material is added to a presentation which defines behavior and characteristic elements that are unique to the presentation, (3) view into the underlying multimedia element (this includes name, date, location, description, category context, and other views that are dynamically created and used), (4) where the media is actually stored (the internal methods determine the appropriate distributed system that contains raw data and finished presentations and productions. this may be a combination of data residing on the local system, close area communication and storage with system databases, internet accessible locations throughout the country and world where the customer resides) and (5) internal audit and inventory systems, similar to automobile component assembly systems, that guarantee the availability of multimedia items and productions, as well as track the use, exposure, licensing and security of managed media.

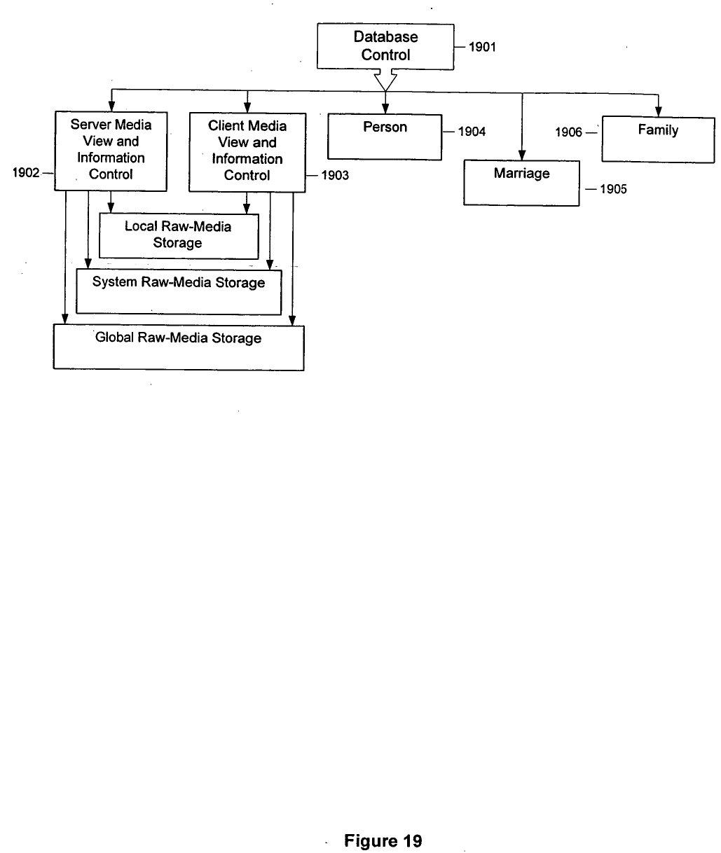

The database also contains category information, personal profiles, and personal data that aid in the development of enterprise level editions of the product. Referring to FIG. 19, the database control resides with Server Media Information 1901, Client Media Information 1902, Person 1903, Marriage 1904 and Family 1905 relationships.

The main focus of this information is to add family (or close associations) and friend relationships (layered associations) so multimedia materials (photos, videos, audio tapes) can be shared in their raw form with friends, family, and associates; or where the built presentations and productions can be shared in a similar fashion. The following diagram shows the set of methods associated with the database control:

```
class Database
{
public:
    static void ClassInitialize(void);
    static void ClassRestore(void);
    // general
    FamilyAccess *LockFamilyAccess(void);
    MarriageAccess *LockMarriageAccess(void);
    MediaAccess *LockMediaAccess(const char *pFileName);
    PersonAccess *LockPersonAccess(void);
    void UnlockFamilyAccess(FamilyAccess *pFamily);
    void UnlockMarriageAccess(MarriageAccess *pMarriage);
    void UnlockMediaAccess(MediaAccess *pMedia);
    void UnlockPersonAccess(PersonAccess *pPerson);
};
```

Package Implementation

Database access is defined within the package implementation. FIG. 15, item 1504, shows the the relationship of the database component within a package, beginning with the Data base module, and pushing down control to the Server Media, Client Media, Person, Marriage, and Family modules. For example, the following describes both the client and server database locations:

| | |
|---|---|
| <Package | |
| name | = “aVinci” |
| thumbnail | = “%SMGThemes%\aVinci.jpg”> |

```
  <!-- Database Directory -->
  <Component
    src = “%SMGPackages%\Component-Database.xml” />
  ...
</Package>
<Component
  name = “Database”
  src  = “%SMGServer%\Database”>
  <!-- User -->
  <File>“PERSON.CDX”</File>
  <File>“PERSON.DBF”</File>
  <File>“PERSON.FPT”</File>
  <File>“FAMILY.CDX”</File>
  <File>“FAMILY.DBF”</File>
  <File>“MARRIAGE.CDX”</File>
  <File>“MARRIAGE.DBF”</File>
  <!-- Raw Materials -->
  <File>“THEME TREE.CDX”</File>
  <File>“THEME TREE.DBF”</File>
  <File>“THEME TREE.FPT”</File>
</Component>
```

Behavior/Characteristic Declaration Module

The exemplary product ties behavior and characteristics with the primitive and advanced templates, not with the original media. The original media simply becomes one of the input factors associated with the sub-assembly, instead of the characteristics being tied with the media. This allows for the simple replacement of user media, where the overall structure and composition of the presentation remains intact.

The implementation of the behavior/characteristics hierarchy is accomplished through three structural models and associated methods, including a render component, an attribute component and an effect component.

The Render Component provides the environment and destination specific rendering features so the user can preview media and presentations, capture presentations for later use, or burn presentations to a specific output media. The Attribute Component defines the core and run-time specifications associated with a particular media item. The Effect Component defines the run-time effects that manipulate the multimedia object's rendering component. This module uses standard 3-D graphic algorithms, as well as advanced matrix and vector calculations based on time and the mixing algorithm associated with the encapsulating scene, presentation, or production.

Capture Module

The capture module is similar in functionality to the Render Module, described above, but the output media is a single multimedia file (e.g., mpeg, avi) instead of a run-time mixing model (as is the case with previewed presentations and productions). The capture module contains conversion drivers that take various input forms, such as bitmaps, textures, presentation spaces, surfaces, etc. and convert those formats to a consistent underlying format, such as the Moving Pictures Expert Group (MPEG) and Windows Audio Video Interleaved (AVI) formats.

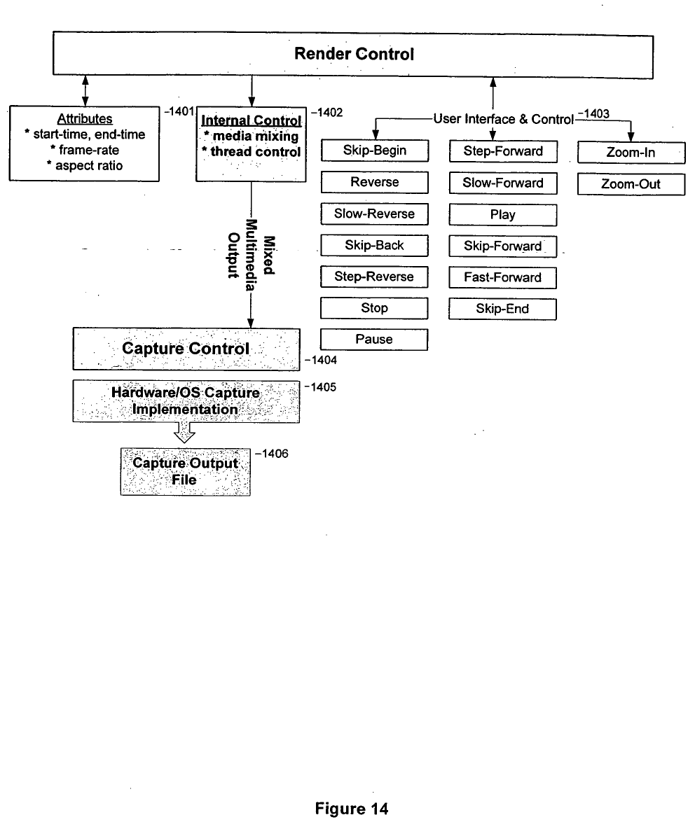

Referring to FIG. 14 shows how the Capture control analyses mixed media, frame-by-frame, and captures the output to industry standard encodings.

Burn Module

The Burn Module obtains individual production and presentation media, along with underlying multimedia elements, and burns to various output media. FIG. 23 shows how final presentation and production encodings are interpreted by a controlling output handler, that determines whether to encode Screen Display versions 2304, DVD and CD-Rom versions 2305 or Printer 2306 versions of output

The Burn Module uses package input information to determine the type and location of content media that will be output to disk, CD, DVD, Printer, or Web, or other output media. The burn module dynamically loads appropriate object methods according to the destination type.

General Installation and Upgrade Module

The exemplary system uses an installation program to copy the application, required DLLs and associated application files to the end-user's computer, embedded device, or media device. The following directories are created, and the following applications and files, are copied:
\SeqoiaMG\aVinciDatabase—ThemeTree.CDX, ThemeTree.DBF, ThemeTree.FPT, Person.CDX, Person.DBF, Person.FPT, Family.CDX, Family.DBF, Marriage.CDX, Marriage.DBF, MemoryTree.DBF, MemoryTree.CDX, MemoryTree.FPT. These files contain the database connections between user information and their associated memory elements and productions.
\SeqoiaMG\a Vinci\Bin—5 mgProductionBuilder.exe and 5 mgVideoPresenter.exe. These files are the production building and presenting modules for computer use. SmgProductionBuilder also produces the appropriate output files for use on DVD and CD-Rom.
\SeqoiaMG \a Vinci \Themes—Sub-directories under this directory are determined by the type of modules installed by the application user. At a minimum, a Moods and Sample set of presentations, stock images, audio clips and video clips are copied to this directory.
\SeqoiaMG \a Vinci\StockMedia—Media specific to various themes.
\Documents and Settings\<Personal Profiles Directory>\SequoiaMG—This directory contains the productions, user copied or linked images, documents, audio clips, and video clips associated with productions. The clips are quick renderings of the actual image which is typically identified by a URL. The quick rendering consists of a thumbnail image (120×90 pixel).
Automatic User Identification—This is accomplished by adding one database entry <User Name>to the SFV database (in the person.DBF and person.FPT) files. The user information consists of names, birthdates, parents, marriage, and family information, and personal preferences.
Presentations—These consist of both .MP2 final production files, and .XML intermediate files: These files are created in the \Document and Settings\<Personal Profiles Directory>\SMG directory when the user identifies a presentation for production.

The exact contents of any particular installation are dependant on package parameters. For instance, installation deliveries for the real-estate, direct marketing, and general use markets may be handled by three different packages that share some, but not all package information.

Package Installation & Update Module

Package installation is handled in a manner similar to general installation, but typically only contains Theme Tree hierarchies, with associated encryption and sharing rights. The Package installation installs according to the following protocol: (1) if content media does not already exist for the package component, contents are added to appropriate databases and media trees, (2) if content media already exists, the package installs the latest version onto the destination hardware/software configuration and (3) if content media already exists and is more recent, the package installation is ignored.

Support Module

The support module contains various software components to support the other modules. Supplied within this module are a System Diagnostics, Error Handling, Help Management, Branding and User Information and Preferences components.

System Diagnostics

System diagnostics are handled by a debug support component. This component is used to test code coverage, to check for memory and system allocation errors, and to run module-by-module diagnostics. The following diagnostic levels are defined:

| | |
|---|---|
| INFO | Presents general textual information to the user. |
| USER | Indicates the user performed a step of interactions |
| | that was either invalid or that needs associated |
| | diagnostics. |
| TIME | Presents timing diagnostics on presentations, |
| | capturing, burning, and general process flow. |
| PROGRAM | Presents general program flow diagnostics. |
| RESOURCE | Evaluates resource usage and maintenance. |
| FATAL | Handles system failures that require special handling |
| | and shutdown. |
| CONSISTENCY | Handles system consistency issues, such as media |
| | allocation, module resource consumption, and general |
| | process flow. |

Help Management

Help is handled by a help management support component. This component allows various levels of help, based on requested system granularity. The following help information is available:

| | |
|---|---|
| MINIMUM | Removes all or most run-time help |
| | information. This does not turn off all help, but |
| | user must request specific help for this module |
| | to become active. |
| TOOLTIPS | Requests tool-tip, or brief help on a given |
| | topic, selection, or implementation step. User is |
| | presented with in-line or context sensitive help |
| | based on their progress in the set of creation |
| | methods. |
| GUIDES | Provides general help guides throughout the |
| | application. Help Guides are typically |
| | presented either at the bottom of the screen, or |
| | within the framework where the user is |
| | currently working. |
| MAXIMUM | A combination of all help options. |
| HELP_MESSAGE, | Gives general step-method feedback to the |
| HELP_INDICATOR | user, based on what part of the creation set of |
| | methods they have completed. |

Branding

The Branding module allows customers to radically alter the presentation and interaction of applications. Although it does not change the general and sub-architecture designs, it presents a market specific context to the application. Branding features include: 1) font types, sizes and colors, 2) background colors and images, 3) application user interface layouts and interactions, and 4) media presentation items such as thumbnail images and presentation size.

User Information & Preferences

The final support module is user information and preferences. This module uses underlying hardware and system information to determine attributes and preferences of the user. This includes: 1) the user's login name, 2) underlying client and server media paths, 3) language and locale preferences, 4) user access privileges, and 5) default encryption and license information.

Reference Implementation

General Architecture

A unique XML definition has been architected that handles multimedia behavior, characteristic, and rendering requests. This documentation describes an XML sample implementation of the architecture and methods described above.

The exemplary XSD definition may adhere to standards set for by the World Wide Web Consortium (W3C) and may extend the XML definition language to include multimedia behavior and characteristics. The following major components are included in the XSD definition: (1) core constants, variables, and base class definitions, (2) primitive elements, (3) scene elements, (4) composite elements, (5) special effect elements, (6) advanced special effect elements, (7) data elements, (8) media data elements, (9) property descriptors and (10) requirements. Described below is elemental behavior and characteristics associated with program objects. Each section contains 1) a general element description, 2) a description of the element and associated attributes, and 3) a sample xml snippet that shows the element's use, and finally 4) the technical XSD schema definition.

Core Elements and Constants

Constants

The following XML constants are defined by SequoiaMG:

| | |
|---|---|
| %SMGServer% | Resolves to the SequoiaMG server directory. The actual location |
| | depends on the specified installation location but typically contains |
| | the path “...♯SequoiaMG”. |
| %SMGServerMedia% | Resolves to the SequoiaMG server media directory. The actual |
| | location depends on the specified installation location but typically |
| | contains the path “...♯SequoiaMG♯SMGServerMedia”. |
| %SMGPackages% | Resolves to the SequoiaMG packages directory. The actual location |
| | depends on the specified installation location but typically contains |
| | the path “...♯SequoiaMG♯Bin”. |
| %SMGHelp% | Resolves to the SequoiaMG help directory. The actual location |
| | depends on the specified-installation location but typically contains |
| | the path “...♯SequoiaMG♯Help”. |
| %SMGDatabase% | Resolves to the SequoiaMG database directory. The actual location |
| | depends on the specified installation location but typically contains |
| | the path “...♯SequoiaMG♯Database”. |
| %SMGClientDocuments% | Resolves to the active client's documents directory. The actual |
| | location depends on the client login and version of Microsoft |
| | Windows. For example, the login “quest” running on Microsoft |
| | Windows Xp, may resolve to the following: C:♯Documents and |
| | Settings♯gu“%SMGServer%” - Resolves to the SequoiaMG server |
| | directory. The actual location depends on the specified installation |
| | location, by typically contains the path “...♯SequoiaMG♯My |
| | Documents”. |
| %SMGClientMedia% | Resolves to the active client's automatically generated “SMG Client |
| | Media” directory. This directory is created under the client's login, |
| | and typically resides at the same level as the “My Documents” |
| | directory. As with the documents directory, the actual location |
| | depends on the client login and version of Microsoft Windows. For |
| | example, the login “quest” running on Microsoft Windows Xp, may |
| | resolve to “C:♯Documents and Settings♯guest♯SMGClientMedia”. |
| %SMGClient% | Resolves to the active client's home directory. The actual location |
| | depends on the client login and version of Microsoft Windows. For |
| | example, the login “quest” running on Microsoft Windows Xp, may |
| | resolve to the following: “C:♯Documents and Settings♯guest”. |
| %BPServerMedia% | Resolves to the BigPlanet server media directory. The actual |
| | location depends on the specified installation location but typically |
| | contains the path “...♯SequoiaMG♯BPServerMedia”. |

Media Elements

The CElement complex XSD type defines the basic behavior and characteristics of multimedia material, such as audio renderings, images, text, and videos. It is used as the class template for the SMG:Element base XML tag and derived render type tags.

Special Effects

The CEffect complex XSD type provides base *time* information for effect implementations. It is used as the class template for the SMG:Effect base XML tag and derived special effect type tags.

File Data Elements

The CData complex XSD type provides base information for types of file implementations. It is used as the class template for the SMG:Data base XML tag and derived data type tags. In the discussion below, each tag will be described with an attribute table, and example tag and an XML schema in that order.

Primitive Media Elements

Primitive Media Elements inherit the attributes of the base <Element> class, typically contain one <Render> tag, and can contain one, or many, <Effect> tags. Primitive Elements contain the core definition of multimedia items, but do not have any scene time-control (i.e., no child elements). Definitions are provided for the Audio, Image, Text and Video primitive elements.

The <Element> Tag

The following standard attributes apply to derived element tags:

| Attribute | Type | Default | Description |
|---|---|---|---|
| id | xs:string | null | Gives an identification to an element that can be |
| | | | used to reference that element and change an |
| | | | attribute. |
| refId | xs:string | null | Identification of a destination element that will |
| | | | receive a specified attribute change. |
| title | xs:string | null | Give the identification of the multimedia item. |
| | | | This attribute must use valid alphanumeric |
| | | | characters (including the space value). |
| src | amom:anyPath | null | Specifies the location of the multimedia content |
| | | | (file). It must use valid path or URL |
| | | | conventions and may use pre-defined constants. |
| dst | amom:anyPath | null | Specifies the file destination of the multimedia |
| | | | content. It must use valid path or URL |
| | | | conventions and may use pre-defined constants. |
| xlink | amom:anyPath | null | Specifies a path were more content can be |
| | | | found. |
| xpath | amom:anyPath | null | Specifies the path to an element found within a |
| | | | XML Document. |
| thumbnail | amom:imagePath | null | Specifies the file location of a representative |
| | | | thumbnail image. It must use valid path or url |
| | | | conventions and may use pre-defined constants. |
| addSetting | amom:setting | null | read-only prevents the user from modifying the |
| removeSetting | | | item's default media. |
| | | | hidden prevents the multimedia item from |
| | | | showing up in the editor's layout manager. |
| | | | stock-media specifies that the item's contents |
| | | | come from a special stock-media directory |
| | | | (“SMGServerMedia”) and will not be |
| | | | automatically replaced. |
| | | | chapter-mark indicates an edit-time marking on |
| | | | the presentation that delimits this element from |
| | | | others, such as between scene transitions. This |
| | | | setting also causes the DVD to place a chapter |
| | | | mark on the output DVD. |
| | | | time-dynamic allows the controlling scene (or |
| | | | presentation) to automatically adjust it's start |
| | | | and end-time based on the contents of sub- |
| | | | elements. |
| | | | changed is a system-internal setting that allows |
| | | | for dynamic loading, modification, and |
| | | | verification of existing media objects. This |
| | | | setting should not be initiated by the |
| | | | programmer. |

Element tags are not used directly, rather sub-classed XML tags must be used in conjunction with the element attributes. The following shows an exemplary declaration of an Image element:

| | |
|---|---|
| <Image | |
| displayLabel | = “P1 - 4×6 Frame” |
| src | = “%SMGServerMedia%\Samples\Family.jpg” |

| | |
|---|---|
| > | |
| <Render | |
| startTime | = “0.0” |
| centerX | = “65%” |
| width | = “25%” |
| height | = “25%” |
| /> | |
| </Image> | |

XML Schema Definition

<xs:complexType name=“CElement” abstract=“true”>

<xs:attribute name=“id” type=“xs:string” use=“optional”/>
<xs:attribute name=“refId” type=“xs:string” use=“optional”/>
<xs:attribute name=“title” type=“xs:string” use=“optional”/>
<xs:attribute name=“src” type=“anyPath” use=“optional”/>
<xs:attribute name=“dst” type=“anyPath” use=“optional”/>
<xs:attribute name=“thumbnail” type=“imagePath” use=“optional”/>
<xs:attribute name=“xlink” type=“anyPath” use=“optional”/>
<xs:attribute name=“xpath” type=“anyPath” use=“optional”/>
<xs:attribute name=“addSetting” type=“setting” use=“optional”/>
<xs:attribute name=“removeSetting” type=“setting” use=“optional”/>

</xs:complexType>

The <Render> tag

The <Render> tag defines the basic display and rendering behavior of multimedia material. The following standard attributes apply to all render tags.

| Attribute | Type | Default | Description |
|---|---|---|---|
| startTime | amom:timeOffset | 0.0 sec | Represents the first time the multimedia item will be |
| | | | presented on the display. All positive values apply |
| | | | where values left of the decimal point represent |
| | | | second, and values right of the decimal point |
| | | | represents fractions of a second. A negative value |
| | | | represents a starting time based on the duration of the |
| | | | elements scene parent. |
| endTime | amom:timeOffset | −1.0 sec | A value of −1.0 tells the specified multimedia element |
| | | | to obtain an ending time based on the parent |
| | | | multimedia components start- and end-time. |
| duration | amom:timeOffset | 0.0 sec | Represents the presentation duration, in seconds. This |
| | | | attribute is typically used in replacement of the end- |
| | | | time attribute. |
| overlapTime | amom:timeOffset | 0.0 sec | A value of −1.0 indicates the specified element's |
| | | | render time does not affect any other sibling element |
| | | | start- and end-times. |
| centerX | amom:percent | 50% | Represents the horizontal center position of the |
| | | | multimedia item. Positioning on the display's left side |
| | | | is accomplished by specifying a value of 0%. |
| | | | Positioning on the right-side of the display is |
| | | | accomplished by specifying a value of 100%. Greater |
| | | | or lesser values should only be used if the multimedia |
| | | | item will be moved into display area. |
| centerY | amom:percent | 50% | Represents the vertical center position of the |
| | | | multimedia item. Positioning at the top of the display |
| | | | is accomplished by specifying a value of 0%. |
| | | | Positioning on the bottom of the display is |
| | | | accomplished by specifying a value of 100%. Greater |
| | | | or lesser values should only be used if the multimedia |
| | | | item will be moved into display area. |
| centerZ | amom:percent | 90% | Represents the center depth position of the |
| | | | multimedia item. Positioning at the ‘perceived’ front |
| | | | of the display is accomplished by specifying a value |
| | | | of 0%. Positioning on ‘perceived’ back of the display |
| | | | is accomplished by specifying a value of 100%. |
| width | amom:percent | 100% | The lower bound of width is 0%, which represents no |
| | | | rendering. There is no upper bound to the width, |
| | | | except the rendering quality of the multimedia item. |
| height | amom:percent | 100% | The lower bound of height is 0%, which represents no |
| | | | rendering. There is no upper bound to the height, |
| | | | except the rendering quality of the multimedia item. |
| depth | amom:percent | 0% | The lower bound of depth is 0%, which represents a |
| | | | flat rendering. There is no upper bound to the depth, |
| | | | except the rendering quality of the multimedia item. |
| justify | amom:setting | vt-center | vt-full, hz-full, and dt-full force the rendering sub- |
| | | \| hz- | graph to “stretch” the multimedia item to the specified |
| | | center \| | size of the rendering. |
| | | dt-center | vt-natural, hz-natural force the rendering sub-graph to |
| | | | maintain the multimedia item's aspect ration. |
| | | | vt-top, |
| | | | top, |
| | | | vtcenter, |
| | | | vt-bottom, |
| | | | bottom, |
| | | | vt-photo, |
| | | | vt-natural, or |
| | | | vt-full. |
| | | | hz-left, |
| | | | left, |
| | | | hz-center, |
| | | | hz-right, |
| | | | right, |
| | | | hz-photo, |
| | | | hz-natural, or |
| | | | hz-full. |
| | | | dt-front, |
| | | | front, |
| | | | dt-center, |
| | | | dt-back, |
| | | | back, |
| | | | dt-full. |
| addFilter | amom:setting | null | blur provides a single-level blurring (or smoothing) |
| removeFilter | | | algorithm on user photos. This filter implements a 4- |
| | | | pixel blurring algorithm on the photo after the optimal |
| | | | size photo has been created based on the desired |
| | | | output resolution. This filter is best used when over- |
| | | | sized digital photos have been selected for rendering |
| | | | and when the presentation will enlist a number of |
| | | | general motion effects. |
| | | | blur-more provides a two-level blurring (or |
| | | | smoothing) algorithm on use photos. The first-level |
| | | | implements a “squared reduction” of pixels on the |
| | | | photo as the photo is being created for optimized |
| | | | rendering. The second-level implements a 4-pixel |
| | | | blurring algorithm on the photo after the square |
| | | | reduced photo has been created. This filter is best |
| | | | used when high-resolution digital photos have been |
| | | | selected for rendering and when the presentation will |
| | | | incorporate a number of general motion effects. |
| | | | mipmap provides varying degrees of blurring |
| | | | depending on the render size of the photo. This filter |
| | | | is most appropriate when the photo will be zoomed- |
| | | | in, will have a lot of camera movement, or when its |
| | | | appearance will change from either a large-to-small, |
| | | | or small-to-large presentation size. |
| | | | ntsc-safe adjusts color values of the image to a |
| | | | saturation value lower than 240 [out of 255] and higer |
| | | | than 16. |
| | | | color-correct changes the color content of the light to |
| | | | match the color response of the image using an “85 |
| | | | color-correct” algorithm. |
| | | | color-correct-warm applies the same algorithm as |
| | | | used in color-correct, but adds an 81EF algorithm to |
| | | | produce a warm look. |
| | | | red-eye applies an algorithm to remove red-eye |
| | | | portions of an image. |
| | | | grayscale maps color values of the image to a 255 |
| | | | level gray-scale value. |
| | | | double-strike redraws a font character one pixel lower |
| | | | than the original character to smooth the font edges. |
| | | | smooth-edge removes the jagged edges from a rotated |
| | | | element. |
| | | | gradient places a mask, which has transparent areas, |
| | | | over an element. The defined transparent area will |
| | | | allow the element to show through. For example this |
| | | | can be used to create an oval image. |
| addSetting | amom:setting | optimize | render-3d Needed to use camera effect. |
| removeSetting | | | optimize |
| | | | loop causes an element when it reaches its end to |
| | | | restart. For example an Audio element reaches the |
| | | | end it will restart. |
| | | | mute-audio mutes the audio. Can be used to mute the |
| | | | audio in a video. |
| disableEffect | amom:setting | null | |
| enableEffect | | | |

Render tags are not used directly, rather sub-classed XML tags must be used in conjunction with the render attributes. The following shows an example declaration of render attributes in use with an Image element:

| | |
|---|---|
| <Image | |
| displayLabel | = “P1 - 4×6 Frame” |
| src | = “%SMGServerMedia%\Samples\Family.jpg” |
| > | |
| <Render | |
| startTime | = “0.0” |
| duration | = “10.5” |
| centerX | = “65%” |
| width | = “25%” |
| height | = “25%” |
| addFilter | = “blur” |
| /> | |
| </Image> | |

XML Schema Definition

```
<xs:complexType name=“CRender”>
  <xs:attribute name=“startTime” type=“timeOffset” use=“optional”/>
  <xs:attribute name=“endTime” type=“timeOffset” use=“optional”/>
  <xs:attribute name=“duration” type=“timeOffset” use=“optional”/>
  <xs:attribute name=“overlapTime” type=“timeOffset” use=“optional”/>
  <xs:attribute name=“centerX” type=“percent” use=“optional”/>
  <xs:attribute name=“centerY” type=“percent” use=“optional”/>
  <xs:attribute name=“centerZ” type=“percent” use=“optional”/>
  <xs:attribute name=“width” type=“percent” use=“optional”/>
  <xs:attribute name=“height” type=“percent” use=“optional”/>
  <xs:attribute name=“depth” type=“pixel” use=“optional”/>
  <xs:attribute name=“justify” type=“setting” use=“optional”/>
  <xs:attribute name=“addFilter” type=“setting” use=“optional”/>
  <xs:attribute name=“removeFilter” type=“setting” use=“optional”/>
  <xs:attribute name=“addSetting” type=“setting” use=“optional”/>
  <xs:attribute name=“removeSetting” type=“setting” use=“optional”/>
  <xs:attribute name=“disableEffect” type=“setting” use=“optional”/>
  <xs:attribute name=“enableEffect” type=“setting” use=“optional”/>
</xs:complexType>
<xs:element name=“Render” type=“CRender”/>
```

The <Audio> tag

<Audio> is used to specify the attributes and behavior of an audio display element. An exemplary set of recognized audio types includes wav, mpa, mp2, mp3, au, aif, aiff, snd, mid, midi, rmi and m3u formats. Audio elements have no visible representation, rather, they cause audio files to be played during the presentation of a presentation.

The <Audio> tag inherits the attributes of the base <Element> tag and no additional attributes. The <Audio> tag also inherits the attributes of the base <Render> tag as well as the following additional attributes:

| Attribute | Type | Default | Description |
|---|---|---|---|
| inTime | amom:timeOffset | 0.0 sec | Specifies the time, within the audio or video |
| | | | element, when the rendering should begin. Setting |
| | | | this time causes the underlying render engine to |
| | | | ‘seek’ within the specified media file, but does not |
| | | | affect the element's start-time or duration. |
| outTime | amom:timeOffset | * | Default outTime is obtained from the time |
| | | | specification in the parent <Render> tag. If outTime |
| | | | is less than the default it is used as a stopping or |
| | | | looping point. |
| playRate | amom:playRate | play | play, normal, pause Plays or pauses the audio. |

<Audio> tags are used to control the rendering of an Audio element.

| | |
|---|---|
| <Audio | |
| displayLabel | = “Audio” |
| src | = “%SMGServerMedia%\Audio\default.mp3” |
| addSetting | = “stock-media” |

| | |
|---|---|
| > | |
| <Render | |
| removeSetting | = “loop” |
| startTime | = “0.0” |
| endTime | = “0.0” |

| | |
|---|---|
| inTime | = “3.0” |

| | |
|---|---|
| overlapTime | = “−1” |
| /> | |
| <FadeEffect | |
| startTime | = “−2.0” |
| endTime | = “0.0” |
| startAlpha | = “100%” |
| endAlpha | = “0%” |
| /> | |
| </Audio> | |

XML Schema Definition

```
<xs:complexType name=“CRenderAudio”>
  <xs:complexContent>
    <xs:extension base=“CRender”>
      <xs:attribute name=“inTime” type=“timeOffset” use=“optional”/>
      <xs:attribute name=“outTime” type=“timeOffset” use=“optional”/>
      <xs:attribute name=“playRate” type=“playRate” use=“optional”/>
    </xs:extension>
  </xs:complexContent>
</xs:complexType>
<xs:complexType name=“CAudio”>
  <xs:complexContent>
    <xs:extension base=“CElement”>
      <xs:sequence minOccurs=“0” maxOccurs=“unbounded”>
        <xs:element name=“Render” type=“CRenderAudio”
minOccurs=“0” maxOccurs=“1”/>
        <xs:element name=“CameraEffect” type=“CCameraEffect”
minOccurs=“0” maxOccurs=“unbounded”/>
        <xs:element name=“FadeEffect” type=“CFadeEffect”
minOccurs=“0” maxOccurs=“unbounded”/>
        <xs:element name=“FilterEffect” type=“CFilterEffect”
minOccurs=“0” maxOccurs=“unbounded”/>
        <xs:element name=“FrameEffect” type=“CFrameEffect”
minOccurs=“0” maxOccurs=“unbounded”/>
        <xs:element name=“MotionEffect” type=“CMotionEffect”
minOccurs=“0” maxOccurs=“unbounded”/>
        <xs:element name=“RenderEffect” type=“CRenderEffect”
minOccurs=“0” maxOccurs=“unbounded”/>
        <xs:element name=“RollEffect” type=“CRollEffect”
minOccurs=“0” maxOccurs=“unbounded”/>
        <xs:element name=“RotateEffect” type=“CRotateEffect”
minOccurs=“0” maxOccurs=“unbounded”/>
        <xs:element name=“ShadowEffect” type=“CShadowEffect”
minOccurs=“0” maxOccurs=“unbounded”/>
        <xs:element name=“SizeEffect” type=“CSizeEffect”
minOccurs=“0” maxOccurs=“unbounded”/>
        <xs:element name=“WipeEffect” type=“CWipeEffect”
minOccurs=“0” maxOccurs=“unbounded”/>
        <xs:element name=“ZoomEffect” type=“CZoomEffect”
minOccurs=“0” maxOccurs=“unbounded”/>
        <xs:element ref=“AudioData” minOccurs=“0”
maxOccurs=“unbounded”/>
      </xs:sequence>
    </xs:extension>
  </xs:complexContent>
</xs:complexType>
<xs:element name=“Audio” type=“CAudio”/>
```

The <Image> tag

<Image> is used to specify the attributes and behavior of an image display element. An exemplary set of recognized image types includes bmp, gif, jpg, png and tiff formats. The <Image> tag inherits the attributes of the base <Element> tag and no additional attributes. The <Image> tag inherits the attributes of the base <Render> tag, as well as the following additional attributes:

| Attribute | Type | Default | Description |
|---|---|---|---|
| colorKeyMin | amom:color | 0xffffff | Any pixel that has a color value greater then the |
| | | | color value of colorKeyMin becomes transparent. |
| | | | colorKeyMin and colorKeyMax work in tandem to |
| | | | define a color range that should be transparent. |
| | | | colorKeyMin is specified in hexadecimal format |
| | | | and should appear as 0xrrggbb. Where ‘rr’ |
| | | | represents the red component, ‘gg’ represents the |
| | | | green component, and ‘bb’ represents the blue |
| | | | component. |
| colorKeyMax | amom:color | 0x000000 | Any pixel that has a color value less then the color |
| | | | value of colorKeyMax becomes transparent. |
| | | | colorKeyMax and colorKeyMin work in tandem to |
| | | | define a color range that should be transparent. |
| | | | colorKeyMax is specified in hexadecimal format |
| | | | and should appear as 0xrrggbb. Where ‘rr’ |
| | | | represents the red component, ‘gg’ represents the |
| | | | green component, and ‘bb’ represents the blue |
| | | | component. |

<Image> tags are used to control the rendering of an Image element.

| | |
|---|---|
| <Image | |
| displayLabel | = “P1 - 4×6 Frame” |
| src | = “%SMGServerMedia%\Samples\Family.jpg” |

| | |
|---|---|
| > | |
| <Render | |
| startTime | = “0.0” |
| centerX | = “65%” |
| width | = “25%” |
| height | = “25%” |
| addFilter | = “blur” |
| colorKeyMin | = “0x00000000” |
| colorKeyMax | = “0x00101010” |
| /> | |
| </Image> | |

XML Schema Definition

```
<xs:complexType name=“CRenderImage”>
  <xs:complexContent>
    <xs:extension base=“CRender”>
      <xs:attribute name=“colorKeyMin” type=“color” use=“optional”/>
      <xs:attribute name=“colorKeyMax” type=“color” use=“optional”/>
    </xs:extension>
  </xs:complexContent>
</xs:complexType>
<xs:complexType name=“CImage”>
  <xs:complexContent>
    <xs:extension base=“CElement”>
      <xs:sequence minOccurs=“0” maxOccurs=“unbounded”>
        <xs:element name=“Render” type=“CRenderImage”
minOccurs=“0” maxOccurs=“1”/>
        <xs:element name=“CameraEffect” type=“CCameraEffect”
minOccurs=“0” maxOccurs=“unbounded”/>
        <xs:element name=“FadeEffect” type=“CFadeEffect”
minOccurs=“0” maxOccurs=“unbounded”/>
        <xs:element name=“FilterEffect” type=“CFilterEffect”
minOccurs=“0” maxOccurs=“unbounded”/>
        <xs:element name=“FrameEffect” type=“CFrameEffect”
minOccurs=“0” maxOccurs=“unbounded”/>
        <xs:element name=“MotionEffect” type=“CMotionEffect”
minOccurs=“0” maxOccurs=“unbounded”/>
        <xs:element name=“RenderEffect” type=“CRenderEffect”
minOccurs=“0” maxOccurs=“unbounded”/>
        <xs:element name=“RollEffect” type=“CRollEffect”
minOccurs=“0” maxOccurs=“unbounded”/>
        <xs:element name=“RotateEffect” type=“CRotateEffect”
minOccurs=“0” maxOccurs=“unbounded”/>
        <xs:element name=“ShadowEffect” type=“CShadowEffect”
minOccurs=“0” maxOccurs=“unbounded”/>
        <xs:element name=“SizeEffect” type=“CSizeEffect”
minOccurs=“0” maxOccurs=“unbounded”/>
        <xs:element name=“WipeEffect” type=“CWipeEffect”
minOccurs=“0” maxOccurs=“unbounded”/>
        <xs:element name=“ZoomEffect” type=“CZoomEffect”
minOccurs=“0” maxOccurs=“unbounded”/>
        <xs:element ref=“ImageData” minOccurs=“0”
maxOccurs=“unbounded”/>
      </xs:sequence>
    </xs:extension>
  </xs:complexContent>
</xs:complexType>
<xs:element name=“Image” type=“CImage”/>
```

The <Text> Tag

<Text> is used to specify the attributes and behavior of a text display element. An exemplary set of recognized text types includes txt and xml. The <Text> tag inherits the attributes of the base <Element> tag, as well as the following additional attributes:

| Attribute | Type | Default | Description |
|---|---|---|---|
| caption | xs:string | <null> | Can contain the text that should be |
| | | | displayed. |
| title | xs:string | <null> | Can contain the text that should be |
| | | | displayed. |

The <Text> tag inherits the attributes of the base <Render> tag, as well as the following additional attributes:

| Attribute | Type | Default | Description |
|---|---|---|---|
| fontName | xs:string | Arial | Name of the font to use for |
| | | | the text. If no font name is |
| | | | specified the text will use an |
| | | | Arial font. |
| fontSize | xs:int | 240 | Point size of the font. |
| fontColor | amom:color | 0xffffff | Color the font should appear |
| | | | in. The fontColor is specified |
| | | | in hexadecimal format and |
| | | | should appear as 0xrrggbb. |
| | | | Where ‘rr’ represents the |
| | | | red component, ‘gg’ |
| | | | represents the green |
| | | | component, and ‘bb’ |
| | | | represents the blue |
| | | | component. |
| backgroundColor | amom:color | 0xffffff | The background color the |
| | | | font should appear on. The |
| | | | backgroundColor is specified |
| | | | in hexadecimal format and |
| | | | should appear as 0xrrggbb. |
| | | | Where ‘rr’ represents |
| | | | the red component, ‘gg’ |
| | | | represents the green |
| | | | component, and ‘bb’ |
| | | | represents the blue |
| | | | component. |

The following example shows how <Text> tags may be used to control the rendering of a Text element:

| | |
|---|---|
| <Text | |
| displayLabel | = “Title” |
| src | = “caption” |
| caption | = “School Memories” |
| > | |
| <Render | |
| justify | = “vt-center \| hz-center” |
| fontColor | = “0x0000ff” |
| startTime | = “0.0” |
| endTime | = “100.0” |
| fontName | = “Tahoma Bold” |
| fontSize | = “36.0” |
| centerX | = “30%” |
| centerY | = “35%” |
| centerZ | = “95%” |
| width | = “50%” |
| height | = “15%” |
| /> | |
| </Text> | |

XML Schema Definition

```
<xs:complexType name=“CRenderText”>
    <xs:complexContent>
      <xs:extension base=“CRender”>
        <xs:attribute name=“caption” type=“xs:string” use=“optional”/>
        <xs:attribute name=“title” type=“xs:string”
        use=“optional”/>
        <xs:attribute name=“fontName” type=“xs:string”
        use=“optional”/>
        <xs:attribute name=“fontSize” type=“xs:int” use=“optional”/>
        <xs:attribute name=“fontColor” type=“color” use=“optional”/>
        <xs:attribute name=“backgroundColor” type=“color”
  use=“optional”/>
      </xs:extension>
    </xs:complexContent>
</xs:complexType>
<xs:complexType name=“CText”>
    <xs:complexContent>
      <xs:extension base=“CElement”>
        <xs:sequence minOccurs=“0” maxOccurs=“unbounded”>
          <xs:element name=“Render” type=“CRenderText”
          minOccurs=“0”
maxOccurs=“1”/>
          <xs:element name=“CameraEffect” type=“CCameraEffect”
minOccurs=“0” maxOccurs=“unbounded”/>
          <xs:element name=“FadeEffect” type=“CFadeEffect”
minOccurs=“0” maxOccurs=“unbounded”/>
          <xs:element name=“FilterEffect” type=“CFilterEffect”
minOccurs=“0” maxOccurs=“unbounded”/>
          <xs:element name=“FrameEffect” type=“CFrameEffect”
minOccurs=“0” maxOccurs=“unbounded”/>
          <xs:element name=“MotionEffect” type=“CMotionEffect”
minOccurs=“0” maxOccurs=“unbounded”/>
          <xs:element name=“RenderEffect” type=“CRenderEffect”
minOccurs=“0” maxOccurs=“unbounded”/>
          <xs:element name=“RollEffect” type=“CRollEffect”
minOccurs=“0” maxOccurs=“unbounded”/>
          <xs:element name=“RotateEffect” type=“CRotateEffect”
minOccurs=“0” maxOccurs=“unbounded”/>
          <xs:element name=“ShadowEffect” type=“CShadowEffect”
minOccurs=“0” maxOccurs=“unbounded”/>
          <xs:element name=“SizeEffect” type=“CSizeEffect”
minOccurs=“0” maxOccurs=“unbounded”/>
          <xs:element name=“WipeEffect” type=“CWipeEffect”
minOccurs=“0” maxOccurs=“unbounded”/>
          <xs:element name=“ZoomEffect” type=“CZoomEffect”
minOccurs=“0” maxOccurs=“unbounded”/>
          <xs:element ref=“TextData” minOccurs=“0”
maxOccurs=“unbounded”/>
        </xs:sequence>
        <xs:attribute name=“caption” type=“xs:string” use=“optional”/>
      </xs:extension>
    </xs:complexContent>
</xs:complexType>
<xs:element name=“Text” type=“CText”/>
```

The <Video> Tag

<Video> is used to specify the attributes and behavior of a video display element. An exemplary set of recognized video includes avi, mov, mpg, mpeg, m1v and m2v formats. The <Video> tag inherits the attributes of the base <Element> tag, and no additional attributes. The <Video> tag inherits the attributes of the base <Render> tag, as well as the following additional attributes:

| Attribute | Type | Default | Description |
|---|---|---|---|
| inTime | amom:timeOffset | 0.0 sec | Specifies the time, within the |
| | | | audio or video element, when |
| | | | the rendering should begin. |
| | | | Setting this time causes |
| | | | the underlying render engine |
| | | | to ‘seek’ within the |
| | | | specified media file, but |
| | | | does not affect the element's |
| | | | start-time or duration. |
| outTime | amom:timeOffset | * | Default outTime is obtained |
| | | | from the time specification |
| | | | in the parent <Render> tag. |
| | | | If outTime is less than the |
| | | | default it is used as a |
| | | | stopping or looping point. |
| playRate | amom:playRate | play | play, normal, pause |
| | | | Plays or pauses the video. |

<Video> tags are used to control the rendering of a Video element.

| | |
|---|---|
| <Video | |
| displayLabel | = “Hearth” |
| src | = “%SMGServerMedia%\Video\Cinema2.m2v” |
| addSetting | = “stock-media” |
| > | |
| <Render | |

| | |
|---|---|
| removeSetting | = “loop” |
| addSetting | = “mute-audio” |
| startTime | = “0.0” |
| duration | = “0.0” |
| centerZ | = “99%” |
| width | = “100%” |
| height | = “100%” |
| /> | |
| <RenderEffect | |
| startTime | = “7.0” |
| playRate | = “normal” |
| /> | |
| <RenderEffect | |
| startTime | = “21.0” |

| | |
|---|---|
| endTime | = “0.0” |

| | |
|---|---|
| playRate | = “pause” |
| /> | |
| </Video> | |

XML Schema Definition

```
<xs:complexType name=“CRenderVideo”>
  <xs:complexContent>
    <xs:extension base=“CRender”>
      <!-- audio/video -->
      <xs:attribute name=“inTime” type=“timeOffset” use=“optional”/>
      <xs:attribute name=“outTime” type=“timeOffset” use=“optional”/>
      <xs:attribute name=“playRate” type=“playRate” use=“optional”/>
    </xs:extension>
  </xs:complexContent>
</xs:complexType>
<xs:complexType name=“CVideo”>
  <xs:complexContent>
    <xs:extension base=“CElement”>
      <xs:sequence minOccurs=“0” maxOccurs=“unbounded”>
        <xs:element name=“Render” type=“CRenderVideo”
        minOccurs=“0”
maxOccurs=“1”/>
        <xs:element name=“CameraEffect” type=“CCameraEffect”
minOccurs=“0” maxOccurs=“unbounded”/>
        <xs:element name=“FadeEffect” type=“CFadeEffect”
minOccurs=“0” maxOccurs=“unbounded”/>
        <xs:element name=“FilterEffect” type=“CFilterEffect”
minOccurs=“0” maxOccurs=“unbounded”/>
        <xs:element name=“FrameEffect” type=“CFrameEffect”
minOccurs=“0” maxOccurs=“unbounded”/>
        <xs:element name=“MotionEffect” type=“CMotionEffect”
minOccurs=“0” maxOccurs=“unbounded”/>
        <xs:element name=“RenderEffect” type=“CRenderEffect”
minOccurs=“0” maxOccurs=“unbounded”/>
        <xs:element name=“RollEffect” type=“CRollEffect”
minOccurs=“0” maxOccurs=“unbounded”/>
        <xs:element name=“RotateEffect” type=“CRotateEffect”
minOccurs=“0” maxOccurs=“unbounded”/>
        <xs:element name=“ShadowEffect” type=“CShadowEffect”
minOccurs=“0” maxOccurs=“unbounded”/>
        <xs:element name=“SizeEffect” type=“CSizeEffect”
minOccurs=“0” maxOccurs=“unbounded”/>
        <xs:element name=“WipeEffect” type=“CWipeEffect”
minOccurs=“0” maxOccurs=“unbounded”/>
        <xs:element name=“ZoomEffect” type=“CZoomEffect”
minOccurs=“0” maxOccurs=“unbounded”/>
        <xs:element ref=“VideoData” minOccurs=“0”
maxOccurs=“unbounded”/>
      </xs:sequence>
    </xs:extension>
  </xs:complexContent>
</xs:complexType>
<xs:element name=“Video” type=“CVideo”/>
```

Scene Elements

Advanced Media Elements inherit the attributes of the base <Element> class, typically contain one <Render> tag, and can contain one or many <Effect> tags. Advanced Media Elements also contain primitive child elements, and may contain advanced child elements, when specified in the definition. Advanced Media Elements encapsulate the primitive child elements and have timing, rendering, and effect controls that are applied to all children. The following advanced elements are defined: <Scene>, <Layout>, <Menu>, <Navigator>, <Presentation>, <Presentation> and <Production>.

The <Scene> Tag

<Scene> is used to encapsulate child elements within a specified time-frame. The <Scene> tag inherits the attributes of the base <Element> tag and no additional attributes. The <Scene> tag inherits the attributes of the base <Render> tag and these additional attributes:

| Attribute | Type | Default | Description |
|---|---|---|---|
| inTime | amom:timeOffset | 0 | Specifies a time to |
| | | | advance to within the scene |
| | | | before starting. (normally |
| | | | used when making a sample |
| | | | of a presentation) |
| outTime | amom:timeOffset | 0 | Specifies a time at which the |
| | | | scene should exit. (normally |
| | | | used when making a sample of a |
| | | | presentation) |

The <Scene> tag contains the following child elements: Audio, Image, Text, Video and Scene.

<Scene> tags are used to create scenes with in a presentation.

| | |
|---|---|
| <Scene | |
| src | = “%SMGServerMedia%\Scenes\Scene-Flag.xml” |

| | |
|---|---|
| addSetting | = “chapter-mark” |
| > | |
| <Render | |
| overlapTime | = “1” |
| /> | |
| </Scene> | |

XML Schema Definition

```
<xs:complexType name=“CScene”>
  <xs:complexContent>
    <xs:extension base=“CElement”>
      <xs:sequence minOccurs=“0” maxOccurs=“unbounded”>
        <xs:element name=“Render” type=“CRender” minOccurs=“0”
maxOccurs=“1”/>
        <xs:element ref=“Audio” minOccurs=“0”
        maxOccurs=“unbounded”/>
        <xs:element ref=“Image” minOccurs=“0”
        maxOccurs=“unbounded”/>
        <xs:element ref=“Text” minOccurs=“0”
        maxOccurs=“unbounded”/>
        <xs:element ref=“Video” minOccurs=“0”
        maxOccurs=“unbounded”/>
        <xs:element ref=“Scene” minOccurs=“0”
        maxOccurs=“unbounded”/>
      </xs:sequence>
      <xs:attribute name=“inTime” type=“timeOffset” use=“optional”/>
      <xs:attribute name=“outTime” type=“timeOffset” use=“optional”/>
    </xs:extension>
  </xs:complexContent>
</xs:complexType>
<!-- Scene -->
<xs:element name=“Scene”>
  <xs:complexType>
    <xs:complexContent>
      <xs:extension base=“CScene”>
        <xs:sequence minOccurs=“0” maxOccurs=“unbounded”>
          <xs:element ref=“AudioData” minOccurs=“0”
maxOccurs=“unbounded”/>
          <xs:element ref=“ImageData” minOccurs=“0”
maxOccurs=“unbounded”/>
          <xs:element ref=“TextData” minOccurs=“0”
maxOccurs=“unbounded”/>
          <xs:element ref=“VideoData” minOccurs=“0”
maxOccurs=“unbounded”/>
        </xs:sequence>
      </xs:extension>
    </xs:complexContent>
  </xs:complexType>
</xs:element>
```

The <Presentation> Tag

The <Presentation> Tag

The <Presentation> tag inherits the attributes of the base <Scene> tag and has no additional attributes. Refer to the <Scene> tag for the list of attributes. The <Presentation> tag contains the following child elements: AudioData, ImageData, TextData, VideoData and SceneData. <Presentation> tags are used to define the beginning and ending:

| | |
|---|---|
| <Presentation | |
| displayLabel | = “WebSample - American Tribute” |
| src | = “%SMGServerMedia%\American Tribute.xml” |
| removeSetting | = “time-dynamic” |
| > | |
| <Render | |
| startTime | = “0.0” |
| endTime | = “60.0” |
| inTime | = “15.0” |
| /> | |
| <FadeEffect | |
| startTime | = “56.0” |
| endTime | = “60.0” |
| startAlpha | = “100%” |
| endAlpha | = “0%” |
| /> | |
| </Presentation> | |

XML Schema Definition

```
<xs:complexType name=“CPresentation”>
  <xs:complexContent>
    <xs:extension base=“CScene”>
      <xs:sequence minOccurs=“0” maxOccurs=“unbounded”>
        <xs:element ref=“AudioData” minOccurs=“0”
maxOccurs=“unbounded”/>
        <xs:element ref=“ImageData” minOccurs=“0”
maxOccurs=“unbounded”/>
        <xs:element ref=“TextData” minOccurs=“0”
maxOccurs=“unbounded”/>
        <xs:element ref=“VideoData” minOccurs=“0”
maxOccurs=“unbounded”/>
      </xs:sequence>
    </xs:extension>
  </xs:complexContent>
</xs:complexType>
<xs:element name=“Presentation” type=“CPresentation”/>
```

The <Presentation> Tag

<Presentation> is used to encapsulate child elements and scenes within a specified time-frame. The <Presentation> tag inherits the attributes of the base <Presentation> tag and defines the following additional attributes.

| Attribute | Type | Default | Description |
|---|---|---|---|
| aspectRatio | amom:aspectRatio | 4:3 | Defines the presentation or |
| | | | render screen aspect. |
| | | | Allowed values are either |
| | | | 4:3, 3:2, or 16:9. |

The <Presentation> tag contains the DropData child element.

<Presentation
src = “%SMGServerMedia%\Scenes\Spinup.xml”
/>

XML Schema Definition

```
<xs:complexType name=“CPresentation”>
  <xs:complexContent>
    <xs:extension base=“CPresentation”>
      <xs:sequence minOccurs=“0” maxOccurs=“unbounded”>
        <xs:element ref=“DropData” minOccurs=“0”
        maxOccurs=“unbounded”/>
      </xs:sequence>
      <xs:attribute name=“aspectRatio” type=“aspectRatio”
      use=“optional”/>
    </xs:extension>
  </xs:complexContent>
</xs:complexType>
</xs:element name=“Presentation” type=“CPresentation”/>
```

The <Navigator> Tag

<Navigator> is used to encapsulate child elements within a specified time-frame and with interactive components, such as selection. The <Navigator> tag inherits the attributes of the base <Scene> tag and defines the following additional attributes.

| Attribute | Type | Default | Description |
|---|---|---|---|
| navigateLeft | xs:string | null | String value matches id of |
| | | | another navigator element. |
| navigateRight | xs:string | null | |
| navigatorUp | xs:string | null | |
| navigateDown | xs:string | null | |
| endAction | xs:string | null | menu returns to root dvd menu |
| | | | when presentation completes |
| | | | continue show next presentation |
| | | | loop repeat current presentation |

The <Navigator> tag contains the Presentation child element.

| | |
|---|---|
| <Navigator | |
| displayLabel | = “Presentation 1” |
| id | = “PRESENTATION1” |
| navigateUp | = “PRESENTATION2” |
| navigateDown | = “PRESENTATION2” |
| navigateLeft | = “PRESENTATION1” |
| navigateRight | = “PRESENTATION1” |
| endAction | = “menu” |
| > | |
| <Render | |
| startTime | = “0.0” |
| endTime | = “0.0” |
| centerX | = “46%” |
| centerY | = “70%” |
| centerZ | = “90%” |
| width | = “14%” |
| height | = “6%” |
| /> | |
| </Navigator> | |

XML Schema Definition

```
<xs:complexType name=“CNavigator”>
  <xs:complexContent>
    <xs:extension base=“CScene”>
      <xs:sequence minOccurs=“0” maxOccurs=“unbounded”>
        <xs:element ref=“Presentation” minOccurs=“0”
        maxOccurs=“unbounded”/>
      </xs:sequence>
      <xs:attribute name=“navigateLeft” type=“xs:string”
      use=“optional”/>
      <xs:attribute name=“navigateRight” type=“xs:string”
      use=“optional”/>
      <xs:attribute name=“navigateUp” type=“xs:string”
      use=“optional”/>
      <xs:attribute name=“navigateDown” type=“xs:string”
      use=“optional”/>
      <xs:attribute name=“endAction” type=“navigate” use=“optional”/>
    </xs:extension>
  </xs:complexContent>
</xs:complexType>
<xs:element name=“Navigator” type=“CNavigator”/>
```

The <Layout> Tag

The <Layout> tag inherits the attributes of the base <Scene> tag and defines the following additional attribute:

| Attribute | Type | Default | Description |
|---|---|---|---|
| burnFormat | amom:burnFormat | null | DVD-NTSC, DVD-PAL, |
| | | | creates a DVD in an |
| | | | NTSC or a PAL format. |
| | | | VIDEOTS-NTSC, |
| | | | VIDEOTS-PAL, creates |
| | | | VIDEOTS files in an |
| | | | NTSC or a PAL format. |
| | | | ISO-NTSC, ISO-PAL, |
| | | | creates an ISO image in |
| | | | an NTSC or a PAL format. |
| | | | WEB creates an MPEG1 |
| | | | rendering. CD, PC create |
| | | | an MPEG2 rendering. |

The <Layout> tag contains the following child elements: Menu, Menu, Presentation, AudioData, ImageData, TextData, VideoData and PresentationData.

```
<Layout
    xmlns:xsi = “http://www.w3.org/2001/XMLSchema-instance”
    xsi:noNamespaceSchemaLocation = “D:\SequoiaMG\amom.xsd”
    >
    <Presentation
```

| | |
|---|---|
| src | = “%SMGServerMedia%\Scenes\Spinup.xml” |
| /> | |
| <Menu | |
| displayLabel | = “DVD Menu” |
| addSetting | = “read-only” |
| > | |
| <Render | |
| duration | = “60.0” |
| addSetting | = “loop” |
| /> | |

| | |
|---|---|
| <Navigator | |
| displayLabel | = “Presentation 1” |
| id | = “PRESENTATION1” |
| navigateUp | = “PRESENTATION2” |
| navigateDown | = “PRESENTATION2” |
| navigateLeft | = “PRESENTATION1” |
| navigateRight | = “PRESENTATION1” |
| endAction | = “menu” |
| > | |
| <Render | |
| startTime | = “0.0” |
| endTime | = “0.0” |
| centerX | = “46%” |
| centerY | = “70%” |
| centerZ | = “90%” |
| width | = “14%” |
| height | = “6%” |
| /> | |
| </Navigator> | |
| <Navigator | |
| displayLabel | = “Presentation 2” |
| id | = “PRESENTATION2” |
| navigateUp | = “PRESENTATION1” |
| navigateDown | = “PRESENTATION1” |
| navigateLeft | = “PRESENTATION2” |
| navigateRight | = “PRESENTATION2” |
| endAction | = “menu” |
| > | |
| <Render | |
| startTime | = “0.0” |
| endTime | = “0.0” |
| centerX | = “46%” |
| centerY | = “77%” |
| centerZ | = “90%” |
| width | = “14%” |
| height | = “6%” |
| /> | |
| </Navigator> | |
| </Menu> | |
| </Layout> | |

XML Schema Definition

```
<xs:complexType name=“CLayout”>
    <xs:complexContent>
        <xs:extension base=“CScene”>
            <xs:sequence minOccurs=“0” maxOccurs=“unbounded”>
                <xs:element ref=“Menu” minOccurs=“0” maxOccurs=“unbounded”/>
                <xs:element ref=“Presentation” minOccurs=“0”
maxOccurs=“unbounded”/>
                <xs:element ref=“AudioData” minOccurs=“0”
maxOccurs=“unbounded”/>
                <xs:element ref=“ImageData” minOccurs=“0”
maxOccurs=“unbounded”/>
                <xs:element ref=“TextData” minOccurs=“0”
maxOccurs=“unbounded”/>
                <xs:element ref=“VideoData” minOccurs=“0”
maxOccurs=“unbounded”/>
                <xs:element ref=“PresentationData” minOccurs=“0”
maxOccurs=“unbounded”/>
            </xs:sequence>
            <xs:attribute name=“burnFormat” type=“burnFormat”
  use=“optional”/>
        </xs:extension>
    </xs:complexContent>
</xs:complexType>
<xs:element name=“Layout” type=“CLayout”/>
```

The <Production> Tag

The <Production> tag is used to encapsulate a set of presentations and navigator elements. Primitive elements may also be used to show various media components. The <Production> tag inherits the attributes of the base <Layout> tag and no additional attributes. The <Production> tag contains the DropData child element.

| | |
|---|---|
| <Production | |
| name | = “My Family Pictures” |
| src | = “%SMGServerMedia%\Scenes\Vacation.xml” |
| /> | |

XML Schema Definition

```
<xs:complexType name=“CProduction”>
    <xs:complexContent>
        <xs:extension base=“CLayout”>
            <xs:sequence minOccurs=“0” maxOccurs=“unbounded”>
                <xs:element ref=“DropData” minOccurs=“0”
maxOccurs=“unbounded”/>
            </xs:sequence>
        </xs:extension>
    </xs:complexContent>
</xs:complexType>
<xs:element name=“Production” type=“CProduction”/>
```

The <Menu> Tag

The <Menu> tag is used to encapsulate <Navigator> tags. The <Menu> tag inherits the attributes of the base <Presentation> tag and no additional attributes. The <Menu> tag contains the Navigator child element.

| | |
|---|---|
| <Menu | |
| displayLabel | = “DVD Menu” |
| addSetting | = “read-only” |
| > | |
| <Render | |
| duration | = “60.0” |
| addSetting | = “loop” |
| /> | |
| <Navigator | |
| displayLabel | = “Presentation 1” |
| id | = “PRESENTATION1” |
| navigateUp | = “PRESENTATION2” |
| navigateDown | = “PRESENTATION2” |
| navigateLeft | = “PRESENTATION1” |
| navigateRight | = “PRESENTATION1” |
| endAction | = “menu” |
| > | |
| <Render | |
| startTime | = “0.0” |
| endTime | = “0.0” |
| centerX | = “46%” |
| centerY | = “70%” |
| centerZ | = “90%” |
| width | = “14%” |
| height | = “6%” |
| /> | |
| </Navigator> | |
| <Navigator | |
| displayLabel | = “Presentation 2” |
| id | = “PRESENTATION2” |
| navigateUp | = “PRESENTATION1” |
| navigateDown | = “PRESENTATION1” |
| navigateLeft | = “PRESENTATTON2” |
| navigateRight | =“PRESENTATTON2” |
| endAction | = “menu” |
| > | |
| <Render | |
| startTime | = “0.0” |
| endTime | = “0.0” |
| centerX | = “46%” |
| centerY | = “77%” |
| centerZ | = “90%” |
| width | = “14%” |
| height | = “6%” |
| /> | |
| </Navigator> | |
| </Menu> | |

XML Schema Definition

```
<xs:complexType name=“CMenu”>
    <xs:complexContent>
        <xs:extension base=“CPresentation”>
            <xs:sequence minOccurs=“0” maxOccurs=“unbounded”>
                <xs:element ref=“Navigator” minOccurs=“0”
maxOccurs=“unbounded”/>
            </xs:sequence>
        </xs:extension>
    </xs:complexContent>
</xs:complexType>
<xs:element name=“Menu” type=“CMenu”/>
```

Composite Elements

The advanced elements add encapsulation information to primitive elements. The following composite elements are defined: <Directory>, <Component>, <Theme>, <Package> and <Copy Template>.

The <Directory> Tag

The <Directory> tag is used to represent an operating system dependent structure. The <Directory> tag is a base tag and has no attributes.

XML Schema Definition

<xs:complexType name=“CDirectory”>
</xs:complexType>
<xs:element name=“Directory” type=“CDirectory”/>

The <Theme> Tag

The <Theme> tag is used to encapsulate a set of Layouts and Presentations according to a name/concept classification. The <Theme> tag inherits the attributes of the base <Directory> tag, and defines the following additional attribute:

| | | | |
|---|---|---|---|
| Attribute | Type | Default | Description |

| | | |
|---|---|---|
| title | xs: string | null |
| src | amom: anyPath | null |
| thumbnail | amom: imagePath | null |

The <Theme> tag contains the following child elements: Presentation and Layout.

| | |
|---|---|
| <Theme | |
| xmlns | = “http://www.sequoiamg.com” |
| xmlns:xsi | = “http://www.w3.org/2001/XMLSchema-instance” |
| xsi:schemaLocation | = “http://www.sequoiamg.com ../../amom.xsd” |
| title | = “American Tribute” |
| src | = “%BPServerMedia%\AmericanTribute” |
| thumbnail | = “%BPServerMedia%\AmericanTribute\ |
| AmericanTribute.jpg” | |

| | |
|---|---|
| > | |
| <Layout | |
| title | = “American Tribute” |
| src | = “DVD-AmericanTribute.xml” |
| /> | |
| <Presentation | |
| title | = “Presentation” |
| src | = “AmericanTribute.xml” |
| /> | |
| <Presentation | |
| title | = “Credits” |
| src | = “Credits-AmericanTribute.xml” |
| /> | |
| <Presentation | |
| title | = “Sample” |
| src | = “Sample-AmericanTribute.xml” |
| /> | |
| </Theme> | |

XML Schema Definition

```
<xs:complexType name=“CTheme”>
    <xs:complexContent>
        <xs:extension base=“CDirectory”>
            <xs:sequence minOccurs=“0” maxOccurs=“unbounded”>
                <xs:element ref=“Presentation” minOccurs=“0”
maxOccurs=“unbounded”/>
                <xs:element ref=“Layout” minOccurs=“0”
maxOccurs=“unbounded”/>
            </xs:sequence>
            <xs:attribute name=“title” type=“xs:string”
            use=“optional”/>
            <xs:attribute name=“src” type=“anyPath” use=“optional”/>
            <xs:attribute name=“thumbnail” type=“imagePath”
            use=“optional”/>
        </xs:extension>
    </xs:complexContent>
</xs:complexType>
<xs:element name=“Theme” type=“CTheme”/>
```

The <CopyTemplate> Tag

The <CopyTemplate> tag is used to encapsulate child elements that may need to be copied within a presentation. The <CopyTemplate> tag inherits the attributes of the base <Directory> tag and the following additional attributes:

| Attribute | Type | Default | Description |
|---|---|---|---|
| seriesType | amom:series | | sequential repeats scenes |
| | | | in the series in the order |
| | | | they are entered. random |
| | | | repeats scenes randomly. |
| maxCopies | xs:nonNegativeInteger | | |
| minCopies | xs:nonNegativeInteger | | |
| itemDuration | amom:timeOffset | | |
| itemOverlap | amom:timeOffset | | |

The <CopyTemplate> tag contains the following child elements: Audio, Image, Text, Video and Scene.

| <CopyTemplate> | |
|---|---|
| <Image | |
| title | = “Wipe R to L” |
| src | = “%SMGServerMedia%\Frame\White.jpg” |
| > | |

| <Render | |
|---|---|
| justify | = “vt-natural \| hz-natural” |
| duration | = “8.0” |
| overlapTime | = “2.0” |
| centerX | = “50%” |
| centerY | = “50%” |
| width | = “100%” |
| height | = “100%” |
| /> | |
| <WipeEffect | |
| startTime | = “0.0” |
| endTime | = “2.0” |
| startX | = “100%” |
| endX | = “50%” |
| startWidth | = “0%” |
| endWidth | = “100%” |
| /> | |
| <WipeEffect | |
| startTime | = “6.0” |
| endTime | = “8.0” |
| startY | = “50%” |
| endY | = “0%” |
| startHeight | = “100%” |
| endHeight | = “0%” |
| /> | |
| </Image> | |
| <Image | |

| | |
|---|---|
| title | = “Wipe B to T” |
| src | = “%SMGServerMedia%\Frame\White.jpg” |
| > | |

| <Render | |
|---|---|
| justify | = “vt-natural \| hz-natural” |
| duration | = “8.0” |
| overlapTime | = “2.0” |
| centerX | = “50%” |
| centerY | = “50%” |
| width | = “100%” |
| height | = “100%” |
| /> | |
| <WipeEffect | |
| startTime | = “0.0” |
| endTime | = “2.0” |
| startY | = “100%” |
| endY | = “50%” |
| startHeight | = “0%” |
| endHeight | = “100%” |
| /> | |
| <WipeEffect | |
| startTime | = “6.0” |
| endTime | = “8.0” |
| startX | = “50%” |
| endX | = “100%” |
| startWidth | = “100%” |
| endWidth | = “0%” |
| /> | |
| </Image> | |
| </CopyTemplate> | |

XML Schema Definition

```
<xs:complexType name=“CCopyTemplate”>
  <xs:complexContent>
    <xs:extension base=“CDirectory”>
      <xs:sequence minOccurs=“0” maxOccurs=“unbounded”>
        <xs:element ref=“Audio” minOccurs=“0”
        maxOccurs=“unbounded”/>
        <xs:element ref=“Image” minOccurs=“0”
        maxOccurs=“unbounded”/>
        <xs:element ref=“Text” minOccurs=“0”
        maxOccurs=“unbounded”/>
        <xs:element ref=“Video” minOccurs=“0”
        maxOccurs=“unbounded”/>
        <xs:element ref=“Scene” minOccurs=“0”
        maxOccurs=“unbounded”/>
      </xs:sequence>
      <xs:attribute name=“seriesType” type=“series” use=“optional”/>
      <xs:attribute name=“maxCopies” type=“xs:nonNegativeInteger”
  use=“optional”/>
      <xs:attribute name=“maxCopies” type=“xs:nonNegativeInteger”
  use=“optional”/>
      <xs:attribute name=“itemDuration” type=“timeOffset”
      use=“optional”/>
      <xs:attribute name=“itemOverlap” type=“timeOffset”
      use=“optional”/>
    </xs:extension>
  </xs:complexContent>
</xs:complexType>
<xs:element name=“CopyTemplate” type=“CCopyTemplate”/>
```

The <Component> Tag

The <Component> tag is used to encapsulate a set of themes, multimedia templates, directories, and files. The <Component> tag inherits the attributes of the base <Directory> tag and the following additional attributes:

| Attribute | Type | Default | Description |
|---|---|---|---|
| id | xs:string | null | |
| title | xs:string | null | |
| src | amom:anyPath | null | |
| thumbnail | amom:imagePath | null | |

The <Component> tag contains the following child elements: File, Directory, Theme and Layout.

| | |
|---|---|
| <Component | |
| id | = “SMGThemeTree” |
| title | = “Game Face” |
| src | = “%SMGServerMedia%\GameFace\Component- |
| | GameFace.xml” |
| > | |
| </Component> | |

XML Schema Definition

```
<xs:complexType name=“CComponent”>
  <xs:complexContent>
    <xs:extension base=“CDirectory”>
      <xs:sequence minOccurs=“0” maxOccurs=“unbounded”>
        <xs:element ref=“File” minOccurs=“0”
        maxOccurs=“unbounded”/>
        <xs:element ref=“Directory” minOccurs=“0”
maxOccurs=“unbounded”/>
        <xs:element ref=“Theme” minOccurs=“0”
        maxOccurs=“unbounded”/>
        <xs:element ref=“Layout” minOccurs=“0”
maxOccurs=“unbounded”/>
      </xs:sequence>
      <xs:attribute name=“id” type=“xs:string” use=“optional”/>
      <xs:attribute name=“title” type=“xs:string” use=“optional”/>
      <xs:attribute name=“src” type=“anyPath” use=“optional”/>
      <xs:attribute name=“thumbnail” type=“imagePath”
      use=“optional”/>
    </xs:extension>
  </xs:complexContent>
</xs:complexType>
<xs:element name=“Component” type=“CComponent”/>
```

The <Package> Tag

The <Package> tag is used to encapsulate components, themes, and productions. The <Package> tag inherits the attributes of the base <Directory> tag, as well as the following additional attributes:

| Attribute | Type | Default | Description |
|---|---|---|---|
| title | xs:string | null | |
| src | amom:anyPath | null | |
| thumbnail | amom:imagePath | null | |

The <Package> tag contains the following child elements: Component, Production and Theme.

| <Package> | |
|---|---|
| <!-- Specify the production --> | |
| <Production | |
| src | = “%BPServerMedia%\Legacy\DVD - Legacy.xml” |
| > | |
| <!-- Specify the client media --> | |
| <DropData | |
| type | = “Directory” |
| src | = “D:\Jobs\621009\JPEG” |

```
    />
  </Production>
</Package>
```

XML Schema Definition

```
<xs:complexType name=“CPackage”>
  <xs:complexContent>
    <xs:extension base=“CDirectory”>
      <xs:sequence minOccurs=“0” maxOccurs=“unbounded”>
        <xs:element ref=“Component” minOccurs=“0”
maxOccurs=“unbounded”/>
        <xs:element ref=“Production” minOccurs=“0”
maxOccurs=“unbounded”/>
        <xs:element ref=“Theme” minOccurs=“0”
        maxOccurs=“unbounded”/>
      </xs:sequence>
      <xs:attribute name=“title” type=“xs:string” use=“optional”/>
      <xs:attribute name=“src” type=“anyPath” use=“optional”/>
      <xs:attribute name=“thumbnail” type=“imagePath”
      use=“optional”/>
    </xs:extension>
  </xs:complexContent>
</xs:complexType>
<xs:element name=“Package” type=“CPackage”/>
```

The following special effects are defined: FadeEffect, FilterEffect, FrameEffect, MotionEffect, RollEffect, RotateEffect, ShadowEffect, SizeEffect, WipeEffect and ZoomEffect. In addition, the following advanced special effects are defined: CameraEffect and RenderEffect.

The <Effect> Tag

The following standard attributes apply to derived effect tags.

| Attribute | Type | Default | Description |
|---|---|---|---|
| startTime | amom:timeOffset | 0.0 | Represents the first time the effect will be presented |
| | | | on the display. All positive values apply where |
| | | | values left of the decimal point represent seconds, |
| | | | and values right of the decimal point represents |
| | | | fractions of a second. If no startTime is specified, |
| | | | the default value will be applied to the effect. |
| | | | Negative values represent the time the effect will be |
| | | | presented relative to the endTime of the parent |
| | | | element. |
| endTime | amom:timeOffest | 0.0 | The endTime value must be greater than, or equal to |
| | | | the startTime. The rendering takes effect at the |
| | | | startTime, and ends at the endTime (i.e., |
| | | | startTime <= rendering < endTime). If no endTime |
| | | | is specified, the default value will be applied to the |
| | | | effect. The default of 0.0 causes the rendering of |
| | | | the effect to end at the same time as the endTime of |
| | | | the parent element. Negative values represent the |
| | | | time the effect will end relative to the endTime of |
| | | | the parent element. |
| duration | amom:timeOffset | 0.0 | Setting this attribute causes the endTime of the |
| | | | multimedia rendering to offset relative to the |
| | | | startTime. |

The following sample shows the implementation of two Motion effects, where specific <Effect> times are specified.

| | |
|---|---|
| <Image | |
| name | = “P1 - 4×6 Frame” |
| src | = “%SMGServer%\Samples\Family.jpg” |
| > | |
| <Render | |
| startTime | = “0.0” |
| centerX | = “65%” |
| width | = “25%” |
| height | = “25%” |
| /> | |
| <MotionEffect | |
| startTime | = “0.0” |
| endTime | = “10.0” |
| startX | = “0%” |
| startY | = “0%” |
| endX | = “20%” |
| endY | = “20%” |
| /> | |
| <MotionEffect | |
| startTime | = “10.0” |
| endTime | = “20.0” |
| startX | = “20%” |
| startY | = “20%” |
| endX | = “0%” |
| endY | = “0%” |
| /> | |
| </Image> | |

Special effects use the start and end-times to indicate when a special effect should be applied. The startTime indicates exactly when the special effect should be applied. The endTime, however, indicates when the special effect should stop. Thus, the endTime is *not* inclusive when applied to an effect: startTime <=apply-effect <endTime.

The purpose of this definition is to allow programmers to apply a sequence of effects with the guarantee that like effects will not be applied at the same time (causing a double-effect). For example, the code sequence above shows how a motion-effect could be applied in two stages over a 20 second period. The first application moves the parent image 20% to the right and bottom. The second application moves the parent image back to it's original position.

XML Schema Definition

```
<xs:complexType name=“CEffect” abstract=“true”>
  <xs:attribute name=“startTime” type=“timeOffset” use=“optional”/>
  <xs:attribute name=“endTime” type=“timeOffset” use=“optional”/>
  <xs:attribute name=“duration” type=“timeOffset” use=“optional”/>
</xs:complexType>
```

The <FadeEffect> Tag

<FadeEffect> makes a parent element transparent on the display. The following primitive and advanced elements support use of the <FadeEffect> tag: Image, Text, Video, Scene and Navigator. When the FadeEffect is applied to the Image, Text or Video elements, a frame is applied according to the specifications of the standard attributes described below. When applied to the Scene or Navigator elements, a fade effect is applied to all the sub-elements within the scene, unless the sub-element specifies the disableEffect attribute. The following standard attributes apply to the <FadeEffect> tag:

| Attribute | Type | Default | Description |
|---|---|---|---|
| startAlpha | amom:percent | 100% | Allowable ranges of alpha (image |
| | | | presentation) are 100% (totally |
| | | | opaque) to 0% (totally transparent). |
| endAlpha | amom:percent | 100% | |
| startLevel | amom:percent | 100% | Allowable ranges of levels |
| | | | (audio output) are 100% |
| | | | (full audio) to 0% (no audio) |
| endLevel | amom:percent | 100% | |

The following sample illustrates the use of the <FadeEffect> tag, which causes the image to be totally transparent in a 10 second time-frame.

| | |
|---|---|
| <Image | |
| name | = “P1 - 4×6 Frame” |
| src | = “%SMGServer%\Samples\Family.jpg” |
| > | |
| <Render | |
| startTime | = “0.0” |
| centerX | = “65%” |
| width | = “25%” |
| height | = “25%” |
| /> | |
| <FadeEffect | |
| startTime | = “0.0” |
| endTime | = “10.0” |
| startAlpha | = “100%” |
| endAlpha | = “0%” |
| /> | |
| </Image> | |

XML Schema Definition

```
<xs:complexType name=“CFadeEffect”>
  <xs:complexContent>
    <xs:extension base=“CEffect”>
      <xs:attribute name=“startAlpha” type=“percent” use=“optional”/>
      <xs:attribute name=“endAlpha” type=“percent” use=“optional”/>
      <xs:attribute name=“startLevel” type=“percent” use=“optional”/>
      <xs:attribute name=“endLevel” type=“percent” use=“optional”/>
    </xs:extension>
  </xs:complexContent>
</xs:complexType>
```

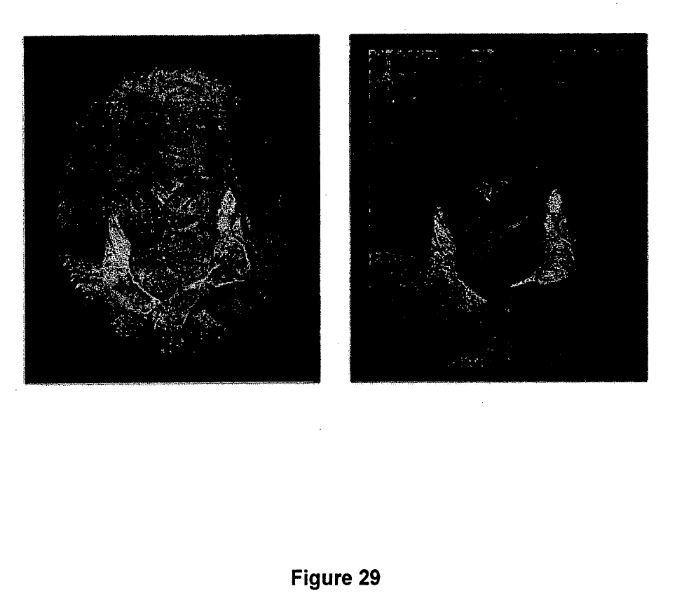

The <FilterEffect> Tag

<FilterEffect> applies a runtime filter to the parent element. It is similar to the <Render> addFilter attribute, but allows for additional parameters. For example, FIG. 29 illustrates an image with and without a gradient filter applied. The the gradient mask conforms to the dimensions of the parent element and the masked area becomes transparent, revealing the black background behind the image. The following primitive elements support use of the <FilterEffect> tag: Image and Video. When applied to these elements, the filter is applied according to the specifications of the standard attributes described below. The following standard attributes apply to the <FilterEffect> tag.

| Attribute | Type | Default | Description |
|---|---|---|---|
| addFilter | xs:string | null | See above: the <Render> Tag addFilter |
| | | | attribute for available filters. |
| src | xs:anyPath | null | Specifies the location of the mask |
| | | | content (file). It must use valid path |
| | | | or URL conventions and may use |
| | | | pre-defined constants. |

The following example illustrates the use of the <FilterEffect> tag applying a gradient mask. The mask is a transparent TIF file with black pixels defining the transparency.

<Image

| | |
|---|---|
| src | = “%SMGServerMedia%\Frame\Red.jpg” |
| addSetting | = “hidden \| read-only” |
| > | |

<Render

| | |
|---|---|
| startTime | = “0.0” |
| endTime | = “−0.0” |
| justify | = “vt-full \| hz-full” |
| width | = “105%” |
| height | = “105%” |
| centerX | = “50%” |
| centerY | = “50%” |
| centerZ | = “90” |
| /> | |

<FilterEffect

| | |
|---|---|
| addFilter | = “gradient” |
| src | = “%SMGServerMedia% |

\PixelShaders\Mask.tif”

| | |
|---|---|
| startTime | = “0.0” |
| endTime | = “−0.0” |
| /> | |

<FadeEffect

| | |
|---|---|
| startAlpha | = “90%” |
| /> | |

</Image>

XML Schema Definition

```
<xs:complexType name=“CFilterEffect”>
    <xs:complexContent>
        <xs:extension base=“CEffect”>
            <xs:attribute name=“addFilter” type=“xs:string”
            use=“required”/>
            <xs:attribute name=“src” type=“xs:anyURI”
            use=“optional”/>
        </xs:extension>
    </xs:complexContent>
</xs:complexType>
```

The <FrameEffect> Tag

<FrameEffect> places a frame around a parent element. The following primitive and advanced elements support use of the <FrameEffect> tag: Image, Video, Text, Scene and Navigator. For the Image and Video elements, a frame is applied according to the specifications of the standard attributes described below. For the Text element, the depth attribute indicates the pixel size of and outlying stencil applied behind the text. For the Scene and Navigator elements, the frame effect is applied to all the sub-elements within the scene, unless the sub-element specifies the disable-effect attribute. The following standard attributes apply to the <FrameEffect> tag.

| Attribute | Type | Default | Description |
|---|---|---|---|
| depth | amom:percent | 10% | This is the depth, relative to the |
| | | | parent element, not the screen. |
| color | amom:color | 0xffffff | Sets the frame color. The default is |
| | | | white (hex value 0xffffff). |

The following sample illustrates the use of the <FrameEffect> tag, applying a brown frame effect of 3% on a parent image.

<Image

| | |
|---|---|
| name | = “P1 - 4×6 Frame” |
| src | = “%SMGServer%\Samples\Family.jpg” |
| > | |

<Render

| | |
|---|---|
| startTime | = “0.0” |
| centerX | = “65%” |
| width | = “25%” |
| height | = “25%” |
| /> | |

<FrameEffect

| | |
|---|---|
| color | = “0x400000” |
| depth | = “4%” |
| /> | |

</Image>

XML Schema Definition

```
<xs:complexType name=“CFrameEffect”>
    <xs:complexContent>
        <xs:extension base=“CEffect”>
            <xs:attribute name=“depth” type=“pixel” use=“optional”/>
            <xs:attribute name=“color” type=“color” use=“optional”/>
        </xs:extension>
    </xs:complexContent>
</xs:complexType>
```

The <MotionEffect> Tag

<MotionEffect> moves a parent element from one position on the display to another. The following standard attributes apply to the <MotionEffect> tag (the percentages listed are offset values from the parent element's default position):

| Attribute | Type | Default | Description |
|---|---|---|---|
| startX | amom:percent | 0% | Starting and ending x, y, |
| | | | and z points are *relative* |
| | | | offsets from the specified |
| | | | default location of the |
| | | | parent element. |
| startY | amom:percent | 0% | |
| startZ | amom:percent | 0% | |
| endX | amom:percent | 0% | |
| endY | amom:percent | 0% | |
| endZ | amom:percent | 0% | |
| seriesType | amom:seriesType | null | sequential or random |

The following example illustrates the use of the <MotionEffect> tag, applying a movement of 20% to the right and 20% to the bottom (relative to the screen size) over a period of 10 seconds.

<Image

| | |
|---|---|
| name | = “P1 - 4×6 Frame” |
| src | = “%SMGServer%\Samples\Family.jpg” |
| > | |

<Render

| | |
|---|---|
| startTime | = “0.0” |
| centerX | = “65%” |
| width | = “25%” |
| height | = “25%” |
| /> | |

<MotionEffect

| | |
|---|---|
| startTime | = “0.0” |
| endTime | = “10.0” |
| startX | = “0%” |
| startY | = “0%” |
| endX | = “20%” |
| endY | = “20%” |
| /> | |

</Image>

XML Schema Definition

```
<xs:complexType name=“CMotionEffect”>
  <xs:complexContent>
    <xs:extension base=“CEffect”>
        <xs:attribute name=“startX” type=“percent” use=“optional”/>
        <xs:attribute name=“endX” type=“percent” use=“optional”/>
        <xs:attribute name=“startY” type=“percent” use=“optional”/>
        <xs:attribute name=“endY” type=“percent” use=“optional”/>
        <xs:attribute name=“startZ” type=“percent” use=“optional”/>
        <xs:attribute name=“endZ” type=“percent” use=“optional”/>
        <xs:attribute name=“seriesType” type=“series” use=“optional”/>
    </xs:extension>
  </xs:complexContent>
</xs:complexType>
```

The <RollEffect> Tag

<RollEffect> scrolls the parent element along the x, y, or z axis. The following standard attributes apply to the <RollEffect> tag.

| Attribute | Type | Default | Description |
|---|---|---|---|
| startX | amom:percent | 0% | Starting and ending x, y, and |
| | | | z points are *relative* offsets from |
| | | | the specified default location of |
| | | | the parent element. |
| startY | amom:percent | 0% | |
| startZ | amom:percent | 0% | |
| endX | amom:percent | 0% | |
| endY | amom:percent | 0% | |
| endZ | amom:percent | 0% | |

The following example illustrates the use of the <RollEffect> tag, scrolling a 4-line paragraph of text from the bottom of the element's display area (25% width, 25% height) to the top of the display area.

| | |
|---|---|
| <Text | |
| name | = “Quote” |
| src | = “Caption” |
| caption | = “This is line ONE.\n |
| This is line TWO.\n | |
| This is line 3.\n | |
| This is line 4.” | |
| > | |
| <Render | |
| foregroundColor | = “0x000000” |
| startTime | = “0.0” |
| centerX | = “65%” |
| width | = “25%” |
| height | = “25%” |
| /> | |
| <RollEffect | |
| startTime | = “0.0” |
| endTime | = “10.0” |
| startY | = “−25%” |
| endY | = “0%” |
| /> | |
| </Text> | |

XML Schema Definition

```
<xs:complexType name=“CRollEffect”>
  <xs:complexContent>
    <xs:extension base=“CEffect”>
        <xs:attribute name=“startX” type=“percent” use=“optional”/>
        <xs:attribute name=“endX” type=“percent” use=“optional”/>
        <xs:attribute name=“startY” type=“percent” use=“optional”/>
        <xs:attribute name=“endY” type=“percent” use=“optional”/>
        <xs:attribute name=“startZ” type=“percent” use=“optional”/>
        <xs:attribute name=“endZ” type=“percent” use=“optional”/>
    </xs:extension>
  </xs:complexContent>
</xs:complexType>
```

The <RotateEffect> Tag

<RotateEffect> rotates the parent element along the x, y, or z axis. In addition, the parent element rotation is affected by the element justification (e.g., left, top, center). The following standard attributes apply to the <RotateEffect> tag.

| Attribute | Type | Default | Description |
|---|---|---|---|
| startX | amom:degrees | 0 | Starting and ending x, y, and z |
| | | | degrees are *relative* offsets from |
| | | | the specified default orientation |
| | | | of the parent element. |
| startY | amom:degrees | 0 | |
| startZ | amom:degrees | 0 | |
| endX | amom:degrees | 0 | Specifying ending values greater |
| | | | than 360 degrees will |
| | | | cause the parent element to ‘spin’, |
| | | | ie. a startZ of 0 and an endZ of 720 |
| | | | will cause the element to complete |
| | | | two rotations for the duration |
| | | | of the effect. |
| endY | amom:degrees | 0 | |
| endZ | amom:degrees | 0 | |

The following example illustrates the use of the <RotateEffect> tag, applying a 15 degree rotation on a parent image during a 10 second time-frame.

| | |
|---|---|
| <Image | |
| name | = “P1 - 4×6 Frame” |
| src | = “%SMGServer%\Samples\Family.jpg” |
| > | |
| <Render | |
| startTime | = “0.0” |
| centerX | = “65%” |
| width | = “25%” |
| height | = “25%” |
| /> | |
| <RotateEffect | |
| startTime | = “0.0” |
| endTime | = “10.0” |
| startZ | = “0” |
| endZ | = “15” |
| /> | |
| </Image> | |

XML Schema Definition

```
<xs:complexType name=“CRotateEffect”>
  <xs:complexContent>
    <xs:extension base=“CEffect”>
        <xs:attribute name=“startX” type=“angle” use=“optional”/>
        <xs:attribute name=“endX” type=“angle” use=“optional”/>
        <xs:attribute name=“startY” type=“angle” use=“optional”/>
        <xs:attribute name=“endY” type=“angle” use=“optional”/>
        <xs:attribute name=“startZ” type=“angle” use=“optional”/>
        <xs:attribute name=“endZ” type=“angle” use=“optional”/>
    </xs:extension>
  </xs:complexContent>
</xs:complexType>
<xs:element name=“RotateEffect” type=“CRotateEffect”/>
```

The <ShadowEffect> Tag

<ShadowEffect> places a shadow behind a parent element. The following primitive and advanced elements support use of the <ShadowEffect> tag: Image, Video, Text and Scene. When applied to the Image and Video elements, the shadow is applied according to the specifications of the standard attributes described below. When applied to the Text element, the depth attribute indicates the distance the shadow is offset, rather than the size of the shadow. When applied to the Scene element, the tag is applied to all the sub-elements within the scene, unless the sub-element specifies the disable-effect attribute. The following standard attributes apply to the <ShadowEffect> tag.

| Attribute | Type | Default | Description |
|---|---|---|---|
| depth | amom:pixel | 10 | |
| startAlpha | amom:percent | 100% | Alpha value defines how ‘dark’ |
| | | | the shadow will be, starting |
| | | | from the edge of the parent image. |
| | | | A 100% alpha value is totally |
| | | | black (opaque), whereas a 0% |
| | | | alpha value is totally |
| | | | transparent (no shadow). |
| endAlpha | amom:percent | 20% | |
| startX | amom:angle | 45° | Angles are in degrees. Typical |
| | | | angles range from 0°-360°. |
| endX | amom:angle | 45° | |

The following example illustrates the use of the <ShadowEffect> tag, applying a 15 pixel shadow on a parent image (the default shadow angle of 45° is used).

| | |
|---|---|
| <Image | |
| name | = “P1 - 4×6 Frame” |
| src | = “%SMGServer%\Samples\Family.jpg” |
| > | |
| <Render | |
| startTime | = “0.0” |
| centerX | = “65%” |
| width | = “25%” |
| height | = “25%” |
| /> | |
| <ShadowEffect | |
| depth | = “15” |
| /> | |
| </Image> | |

XML Schema Definition

```
<xs:complexType name=“CShadowEffect”>
  <xs:complexContent>
    <xs:extension base=“CEffect”>
      <xs:attribute name=“depth” type=“pixel” use=“optional”/>
      <xs:attribute name=“startX” type=“angle” use=“optional”/>
      <xs:attribute name=“endX” type=“angle” use=“optional”/>
      <xs:attribute name=“startAlpha” type=“percent” use=“optional”/>
      <xs:attribute name=“endAlpha” type=“percent” use=“optional”/>
    </xs:extension>
  </xs:complexContent>
</xs:complexType>
```

The <SizeEffect> Tag

<SizeEffect> increases or decreases the size of a rendering element on the display. The following primitive and advanced elements support use of the <SizeEffect> tag: Image, Text and Video. The following standard attributes apply to the <SizeEffect> tag:

| Attribute | Type | Default | Description |
|---|---|---|---|
| startSize | amom:percent | 100% | startSize indicates the initial size of the parent element |
| | | | when the effect is first applied. The element is then |
| | | | enlarged or reduce over the duration of the effect until |
| | | | the endSize is reached. All sizes are expressed as a |
| | | | percentage of the parent element's size relative to the |
| | | | <Render> width and height values. |
| endSize | amom:percent | 100% | If no endSize is specified, endSize is set to equal |
| | | | startSize. Note: Setting the <Render> width and height |
| | | | values to 100% and resizing to 25% with the |
| | | | <SizeEffect> tag will result in higher quality zoomed, |
| | | | enlarged and cameraEffect manipulated images than |
| | | | those with <Render> width and height values of 25%. |

The following example illustrates the use of the <SizeEffect> tag, shrinking the original image by 50% in a 10 second time-frame.

| | |
|---|---|
| <Image | |
| name | = “P1 - 4×6 Frame” |
| src | = “%SMGServer%\Samples\Family.jpg” |
| > | |
| <Render | |
| startTime | = “0.0” |
| centerX | = “65%” |
| width | = “100%” |
| height | = “100%” |
| /> | |
| <SizeEffect | |
| startTime | = “0.0” |
| endTime | = “10.0” |
| startSize | = “50%” |
| endSize | = “25%” |
| /> | |
| </Image> | |

XML Schema Definition

```
<xs:complexType name=“CSizeEffect”>
  <xs:complexContent>
    <xs:extension base=“CEffect”>
      <xs:attribute name=“startSize” type=“percent” use=“optional”/>
      <xs:attribute name=“endSize” type=“percent” use=“optional”/>
    </xs:extension>
  </xs:complexContent>
</xs:complexType>
```

The <WipeEffect> Tag

<WipeEffect>“presents” a particular horizontal or vertical section of the parent element. The following primitive and advanced elements support use of the <WipeEffect> tag: Image, Text and Video. The following standard attributes apply to the <WipeEffect> tag.

| Attribute | Type | Default | Description |
|---|---|---|---|
| startX | amom:percent | 50% | Starting and ending x, y, and z |
| | | | points are *relative* offsets from |
| | | | the specified default location of |
| | | | the parent element. |
| startY | amom:percent | 50% | |
| startZ | amom:percent | 0% | |
| endX | amom:percent | 50% | |
| endY | amom:percent | 50% | |
| endZ | amom:percent | 0% | |
| startWidth | amom:percent | 100% | Starting and ending widths, |
| | | | heights and depths are |
| | | | *relative* offsets from the |
| | | | specified default size of |
| | | | the parent element. |
| startHeight | amom:percent | 100% | |
| startDepth | amom:percent | 0% | |
| endWidth | amom:percent | 100% | |
| endHeight | amom:percent | 100% | |
| endDepth | amom:percent | 0% | |

The following XML example illustrates the use of the <WipeEffect> tag, applying a left-to-right wipe on a parent image.

| | |
|---|---|
| <Image | |
| name | = “P1 - 4×6 Frame” |
| src | = “%SMGServer%\Samples\Family.jpg” |
| > | |
| <Render | |
| removeSetting | = “optimize” |
| startTime | = “0.0” |
| width | = “100%” |
| height | = “100%” |
| /> | |
| <WipeEffect | |
| startTime | = “0.0” |
| endTime | = “10.0” |
| startX | = “5%” |
| startWidth | = “20%” |
| endX | = “95%” |
| /> | |
| </Image> | |

XML Schema Definition

```
<xs:complexType name=“CWipeEffect”>
  <xs:complexContent>
    <xs:extension base=“CEffect”>
      <xs:attribute name=“startX” type=“percent” use=“optional”/>
      <xs:attribute name=“endX” type=“percent” use=“optional”/>
      <xs:attribute name=“startY” type=“percent” use=“optional”/>
      <xs:attribute name=“endY” type=“percent” use=“optional”/>
      <xs:attribute name=“startZ” type=“percent” use=“optional”/>
      <xs:attribute name=“endZ” type=“percent” use=“optional”/>
      <xs:attribute name=“startWidth” type=“percent” use=“optional”/>
      <xs:attribute name=“startHeight” type=“percent” use=“optional”/>
      <xs:attribute name=“startDepth” type=“percent” use=“optional”/>
      <xs:attribute name=“endWidth” type=“percent” use=“optional”/>
      <xs:attribute name=“endHeight” type=“percent” use=“optional”/>
      <xs:attribute name=“endDepth” type=“percent” use=“optional”/>
    </xs:extension>
  </xs:complexContent>
</xs:complexType>
```

The <ZoomEffect> Tag

<ZoomEffect>“zooms” in or out (magnification) on a particular point of focus. It differs from <SizeEffect> in that the size of the element does not change, rather the contents within the frame are magnified. The following primitive and advanced elements support use of the <ZoomEffect> tag: Image, Text and Video. The following standard attributes apply to the <ZoomEffect> tag.

| Attribute | Type | Default | Description |
|---|---|---|---|
| startX | amom:percent | 0% | Starting and ending x, y, and z |
| | | | points are *relative* offsets from |
| | | | the specified default location of the |
| | | | parent element. They also indicate |
| | | | the point of focus. |
| startY | amom:percent | 0% | |
| startZ | amom:percent | 0% | |
| endX | amom:percent | 0% | |
| endY | amom:percent | 0% | |
| endZ | amom:percent | 0% | |
| startSize | amom:percent | 100% | startSize and endSize determine |
| | | | whether the element is zooming |
| | | | in or out. |
| endSize | amom:percent | 100% | |

The following XML example illustrates the use of the <ZoomEffect> tag, applying a 450% zoom to a slightly-left, top focal point on a parent image.

| | |
|---|---|
| <Image | |
| src | = “%BPServerMedia%\Images\MMNavBackground.jpg” |
| id | = “CREDITS_BACKGROUND” |
| addSetting | = “stock-media” |
| > | |
| <Render | |

| | |
|---|---|
| startTime | = “0.0” |
| endTime | = “0.0” |
| overlapTime | = “−1” |
| centerZ | = “100%” |
| width | = “100%” |
| height | = “80%” |
| /> | |
| <ZoomEffect | |
| startTime | = “0.0” |
| endTime | = “1.0” |
| startSize | = “110%” |
| startX | = “40%” |
| /> | |
| <ZoomEffect | |
| startTime | = “1.0” |
| endTime | = “−0.0” |
| startSize | = “110%” |
| startX | = “40%” |
| endX | = “50%” |
| /> | |
| </Image> | |

XML Schema Definition

```
<xs:complexType name=“CZoomEffect”>
  <xs:complexContent>
    <xs:extension base=“CEffect”>
      <xs:attribute name=“startX” type=“percent” use=“optional”/>
      <xs:attribute name=“endX” type=“percent” use=“optional”/>
      <xs:attribute name=“startY” type=“percent” use=“optional”/>
      <xs:attribute name=“endY” type=“percent” use=“optional”/>
      <xs:attribute name=“startZ” type=“percent” use=“optional”/>
      <xs:attribute name=“endZ” type=“percent” use=“optional”/>
      <xs:attribute name=“startSize” type=“percent” use=“optional”/>
      <xs:attribute name=“endSize” type=“percent” use=“optional”/>
    </xs:extension>
  </xs:complexContent>
</xs:complexType>
```

Advanced Special Effects

The <CameraEffect> Tag

The <CameraEffect> tag has the following attributes:

| Attribute | Type | Default | Description |
|---|---|---|---|
| seriesType | amom:seriesType | linear | linear |
| | | | bezier |
| | | | autoUp |
| | | | least squares |
| fieldOfView | xs:float | 1.0 | |
| eyeValues | amom:coordinateSet | null | Defines the time/space |
| | | | location of the eye/camera |
| | | | as follows (T1 x1 y1 z1; |
| | | | T2 x2 y2 z2; . . . ; |
| | | | Tn xn yn zn). |
| lookValues | amom:coordinateSet | null | Defines where the |
| | | | eye/camera is ‘looking’ |
| | | | as follows (T1 x1 y1 z1; T2 |
| | | | x2 y2 z2; . . . ; Tn xn |
| | | | yn zn). |
| upValues | amom:coordinateSet | null | Defines the up vector of the |
| | | | eye/camera as follows |
| | | | (T1 x1 y1 z1; T2 x2 y2 z2; |
| | | | . . . ; Tn xn yn zn). |

The following example illustrates the use of the <CameraEffect>. The effect will cause the elements of ObjectOne.xml and ObjectTwo.xml to ‘pan’ to the left and slightly upward while ‘shrinking’ in size as the eye values change over the time interval of 0 seconds to 12 seconds. Note the lookValues ‘drift’ with the eyeValues. Offset look and eye values cause the elements to skew with 3D perspective as the eyeValue moves relative to the lookValue.

| | |
|---|---|
| <Scene> | |
| <Render | |
| startTime = “0.0” | |
| endTime | = “−0.0” |
| /> | |
| <CameraEffect | |
| eyeValues | = “0 −40 −32 25; 8 −12 −14 2; 12 16 −15 |
| −3” | |
| lookValues | = “0 −40 −32 100; 8 −12 −14 100; 12 16 −15 |
| 100” | |
| /> | |
| <Scene | |
| src | = “%SMGServer%\Scenes\Objectone.xml” |
| > | |
| </Scene> | |
| <Scene | |
| src | = “%SMGServer%\Scenes\ObjectTwo.xml” |
| > | |
| </Scene> | |
| </Scene> | |

XML Schema Definition

```
  <xs:complexType name=“CCameraEffect”>
    <xs:complexContent>
      <xs:extension base=“CEffect”>
        <xs:attribute name=“seriesType” type=“series” use=“optional”/>
        <xs:attribute name=“fieldOfView” type=“angle” use=“optional”/>
        <xs:attribute name=“eyeValues” type=“coordinateSet”
use=“optional”/>
        <xs:attribute name=“lookValues” type =“coordinateSet”
use=“optional”/>
        <xs:attribute name=“upValues” type=“coordinateSet”
use=“optional”/>
      </xs:extension>
    </xs:complexContent>
  </xs:complexType>
```

The <RenderEffect> Tag

<RenderEffect> controls playback of video elements as per the standard attributes listed below. The following standard attributes apply to the <RenderEffect> tag:

| Attribute | Type | Default | Description |
|---|---|---|---|
| playRate | amom:playRate | play | Enables the pausing and resuming |
| | | | of video playback. pause - stop |
| | | | video playback play - resume |
| | | | video playback |

The example freezes playback of the video after 4 seconds until the end of the scene.

| <Video | |
|---|---|
| displayLabel | = “Video One” |
| src | = “%SMGServer%\Video\Black.avi” |
| > | |
| <Render | |
| startTime | = “0.0” |
| endTime | = “0.0” |
| width | = “112%” |
| height | = “104%” |
| centerX | = “50%” |
| centerY | = “50%” |
| centerZ | = “100%” |
| /> | |
| <!-- Snapshot (Below) --> | |
| <RenderEffect | |
| startTime | = “4.0” |
| endTime | = “−0.0” |
| playRate | = “pause” |
| /> | |
| </Video> | |

XML Schema Definition

```
<xs:complexType name=“CRenderEffect”>
    <xs:complexContent>
        <xs:extension base=“CEffect”>
            <xs:attribute name=“playRate” type=“playRate”
            use=“optional”/>
        </xs:extension>
    </xs:complexContent>
</xs:complexType>
```

Data Elements

The following data elements are defined: DropData, LogData and MetaData. In addition, the following media data elements are defined: PresentationData, ProductionData, ImageData, TextData, AudioData and VideoData.

The <Data> Tag

The <Data> tag has the following attributes:

| Attribute | Type | Default | Description |
|---|---|---|---|
| refId | xs:string | null | Used to reference the id of the object |
| | | | that data element should be applied to. |

XML Schema Definition

<xs:complexType name=“CData” abstract=“true”>
<xs:attribute name=“refId” type=“xs:string” use=“required”/>
</xs:complexType>

The <DropData> Tag

The <DropData> tag allows specified data to be dropped on a specified object. For example, a directory can be specified as the source and the files in a directory will be dropped on the presentation specified by the refId. The <DropData> tag inherits the attributes of the base <Data> tag, as well as the following additional attribute:

| Attribute | Type | Default | Description |
|---|---|---|---|
| type | xs:string | null | Specifies the type of data to drop. |
| src | amom:anyPath | null | Specifies the path to the data. |

The following is an example of the <DropData> tag:

| | |
|---|---|
| <DropData | |
| type | = “Directory” |
| refId | = “PRESENTATION2” |
| src | = “%SMGClient%\LE Media” |
| /> | |

XML Schema Definition

```
<xs:element name=“DropData”>
    <xs:complexType>
        <xs:complexContent>
            <xs:extension base=“CData”>
                <xs:attribute name=“type” type=“xs:string”
                use=“optional”/>
                <xs:attribute name=“src” type=“anyPath”
                use=“optional”/>
            </xs:extension>
        </xs:complexContent>
    </xs:complexType>
</xs:element>
```

The <LogData> Tag

The <LogData> tag inherits the attributes of the base <Data> tag, as well as the following additional attribute:

| | | | |
|---|---|---|---|
| Attribute | Type | Default | Description |

| | | |
|---|---|---|
| status | amom:status | null |

XML Schema Definition

```
<xs:element name=“LogData”>
    <xs:complexType>
        <xs:complexContent>
            <xs:extension base=“CData”>
                <xs:attribute name=“status” type=“status”
                use=“optional”/>
            </xs:extension>
        </xs:complexContent>
    </xs:complexType>
</xs:element>
```

The <MetaData> Tag

The <MetaData> tag inherits the attributes of the base <Data> tag, as well as the following additional attributes:

| | | | |
|---|---|---|---|
| Attribute | Type | Default | Description |

| | | |
|---|---|---|
| author | xs:string | null |
| caption | xs:string | null |
| category | xs:string | null |
| comments | xs:string | null |
| createDate | xs:string | null |
| keywords | xs:string | null |
| modifyDate | xs:string | null |
| place | xs:string | null |
| subject | xs:string | null |
| title | xs:string | null |

XML Schema Definition

```
<xs:element name=“MetaData”>
  <xs:complexType>
    <xs:complexContent>
      <xs:extension base=“CData”>
        <xs:attribute name=“author” type=“xs:string” use=“optional”/>
        <xs:attribute name=“caption” type=“xs:string” use=“optional”/>
        <xs:attribute name=“category” type=“xs:string”
        use=“optional”/>
        <xs:attribute name=“comments”
        type=“xs:string”
        use=“optional”/>
        <xs:attribute name=“createDate” type=“xs:string”
        use=“optional”/>
        <xs:attribute name=“keywords” type=“xs:string”
        use=“optional”/>
        <xs:attribute name=“modifyDate” type=“xs:string”
        use=“optional”/>
        <xs:attribute name=“place” type=“xs:string” use=“optional”/>
        <xs:attribute name=“subject” type=“xs:string” use=“optional”/>
        <xs:attribute name=“title” type=“xs:string” use=“optional”/>
      </xs:extension>
    </xs:complexContent>
  </xs:complexType>
</xs:element>
```

Media Data Elements

The <AudioData> Tag

The <AudioData> tag inherits the attributes of the base <Data> tag, as well as the following additional attributes:

| Attribute | Type | Default | Description |
|---|---|---|---|
| src | amom:audioPath | null | Path to audio file. |
| loop | xs:Boolean | true | If audio reaches the end before |
| | | | render its render time is finished |
| | | | it will start from the beginning. |
| inTime | amom:timeOffset | 0.0 | Specifies a start time within |
| | | | the audio track. For example the |
| | | | first 5 seconds of an audio file |
| | | | can be skipped by setting |
| | | | inTime to 5.0. |
| outTime | amom:timeOffset | 0.0 | Specifies a time earlier then the |
| | | | end of the audio track that can |
| | | | be used to end or loop from. |

### EXAMPLE

```
<AudioData
    refId = “DVD_AUDIO”
    src = “%SMGServerMedia%\LifeSketch\Audio\Folkways
    (60 sec edit) .mp3”
/>
```

XML Schema Definition

```
<xs:element name=“AudioData”>
  <xs:complexType>
    <xs:complexContent>
      <xs:extension base=“CData”>
        <xs:attribute name=“src” type=“audioURI” use=“required”/>
        <xs:attribute name=“loop” type=“xs:boolean” use=“optional”/>
        <xs:attribute name=“inTime” type=“timeOffset”
        use=“optional”/>
        <xs:attribute name=“outTime” type=“timeOffset”
        use=“optional”/>
      </xs:extension>
    </xs:complexContent>
  </xs:complexType>
</xs:element>
```

The <ImageData> Tag

The <ImageData> tag inherits the attributes of the base <Data> tag, as well as the following additional attributes:

| Attribute | Type | Default | Description |
|---|---|---|---|
| src | amom:imagePath | null | Path to an image file. |
| filter | amom:blurFilter | null | One or more of the following |
| | | | filters can be applied |
| | | | to the image. |
| | | | blur, |
| | | | blur-more, |
| | | | mipmap |
| caption | xs:string | null | |

### EXAMPLE

| | |
|---|---|
| <ImageData | |
| refId | = “CREDITS_BACKGROUND” |
| src | = “%BPServerMedia%\AmericanTribute\ |
| | MMNavBackground.tif” |
| /> | |

XML Schema Definition

```
<xs:element name=“ImageData”>
  <xs:complexType>
    <xs:complexContent>
      <xs:extension base=“CData”>
        <xs:attribute name=“src” type=“imageURI” use=“required”/>
        <xs:attribute name=“filter” type=“blurFilter” use=“optional”/>
        <xs:attribute name=“caption” type=“xs:string” use=“optional”/>
      </xs:extension>
    </xs:complexContent>
  </xs:complexType>
</xs:element>
```

The <TextData> Tag

The <TextData> tag inherits the attributes of the base <Data> tag, as well as the following additional attribute:

| Attribute | Type | Default | Description |
|---|---|---|---|
| caption | xs:string | null | Replaces text currently displayed by the |
| | | | text element referenced by refId. |

### EXAMPLE

| | |
|---|---|
| <TextData | |
| refId | = “DVD_PRODUCER” |
| caption | = “Sequoia Media Group” |
| /> | |

XML Schema Definition

```
<xs:element name=“TextData”>
  <xs:complexType>
    <xs:complexContent>
      <xs:extension base=“CData”>
        <xs:attribute name=“caption” type=“xs:string” use=“required“/>
      </xs:extension>
    </xs:complexContent>
  </xs:complexType>
</xs:element>
```

The <VideoData> Tag

The <VideoData> tag inherits the attributes of the base <Data> tag, as well as the following additional attributes:

| Attribute | Type | Default | Description |
|---|---|---|---|
| src | amom:videoPath | null | Path to the video file. |
| caption | xs:string | null | |
| loop | xs:Boolean | true | Specifies whether the video |
| | | | should loop when |
| | | | the end is reached. |
| inTime | amom:timeOffset | 0.0 | Speicifies a start time within the |
| | | | video. |
| outTime | amom:timeOffset | 0.0 | Speicifies an end time within the |
| | | | video. |

### EXAMPLE

<VideoData

| | |
|---|---|
| refId | = “RANDOM_BACKGROUND” |
| src | = “%SMGServerMedia%\LifeSketch\Video\WaterFall01.m2v” |
| /> | |

XML Schema Definition

```
<xs:element name=“VideoData”>
  <xs:complexType>
    <xs:complexContent>
      <xs:extension base=“CData”>
        <xs:attribute name=“src” type=“videoURI” use=“required”/>
        <xs:attribute name=“caption” type=“xs:string” use=“optional”/>
        <xs:attribute name=“loop” type=“xs:boolean” use=“optional”/>
        <xs:attribute name=“inTime” type=“timeOffset”
        use=“optional”/>
        <xs:attribute name=“outTime” type=“timeOffset”
        use=“optional”/>
      </xs:extension>
    </xs:complexContent>
  </xs:complexType>
</xs:element>
```

The <PresentationData> Tag

The <PresentationData> tag inherits the attributes of the base <Data> tag, as well as the following additional attributes:

| Attribute | Type | Default | Description |
|---|---|---|---|
| src | amom:anyPath | null | Path to the Presentation. |

The <PresentationData> tag contains the following child elements, AudioData, ImageData, TextData and VideoData.

### EXAMPLE

<PresentationData

| | |
|---|---|
| refId | = “PRESENTATION4” |
| src | = “%SMGServerMedia%\GameFace\Volleyball\Roster.xml” |
| /> | |

XML Schema Definition

```
<xs:element name=“PresentationData”>
  <xs:complexType>
    <xs:complexContent>
      <xs:extension base=“CData”>
        <xs:sequence minOccurs=“0” maxOccurs=“unbounded”>
          <xs:element ref=“AudioData” minOccurs=“0”
maxOccurs=“unbounded”/>
          <xs:element ref=“ImageData” minOccurs=“0”
maxOccurs=“unbounded”/>
          <xs:element ref=“TextData” minOccurs=“0”
maxOccurs=“unbounded”/>
          <xs:element ref=“VideoData” minOccurs=“0”
maxOccurs=“unbounded”/>
        </xs:sequence>
        <xs:attribute name=“src” type=“videoPath” use=“required”/>
      </xs:extension>
    </xs:complexContent>
  </xs:complexType>
</xs:element>
```

The <ProductionData> Tag

The <ProductionData> tag inherits the attributes of the base <Data> tag, as well as the following additional attributes:

| | | | |
|---|---|---|---|
| Attribute | Type | Default | Description |

| | | |
|---|---|---|
| burnFormat | amom:burnFormat | 0 |
| aspectRatio | amom:aspectRatio | null |
| language | xs:language | null |

The <ProductionData> tag contains the following child elements: AudioData, ImageData, TextData, VideoData and PresentationData.

XML Schema Definition

```
<xs:element name=“ProductionData”>
  <xs:complexType>
    <xs:complexContent>
      <xs:extension base=“CData”>
        <xs:sequence minOccurs=“0” maxOccurs=“unbounded”>
          <xs:element ref=“AudioData” minOccurs=“0” maxOccurs=“unbounded”/>
          <xs:element ref=“ImageData” minOccurs=“0” maxOccurs=“unbounded”/>
          <xs:element ref=“TextData” minOccurs=“0” maxOccurs=“unbounded”/>
          <xs:element ref=“VideoData” minOccurs=“0” maxOccurs=“unbounded”/>
          <xs:element ref=“PresentationData” minOccurs=“0”
maxOccurs=“unbounded”/>
        </xs:sequence>
        <xs:attribute name=“burnFormat” type=“burnFormat” use=“optional”/>
        <xs:attribute name=“aspectRatio” type=“aspectRatio” use=“optional”/>
        <xs:attribute name=“language” type=“xs:language” use=“optional”/>
      </xs:extension>
    </xs:complexContent>
  </xs:complexType>
</xs:element>
```

Property Descriptors

The <PropertyDescriptor> Tag

The <PropertyDescriptor> has the following additional attribute:

| | | | |
|---|---|---|---|
| Attribute | Type | Default | Description |

| | |
|---|---|
| attrName | xs:string |
| displayLabel | xs:string |
| description | xs:string |
| use | amom:useType |

XML Schema Definition

```
<xs:complexType name=“CPropertyDescriptor”>
  <xs:attribute name=“attrName” type=“xs:string” use=“required”/>
  <xs:attribute name=“displayLabel” type=“xs:string” use=“optional”/>
  <xs:attribute name=“description” type=“xs:string” use=“optional”/>
  <xs:attribute name=“use” type=“useType” use=“required”/>
</xs:complexType>
```

The <PathPropertyDescriptor> Tag

The <PathPropertyDescriptor> tag inherits the attributes of the base <PropertyDescriptor> tag, as well as the following additional attribute:

| | | | |
|---|---|---|---|
| Attribute | Type | Default | Description |

| | |
|---|---|
| defaultValue | xs:anyPath |

XML Schema Definition

```
<xs:element name=“URIPropertyDescriptor”>
  <xs:complexType>
    <xs:complexContent>
      <xs:extension base=“CPropertyDescriptor”>
        <xs:attribute name=“defaultValue” type=“xs:anyPath”
        use=“optional”/>
      </xs:extension>
    </xs:complexContent>
  </xs:complexType>
</xs:element>
```

The <AudioPathPropertyDescriptor> Tag

The <AudioPathPropertyDescriptor> tag inherits the attributes of the base <PropertyDescriptor> tag, as well as the following additional attribute:

| | | | |
|---|---|---|---|
| Attribute | Type | Default | Description |

| | |
|---|---|
| defaultValue | amom:audioPath |

### EXAMPLE

| <audioPathPropertyDescriptor | |
|---|---|
| attrName | = “src” |
| displayLabel | = “Default Audio” |
| use | = “required” |
| /> | |

XML Schema Definition

```
<xs:element name=“AudioURIPropertyDescriptor”>
  <xs:complexType>
    <xs:complexContent>
      <xs:extension base=“CPropertyDescriptor”>
        <xs:attribute name=“defaultValue” type=“audioPath”
        use=“optional”/>
      </xs:extension>
    </xs:complexContent>
  </xs:complexType>
</xs:element>
```

The <ImagePathPropertyDescriptor> Tag

The <ImagePathPropertyDescriptor> tag inherits the attributes of the base <PropertyDescriptor> tag, as well as the following additional attribute:

| | | | |
|---|---|---|---|
| Attribute | Type | Default | Description |

| | |
|---|---|
| defaultValue | amom:imagePath |

### EXAMPLE

| <ImagePathPropertyDescriptor | |
|---|---|
| attrName | = “src” |
| displayLabel | = “Team Photo” |
| use | = “required” |
| /> | |

XML Schema Definition

```
<xs:element name=“ImageURIPropertyDescriptor”>
  <xs:complexType>
    <xs:complexContent>
      <xs:extension base=“CPropertyDescriptor”>
        <xs:attribute name=“defaultValue” type=“imagePath”
        use=“optional”/>
      </xs:extension>
    </xs:complexContent>
  </xs:complexType>
</xs:element>
```

The <VideoPathPropertyDescriptor> Tag

The <VideoPathPropertyDescriptor> tag inherits the attributes of the base <PropertyDescriptor> tag, as well as the following additional attribute:

| | | | |
|---|---|---|---|
| Attribute | Type | Default | Description |

| | |
|---|---|
| defaultValue | amom:videoPath |

### EXAMPLE

| <VideoPathPropertyDescriptor | |
|---|---|
| attrName | = “src” |
| displayLabel | = “Team Video” |
| use | = “required” |
| /> | |

XML Schema Definition

```
<xs:element name=“VideoURIPropertyDescriptor”>
  <xs:complexType>
    <xs:complexContent>
      <xs:extension base=“CPropertyDescriptor”>
        <xs:attribute name=“defaultValue” type=“videoPath”
        use=“optional”/>
      </xs:extension>
    </xs:complexContent>
  </xs:complexType>
</xs:element>
```

The <XmlPropertyDescriptor> Tag

The <XmlPropertyDescriptor> tag inherits the attributes of the base <PropertyDescriptor> tag, as well as the following additional attribute:

| | | | |
|---|---|---|---|
| Attribute | Type | Default | Description |

| | |
|---|---|
| defaultValue | amom:xmlPath |

### EXAMPLE

| <XmlPathPropertyDescriptor | |
|---|---|
| attrName | = “src” |
| use | = “required” |
| /> | |

XML Schema Definition

```
<xs:element name=“XmlPathPropertyDescriptor”>
  <xs:complexType>
    <xs:complexContent>
      <xs:extension base=“CPropertyDescriptor”>
        <xs:attribute name=“defaultValue” type=“xmlPath”
use=“optional”/>
      </xs:extension>
    </xs:complexContent>
  </xs:complexType>
</xs:element>
```

The <FilterPropertyDescriptor> Tag

The <FilterPropertyDescriptor> tag inherits the attributes of the base <PropertyDescriptor> tag, as well as the following additional attribute:

| | | | |
|---|---|---|---|
| Attribute | Type | Default | Description |

| | |
|---|---|
| defaultValue | amom:blurFilter |

### EXAMPLE

| <FilterPathPropertyDescriptor | |
|---|---|
| attrName | = “src” |
| use | = “required” |
| /> | |

XML Schema Definition

```
<xs:element name=“FilterPropertyDescriptor”>
  <xs:complexType>
    <xs:complexContent>
      <xs:extension base=“CPropertyDescriptor”>
        <xs:attribute name=“defaultValue” type=“blurFilter”
        use=“optional”/>
      </xs:extension>
    </xs:complexContent>
  </xs:complexType>
</xs:element>
```

The <StringPropertyDescriptor> Tag

The <StringPropertyDescriptor> tag inherits the attributes of the base <PropertyDescriptor> tag, as well as the following additional attributes:

| | | | |
|---|---|---|---|
| Attribute | Type | Default | Description |

| | |
|---|---|
| defaultValue | xs:string |
| pattern | xs:string |
| maxLength | xs:int |

### EXAMPLE

| <StringPropertyDescriptor | |
|---|---|
| attrName | = “caption” |
| maxLength | = “32” |
| displayLabel | = “Photo caption” |
| description | = “Caption for this photo.” |
| use | = “optional” |
| /> | |

XML Schema Definition

```
<xs:element name=“StringPropertyDescriptor”>
  <xs:complexType>
    <xs:complexContent>
      <xs:extension base=“CPropertyDescriptor”>
        <xs:attribute name=“defaultValue” type=“xs:string” use=
        “optional”/>
        <xs:attribute name=“pattern” type=“xs:string” use=“optional”/>
        <xs:attribute name=“maxLength” type=“xs:int” use=
        “optional”/>
      </xs:extension>
    </xs:complexContent>
  </xs:complexType>
</xs:element>
```

Requirements

<Requirements> Base Class

The <Requirements> base class has the following attributes:

| | | | |
|---|---|---|---|
| Attribute | Type | Default | Description |

| | |
|---|---|
| refId | xs:string |
| title | xs:string |
| description | xs:string |
| thumbnail | amom:imagePath |

XML Schema Definition

```
<xs:complexType name=“CRequirements”>
    <xs:attribute name=“refId” type=“xs:string” use=“optional”/>
    <xs:attribute name=“title” type=“xs:string” use=“optional”/>
    <xs:attribute name=“description” type=“xs:string” use=“optional”/>
    <xs:attribute name=“thumbnail” type=“imagePath” use=“optional”/>
</xs:complexType>
```

<Option> Base Class

The <Option> base class has the following attributes:

| | | | |
|---|---|---|---|
| Attribute | Type | Default | Description |

| | |
|---|---|
| title | xs:string |
| description | xs:string |
| requirements | amom:xmlPath |
| thumbnail | amom:imagePath |
| use | amom:useType |

XML Schema Definition

```
<xs:complexType name=“COption”>
    <xs:attribute name=“title” type=“xs:string” use=“required”/>
    <xs:attribute name=“description” type=“xs:string” use=“required”/>
    <xs:attribute name=“requirements” type=“xmlPath” use=“required”/>
    <xs:attribute name=“thumbnail” type=“imagePath” use=“required”/>
    <xs:attribute name=“use” type=“useType” use=“required”/>
</xs:complexType>
```

<Options> Base Class

The <Options> base class has the following attributes:

| | | | |
|---|---|---|---|
| Attribute | Type | Default | Description |

| | |
|---|---|
| title | xs:string |
| thumbnail | amom:imagePath |

XML Schema Definition

```
<xs:complexType name=“COptions”>
    <xs:attribute name=“title” type=“xs:string” use=“required”/>
    <xs:attribute name=“thumbnail” type=“imagePath” use=“required”/>
</xs:complexType>
```

<AudioRequirements> Definition

The <AudioRequirements> definition inherits the attributes of the base <Requirements> class and has no additional attributes. The <AudioRequirements> definition contains the AudioPathPropertyDescriptor child elements.

XML Schema Definition

```
<xs:element name=“AudioRequirements”>
  <xs:complexType>
    <xs:complexContent>
      <xs:extension base=“CRequirements”>
        <xs:sequence minOccurs=“0” maxOccurs=“unbounded”>
          <xs:element ref=“AudioPathPropertyDescriptor”
minOccurs=“0” maxOccurs=“1”/>
        </xs:sequence>
      </xs:extension>
    </xs:complexContent>
  </xs:complexType>
</xs:element>
```

<ImageRequirements> Definition

The <ImageRequirements> definition inherits the attributes of the base <Requirements> class and has no additional attributes. The <ImageRequirements> definition contains the following child elements: ImagePathPropertyDescriptor and StringPropertyDescriptor

### EXAMPLE

| <ImageRequirements> | |
|---|---|
| <ImagePathPropertyDescriptor | |
| attrName | = “src” |
| displayLabel | = “Team Photo” |
| use | = “required” |
| /> | |
| <StringPropertyDescriptor | |
| attrName | = “caption” |
| maxLength | = “32” |
| displayLabel | = “Team photo name” |
| description | = “Team photo name.” |
| use | = “optional” |

/>
</ImageRequirements>

XML Schema Definition

```
<xs:element name=“ImageRequirements”>
  <xs:complexType>
    <xs:complexContent>
      <xs:extension base=“CRequirements”>
        <xs:sequence minOccurs=“0” maxOccurs=“unbounded”>
          <xs:element ref=“ImagePathPropertyDescriptor”
minOccurs=“0” maxOccurs=“1”/>
          <xs:element ref=“StringPropertyDescriptor” minOccurs=“0”
maxOccurs=“unbounded”/>
        </xs:sequence>
      </xs:extension>
    </xs:complexContent>
  </xs:complexType>
</xs:element>
```

<TextRequirements> Definition

The <TextRequirements> definition inherits the attributes of the base <Requirements> class and has no additional attributes. The <TextRequirements> definition contains the StringPropertyDescriptor child element.

### EXAMPLE

| <TextRequirements | |
|---|---|
| refId = “DVD_TITLE” | |
| > | |
| <StringPropertyDescriptor | |
| attrName | = “caption” |
| maxLength | = “30” |
| pattern | = “%s” |
| label | = “DVD Title” |
| shortDescription | = “Title presented on DVD menu.” |
| defaultValue | = “Legacy” |
| use | = “optional” |

/>
</TextRequirements>

XML Schema Definition

```
<xs:element name=“TextRequirements”>
  <xs:complexType>
    <xs:complexContent>
      <xs:extension base=“CRequirements”>
        <xs:sequence minOccurs=“0” maxOccurs=“unbounded”>
          <xs:element ref=“StringPropertyDescriptor” minOccurs=“0”
            maxOccurs=“unbounded”/>
        </xs:sequence>
      </xs:extension>
    </xs:complexContent>
  </xs:complexType>
</xs:element>
```

<VideoRequirements> Definition

The <VideoRequirements> definition inherits the attributes of the base <Requirements> class and has no additional attributes. The <VideoRequirements> definition contains the following child elements: VideoPathPropertyDescriptor and StringropertyDescriptor.

XML Schema Definition

```
<xs:element name=“VideoRequirements”>
  <xs:complexType>
    <xs:complexContent>
      <xs:extension base=“CRequirements”>
        <xs:sequence minOccurs=“0” maxOccurs=“unbounded”>
          <xs:element ref=“VideoPathPropertyDescriptor”
          minOccurs=“0”
            maxOccurs=“1”/>
          <xs:element ref=“StringPropertyDescriptor” minOccurs=“0”
            maxOccurs=“unbounded”/>
        </xs:sequence>
      </xs:extension>
    </xs:complexContent>
  </xs:complexType>
</xs:element>
```

<SceneRequirements> Definition

The <SceneRequirements> definition inherits the attributes of the base <Requirements> class, as well as the following additional attributes:

| | | | |
|---|---|---|---|
| Attribute | Type | Default | Description |

| | |
|---|---|
| qcard | amom:imagePath |

The <SceneRequirements> definition contains the following child elements: AudioRequirements, ImageRequirements, TextRequirement, VideoRequirements and StringPropertyDescriptor.

### EXAMPLE

| <SceneRequirements> | |
|---|---|
| <ImageRequirements> | |
| <ImagePathPropertyDescriptor | |
| attrName | = “src” |
| displayLabel | = “Player photo” |
| use | = “required” |
| /> | |
| <StringPropertyDescriptor | |
| attrName | = “title” |
| displayLabel | = “Player name” |
| maxLength | = “64” |
| use | = “optional” |
| /> | |
| <StringPropertyDescriptor | |
| attrName | = “comments” |
| displayLabel | = “Player position” |
| maxLength | = “64” |
| use | = “optional” |
| /> | |
| </ImageRequirements> | |
| <ImageRequirements> | |
| <ImagePathPropertyDescriptor | |
| attrName | = “src” |
| displayLabel | = “Action photo #1” |
| use | = “required” |
| /> | |
| </ImageRequirements> | |
| <ImageRequirements> | |
| <ImagePathPropertyDescriptor | |
| attrName | = “src” |
| displayLabel | = “Action photo #2” |
| use | = “required” |

```
    />
  </ImageRequirements>
</SceneRequirements>
```

XML Schema Definition

```
<xs:element name=“SceneRequirements”>
  <xs:complexType>
    <xs:complexContent>
      <xs:extension base=“CRequirements”>
        <xs:sequence minOccurs=“0” maxOccurs=“unbounded”>
          <xs:element ref=“AudioRequirements” minOccurs=“0”
            maxOccurs=“unbounded”/>
          <xs:element ref=“ImageRequirements” minOccurs=“0”
            maxOccurs=“unbounded”/>
          <xs:element ref=“TextRequirements” minOccurs=“0”
            maxOccurs=“unbounded”/>
          <xs:element ref=“VideoRequirements” minOccurs=“0”
            maxOccurs=“unbounded”/>
          <xs:element ref=“StringPropertyDescriptor” minOccurs=“0”
            maxOccurs=“unbounded”/>
        </xs:sequence>
        <xs:attribute name=“qcard” type=“imagePath” use=“optional”/>
      </xs:extension>
    </xs:complexContent>
  </xs:complexType>
</xs:element>
```

<SeriesRequirements> Definition

The <SeriesRequirements> definition inherits the attributes of the base <Requirements> class, as well as the following additional attributes:

| | | | |
|---|---|---|---|
| Attribute | Type | Default | Description |

| | |
|---|---|
| minOccurs | xs:nonNegativeInteger |
| maxOccurs | xs:nonNegativeInteger |
| seriesType | amom:seriesType |

The <SeriesRequirements> definition contains the following child elements: AudioRequirements, ImageRequirements, TextRequirements, VideoRequirements and StringPropertyDescriptor.

### EXAMPLE

| <SeriesRequirements | |
|---|---|
| minOccurs | = “1” |
| maxOccurs | = “25” |
| seriesType | = “sequential” |
| > | |

| <SceneRequirements> | |
|---|---|
| <ImageRequirements> | |
| <ImagePathPropertyDescriptor | |
| attrName | = “src” |
| displayLabel | = “Player photo” |
| use | = “required” |
| /> | |
| <StringPropertyDescriptor | |
| attrName | = “title” |
| displayLabel | = “Player name” |
| maxLength | = “64” |
| use | = “optional” |
| /> | |
| <StringPropertyDescriptor | |
| attrName | = “comments” |
| displayLabel | = “Player position” |
| maxLength | = “64” |
| use | = “optional” |
| /> | |
| </ImageRequirements> | |
| <ImageRequirements> | |
| <ImagePathPropertyDescriptor | |
| attrName | = “src” |
| displayLabel | = “Action photo #1” |
| use | = “required” |
| /> | |
| </ImageRequirements> | |
| <ImageRequirements> | |
| <ImagePathPropertyDescriptor | |
| attrName | = “src” |
| displayLabel | = “Action photo #2” |
| use | = “required” |

```
      />
    </ImageRequirements>
  </SceneRequirements>
</SeriesRequirements>
```

XML Schema Definition

```
<xs:element name=“SeriesRequirements”>
  <xs:complexType>
    <xs:complexContent>
      <xs:extension base=“CRequirements”>
        <xs:sequence minOccurs=“0” maxOccurs=“unbounded”>
            <xs:element ref=“AudioRequirements” minOccurs=“0”
              maxOccurs=“unbounded”/>
            <xs:element ref=“ImageRequirements” minOccurs=“0”
              maxOccurs=“unbounded”/>
            <xs:element ref=“TextRequirements” minOccurs=“0”
              maxOccurs=“unbounded”/>
            <xs:element ref=“VideoRequirements” minOccurs=“0”
              maxOccurs=“unbounded”/>
            <xs:element ref=“SceneRequirements” minOccurs=“0”
              maxOccurs=“unbounded”/>
        </xs:sequence>
        <xs:attribute name=“minOccurs” type=“xs:nonNegativeInteger”
          use=“optional”/>
        <xs:attribute name=“maxOccurs” type=“xs:nonNegativeInteger”
          use=“optional”/>
        <xs:attribute name=“seriesType” type=“seriesType”
          use=“required”/>
      </xs:extension>
    </xs:complexContent>
  </xs:complexType>
</xs:element>
```

<PresentationRequirements> Definition

The <PresentationRequirements> definition inherits the attributes of the base <Requirements> class, as well as the following additional attributes:

| | | | |
|---|---|---|---|
| Attribute | Type | Default | Description |

| | |
|---|---|
| src | amom:xmlPath |

The <PresentationRequirements> definition contains the following child elements: AudioRequirements, ImageRequirements, TextRequirements, VideoRequirements, SceneRequirements and StringPropertyDescriptor.

### EXAMPLE

<PresentationRequirements

| | |
|---|---|
| xmlns | = “http://www.sequoiamg.com” |
| xmlns:xsi | = “http://www.w3.org/2001/XMLSchema-instance” |
| xsi:schemaLocation | = “http://www.sequoiamg.com ../../requirements.xsd” |
| title | = “Legacy” |
| description | = “100 photo version of the legacy presentation.” |

| | |
|---|---|
| src | = “http://www. sequoiamg.com/BPserverMedia/Legacy/Legacy.xml” |
| thumbnail | = “http://www.sequoiamg.com/BPServerMedia/Legacy/Legacy.jpg” |

```
  >
  <SeriesRequirements
```

| | |
|---|---|
| minOccurs | = “40” |
| maxOccurs | = “100” |
| seriesType | = “sequential” |

```
    >
    <ImageRequirements>
      <ImagePathPropertyDescriptor
```

| | |
|---|---|
| attrName | = “src” |
| displayLabel | = “Photo” |
| use | = “required” |

```
      />
      <StringPropertyDescriptor
```

| | |
|---|---|
| attrName | = “caption” |
| maxLength | = “32” |
| displayLabel | = “Photo caption” |
| description | = “Caption for this photo.” |
| use | = “optional” |

```
      />
    </ImageRequirements>
  </SeriesRequirements>
</PresentationRequirements>
```

XML Schema Definition

```
<xs:element name=“PresentationRequirements”>
  <xs:complexType>
    <xs:complexContent>
      <xs:extension base=“CRequirements”>
        <xs:sequence minOccurs=“0” maxOccurs=“unbounded”>
          <xs:element ref=“StringPropertyDescriptor” minOccurs=“0”
            maxOccurs=“unbounded”/>
          <xs:element ref=“AudioRequirements” minOccurs=“0”
            maxOccurs=“unbounded”/>
          <xs:element ref=“ImageRequirements” minOccurs=“0”
            maxOccurs=“unbounded”/>
          <xs:element ref =“TextRequirements” minOccurs=“0”
            maxOccurs=“unbounded”/>
          <xs:element ref=“VideoRequirements” minOccurs=“0”
            maxOccurs =“unbounded”/>
          <xs:element ref=“SeriesRequirements” minOccurs=“0”
            maxOccurs=“unbounded”/>
        </xs:sequence>
        <xs:attribute name=“src” type=“xmlPath” use=“required”/>
      </xs:extension>
    </xs:complexContent>
  </xs:complexType>
</xs:element>
```

<PresentationOption> Definition

The <PresentationOption> definition inherits the attributes of the base <Option> class and has no additional attributes.

### EXAMPLE

<PresentationOption

| | |
|---|---|
| title | = “Legacy” |
| description | = “100 photo version of the legacy presentation.” |
| requirements | = “http://www.sequoiamg.com/BPServerMedia/ |

Legacy/Legacy-Requirements.xml”

| | |
|---|---|
| thumbnail | = “http://www.sequoiamg.com/BPServerMedia/Legacy/ |
| Legacy.jpg” | |
| use | = “required” |
| /> | |

XML Schema Definition

```
<xs:element name=“PresentationOption”>
  <xs:complexType>
    <xs:complexContent>
      <xs:extension base=“COption”>
      </xs:extension>
    </xs:complexContent>
  </xs:complexType>
</xs:element>
```

<ProductionRequirements> Definition

The <ProductionRequirements> definition inherits the attributes of the base <Requirements> class, as well as the following additional attributes:

| | | | |
|---|---|---|---|
| Attribute | Type | Default | Description |

| | |
|---|---|
| src | amom:xmlPath |
| minPresentations | xs:nonNegativeInteger |
| maxPresentations | xs:nonNegativeInteger |

The <ProductionRequirements> definition contains the following child elements: AudioRequirements, ImageRequirements, TextRequirements, VideoRequirements, StringPropertyDescriptor, PathPropertyDescriptor and PresentationOption.

### EXAMPLE

<ProductionRequirements

| | |
|---|---|
| xmlns | = “http://www.sequoiamg.com” |
| xmlns:xsi | = “http://www.w3.org/2001/XMLSchema-instance” |
| xsi:schemaLocation | = “http://www.sequoiamg.com ../../requirements.xsd” |
| title | = “Legacy” |
| description | = “100 photo version of the legacy presentation.” |
| src | = “http://www.sequoiamg.com/BPserverMedia/Legacy/ |
| DVD-Legacy.xml” | |
| thumbnail | = “http://www.sequoiamg.com/BPServerMedia/Legacy/ |
| DVD-Legacy.jpg” | |
| minPresentations | = “1” |
| maxPresentations | = “1” |
| > | |

<PresentationOption

| | |
|---|---|
| title | = “Legacy” |
| description | = “100 photo version of the legacy presentation.” |
| requirements | = “http://www.sequoiamg.com/BPServerMedia/Legacy/ |

Legacy-Requirements.xml”

| | |
|---|---|
| thumbnail | = “http://www.sequoiamg.com/BPServerMedia/Legacy/ |

Legacy.jpg”

| | |
|---|---|
| use | = “required” |

/>
</ProductionRequirements>

XML Schema Definition

```
<xs:element name=“PresentationRequirements”>
  <xs:complexType>
    <xs:complexContent>
      <xs:extension base=“CRequirements”>
        <xs:sequence minOccurs=“0” maxOccurs=“unbounded”>
          <xs:element ref=“StringPropertyDescriptor” minOccurs=“0”
            maxOccurs=“unbounded”/>
          <xs:element ref=“AudioRequirements” minOccurs=“0”
            maxOccurs=“unbounded”/>
          <xs:element ref=“ImageRequirements” minOccurs=“0”
            maxOccurs=“unbounded”/>
          <xs:element ref=“TextRequirements” minOccurs=“0”
            maxOccurs=“unbounded”/>
          <xs:element ref=“VideoRequirements” minOccurs=“0”
            maxOccurs=“unbounded”/>
          <xs:element ref=“SeriesRequirements” minOccurs=“0”
            maxOccurs=“unbounded”/>
        </xs:sequence>
        <xs:attribute name=“src” type=“xmlPath” use=“required”/>
      </xs:extension>
    </xs:complexContent>
  </xs:complexType>
</xs:element>
```

<ProductionOption> Definition

The <ProductionOption> definition inherits the attributes of the base <Option> class and has no additional attributes.

XML Schema Definition

```
<xs:element name=“ProductionOption”>
  <xs:complexType>
    <xs:complexContent>
      <xs:extension base=“COption”>
      </xs:extension>
    </xs:complexContent>
  </xs:complexType>
</xs:element>
```

<PackageOptions> Definition

The <PackageOptions> definition inherits the attributes of the base <Options> class and has no additional attributes. The <PackageOptions> definition contains the following child elements: ProductionOption and PresentationOption.

### EXAMPLE

<PackageOptions

| | |
|---|---|
| title | = “SMG Instant Movie” |
| thumbnail | = “www.sequoiamg.com/SMGServerMedia/aVinci |
| | Logo.jpg” |
| xlink | = “www.sequoiamg.com/SMG-InstantMovie.xml” |
| > | |

XML Schema Definition

```
<xs:element name=“PackageOptions”>
  <xs:complexType>
    <xs:complexContent>
      <xs:extension base=“COptions”>
        <xs:sequence minOccurs=“0” maxOccurs=“unbounded”>
          <xs:element ref=“ProductionOption” minOccurs=“0”
            maxOccurs=“unbounded”/>
          <xs:element ref=“PresentationOption” minOccurs=“0”
            maxOccurs=“unbounded”/>
        </xs:sequence>
      </xs:extension>
    </xs:complexContent>
  </xs:complexType>
</xs:element>
```

Use of an Exemplary Product

To use the exemplary product, a user must first install any required software. For example, if the product requires DirectX 9.0c technology, the computer receiving the product must have a video card and drivers that support it. The product may produce an error message if any requirements are not found to be met.

The exemplary product is stored to a compact disc that contains all the applications, storyboards, and related materials needed to create standard DVDs. The product may be installed through the use of standard installation tools, which may be available with an operating system. The user may select the location of the files installed to his computer. The exemplary product may also be supplied in demo, typical, custom or other configurations selectable by the user. Patches may also be supplied for the product. A product as described herein may be distributed on a DVD, or any other convenient media format.

The exemplary product may be exeucted from the command line, for example “MovieMagic+package “D:\Jobs\621009\MM Sample—Basic.xml”” to automatically burn a DVD from an “MM Sample—Basic.xml” file. In that example, the product bypasses the first two steps of the operation and proceeds directly to the render/burn dialog. When the render/burn process is complete, it may creates a DVD VIDEO_TS and AUDIO_TS image, creates intermediate render/burn files, creates a ReportLog.xml file are placed in the default or specified Client-Media directory, and the application may terminate.

In the exemplary product the file SMG-ReportLog.xml is generated anytime a burn process is completed. The contents of the SMG-ReportLog.xml typically contain a success indicator, such as the following:

<!-- SMG-ReportLog.xml -->
<LogData
status = “Success”
/>

The exemplary product also has a debug mode, invocable from the command line with the “+debug” option. The debug option displays a debug screen permitting the following actions:

| Option | Action |
|---|---|
| Storyboard Icon | Click an icon to select it or |
| | double-click it to preview |
| | the spin-up and DVD-Menu. |
| Selection Box | Click to check it. |
| Type of production to burn | Check the value for accuracy. |
| Next button | Click “Next” to advance a screen. |
| Cancel Button | Click “Cancel” to terminate the application. |

Preview individual components that make up the final DVD (Spin-up, DVD Navigator, Movie Presentation, Picture Show Presentation, and Credits) before the encoding and burn process begins. The following preview options are available in the exemplary product:

| Option | Action |
|---|---|
| Movie Magic | Double-click the Movie Magic Spinup |
| Spinup | icon to preview the DVD spin-up |
| DVD Menu | Verify the DVD Menu icon appears. |
| | To preview it, double-click the |
| | storyboard icon on the previous screen. |
| Production icon | Double-click the production icon to |
| | preview the storyboard with user |
| | media. |
| Credits | Double-click the Credits icon to preview |
| | storyboard credits. |
| Picture Show | Double-click the Picture Show icon to |
| | preview storyboard credits. |
| Next Button | Click “Next” to advance a screen and launch |
| | the render/burn process. |
| Back Button | Click “Back” to go back a screen. |
| Cancel Button | Click “Cancel” to terminate the application |
| | and prevent the render/burn process. |

By default, the exemplary product overwrites encoded files from previous sessions during the current encoding process. This means if files exist from a previous session and the path settings do not change, the product overwrites any existing files on subsequent sessions.

Sometimes changes between sessions are very minor and do not impact all components. For example, maybe a name was left out of the credits section by accident. It is much faster to simply re-encode the credits section without re-encoding all five components (spinup, DVD-Menu, Presentation, Picture Show and Credits).

A “-cleanup” option at the command-line may be used to maintain current and past intermediate configurations. This option may be used to save past intermediate files, for example if a user doesn't want clean versions encoded. For example, if it is desired to make minor modifications to a presentation, this option may be used to encode a new presentation file without re-encoding its associated spinup, menu navigator, picture show, and credits sections.

The exemplary product adds a Multimedia Extension to the W3C XML core specifications that define DVD productions with Movie presentations. That product reserves the namespace SMG for all of its element tags but adheres to all the standard definitions and rules of XML XSD file layouts. There are over 50 elements and 100 attributes defined by the SMG extension, but only a few appear in this document. Further description of the particular organization and definition of this extension are not necessary beyond what is described herein.

High-level product XML files define the presentation and operation of DVDs. The overall structure contains a root Package or Production, one DVD Production containing one or many Movie Presentations, and optionally, one Component containing original multimedia files to be saved on the DVD. The following illustrates nesting for a basic package:

```
<!-- COPYRIGHT -->
<Package>
  <!-- (1) Production -->
  <Production>
        ...
    <!-- (1a) Menu additions/modifications -->
    <!-- (1b) Presentation additions/modifications -->
    <!-- (1c) Media specifications -->
    </Production>
</Package>
```

XML encoding samples may also be used to specify or alter the default behavior and output of the exemplary product. In the following examples, two separate productions are specified.

```
<!-- SPECIFICATION FOR LEGACY -->
<Package>
  <!-- (1) Production -->
  <Production
      src = “&bplegacy;\DVD-Legacy.xml”
      burnFormat = “VIDEOTS-NTSC”
      >
    ...
  </Production>
</Package>
<!-- SPECIFICATION FOR CHRISTMAS -->
<Package>
  <!-- (1) Production -->
  <Production
      src = “&bpchristmas\Christmas\DVD-christmas.xml”
      >
    ...
  </Production>
</Package>
```

In the example above, src specifies the name of the associated layout used during DVD creation. Naming conventions typically base the XML file name on the production name (e.g., DVD—Legacy.xml for Legacy, DVD—Christmas.xml for Christmas, etc.). (Note: the xml entities bplegacy and bpchristmas are used for convenience in this notation.

Create a DVD with User Media

The following example (MM-Basic.xml) shows a simple package with a job and client media specification.

| <?xml version=“1.0” encoding=“UTF-8”?> | |
|---|---|
| <!DOCTYPE Package SYSTEM “../../entities.dtd”> | |
| <Package | |
| xmlns | = “&smg;” |
| xmlns:xsi | = “&xsi;” |
| xsi:schemaLocation | = “&smg; ../../amom.xsd” |

| > | |
|---|---|
| <!-- Specify the production --> | |
| <Production | |
| src | = “&bplegacy;\DVD-Legacy.xml” |
| > | |
| <!-- Specify the client media --> | |
| <DropData | |
| type | = “Directory” |
| src | = “D:\Jobs\621009\JPEG” |

```
    />
  </Production>
</Package>
```

The following table describes elements of the structure above:

| Section | Purpose |
|---|---|
| Copyright | Included at the top of the .XML file and required for all |
| | namespace .XML files. |
| Package | The package contains all elements of the DVD creation, |
| | including the type of productions to burn, the destination |
| | of the VIDEO_TS and AUDIO_TS images, |
| | and the ReportLog.xml file. |
| Production | Identifies the name and location of the DVD production. |
| | These are encoded and provided by a vendor either in |
| | the SMGServerMedia or BPServerMedia. |
| DropData | Identifies the directory where client photos and videos |
| | reside. This is typically based on the SMGClient path. |
| | The identification of this DropData item must be contained |
| | within the outer Production XML element. |

Change Output Media Types and Destinations

The following code snippet (MMSample-Destination.xml) shows a package with an alternative ISO/VIDEO_TS and AUDIO_TS output destination and alternative burn format. The default output format is NTSC and the default output destination is based on the user's login documents directory. Add the dst and burnFormat attributes to the Production element to change these defaults:

| <Production | |
|---|---|
| src | = “&bplegacy;\DVD-Legacy.xml” |
| dst | = “D:\Jobs\621009” |
| burnFormat | = “ISO-PAL” |
| > | |
| <!-- Specify the client media --> | |
| <DropData | |
| type | = “Directory” |
| src | = “D:\Jobs\621009\JPEG” |

/>
</Production>

It maybe noted that for the above, the client machine may perform the intermediate work, but the final ISO/VIDEO_TS and AUDIO_TS images can reside on other servers or machine paths. Additionally, the dst attribute may be specified within the Production, rather than the Package. The product may automatically creates the destination directory if it does not already exist. The burnFormat attribute within the Production may be specified with any of the following options:

| Option | Output |
|---|---|
| VIDEOTS-NTSC | Creates a VIDEO_TS and AUDIO_TS image on the |
| | defined or default dst path in NTSC format. |
| VIDEOTS-PAL | Creates a VIDEO_TS and AUDIO_TS image on the |
| | defined or default dst path in PAL format. |
| ISO-NTSC | Creates an ISO image named DVDImage.iso on the |
| | defined or default dst path in NTSC format. |
| ISO-PAL | Creates an ISO image named DVDImage.iso on the |
| | defined or default dst path in PAL format. |
| DVD-NTSC | Creates a VIDEO_TS and AUDIO_TS image on the |
| | defined or default dst path in NTSC format. It then |
| | burns the files to the user selected device and deletes |
| | the image files. |
| DVD-PAL | Creates a VIDEO_TS and AUDIO_TS image on the |
| | defined or default dst path in PAL format. It then |
| | burns the files to the user selected device and deletes |
| | the image files. |
| No burnFormat | Defaults to NTSC (or other regional standard). No |
| setting in the file. | ISO/VIDEO TS and AUDIO TS files output when |
| | using the default setting. |

Change the Report Log Name and Destination

The exemplary product generates a report log each time it completes a production run. The default location for the report log is the user's documents directory. The default report-log name is SMG-ReportLog.xml. To change the report log name and destination, add a reportSrc tag for the production and specify a report log destination path and file name. The following example (MMSample-ReportLog.xml) shows a package with a specified report output directory:

<Production

| | |
|---|---|
| src | = “%BPServerMedia%\Legacy\DVD-Legacy.xml” |
| dst | = “S:\Development\621009” |

| | |
|---|---|
| burnFormat | = “VIDEOTS-PAL” |
| reportSrc | = “D:\Jobs\621009\SMG-ReportLog.xml” |

```
  >
  <!-- Specify the client media -->
  <DropData
```

| | |
|---|---|
| type | = “Directory” |
| src | = “D:\Jobs\621009\JPEG” |
| /> | |

</Production>

Change Default DVD Titles and Captions

The exemplary product allows changes to default DVD and Credit information for all productions. The following attributes apply:

| Option | Output |
|---|---|
| DVD_TITLE | The DVD title text appears on the DVD's main menu page. |
| | The default text for this field is based on the type of DVD |
| | production. For example, the default DVD Title for |
| | Legacy-Garden is “Legacy” |
| DVD_PRODUCER | The Producer text appears when the DVD spins up. It |
| | appears with the phrase “presents.” The default Producer |
| | text is “Big Planet.” |
| DVD_CAST_TITLE | The Cast title that appears above the cast credits lines. The |
| | default Cast title is “Cast and Crew.” |
| DVD_CAST | The Cast text appears toward the end of the presentation. It |
| | contains names of participants credited on the DVD. The |
| | maximum number of credit lines is 20. End each name |
| | with a new line character ‘\n’. The default cast information |
| | is blank |
| PRESENTATION_TITLE | The presentation title text appears at the end of the opening |
| | credits. The default text for this field is based on the type |
| | of DVD production.. For example, the default Presentation |
| | Title for Legacy-Garden is “Legacy” |
| PRESENTATION_DIRECTOR | The Director text appears at the front of a presentation. It |
| | appears with the phrase “a film by.” The default Director |
| | text is “Movie Magic.” |

The following example (MMSample-ChangeData.xml) shows a product package with changed DVD information.

| <Production | |
|---|---|
| src | = “&bplegacy;\DVD-Legacy.xml” |
| > | |

| <!-- Override Values --> | |
|---|---|
| <TextData | |
| refId | = “DVD_TITLE” |
| caption | = “Brett Paulsen” |
| /> | |
| <TextData | |
| refId | = “DVD_PRODUCER” |
| caption | = “SequoiaMG” |
| /> | |
| <TextData | |
| refId | = “DVD_DIRECTOR” |
| caption | = “Chett and Richard Paulsen” |
| /> | |
| <TextData | |
| refId | = “DVD_CAST_TITLE” |
| caption | = “Paulsen Family Members” |
| /> | |
| <TextData | |
| refId | = “DVD_CAST” |
| caption | = “Brett and |

| Kathy\n\nChett\nMori\nRichard\nTodd\nEdward” | |
|---|---|
| /> | |
| <!-- Specify the client media --> | |
| <DropData | |
| type | = “Directory” |
| src | = “D:\Jobs\621009\JPEG” |
| /> | |

</Production>

Creating Advanced XML Files

Each Production typically contains 5 major components, which are (1) a Spinup, (2) the Main DVD Navigator, (3) one or more Presentations (e.g., Legacy, Life Event, Soccer, Volleyball, Christmas), (4) a Picture Show Slide Show Presentation and (5) A Credits Presentation. This remainder of this section describes various advanced XML features associated with DVD configurations.

Change Picture Show Music

The exemplary product allows changes to the default music track associated with Picture Show pesentations, either in a standalone Picture Show Production, or a Production containing a Picture Show Presentation. The following attribute applies:

| Option | Output |
|---|---|
| PICTURESHOW_AUDIO | The music encoded with the Picture |
| | Show presentation. The default attribute/ |
| | music track for this field is |
| | “&bpmedia;\PictureShow\Audio\Omni\Omni |
| | 149 Track 4-4-17.mp3”. |

The following example (MMSample—PictureShow1.xml, MMSample—PictureShow2.xml) shows Picture Show and Movie Magic packages with attributes to change the Picture Show music track:

| <Production | |
|---|---|
| src | = “&bppictureshow;\DVD-PictureShow.xml” |

| > | |
|---|---|
| <!-- Change the default music --> | |
| <AudioData | |
| refId | = “PICTURESHOW_AUDIO” |
| src | = “D:\Jobs\621009\Still Holding Out For You.wav” |
| /> | |
| <!-- Specify the client media --> | |
| <DropData | |
| type | = “Directory” |
| src | = “D:\Jobs\621009\JPEG” |
| /> | |
| </Production> | |
| <Production | |

| | |
|---|---|
| src | = “&bplegacy;\DVD-Legacy.xml” |
| > | |

| <!-- Change the default music --> | |
|---|---|
| <AudioData | |
| refId | = “PICTURESHOW_AUDIO” |
| src | = “D:\Jobs\621009\Still Holding Out For You.wav” |
| /> | |
| <!-- Specify the client media --> | |
| <DropData | |
| type | = “Directory” |
| src | = “D:\Jobs\621009\JPEG” |
| /> | |
| </Production> | |

Change a DVD Presentation

Change presentations by specifying a ChangeData parameter inside the DVD configuration. Here are two examples (MM Sample—ChangePresentation1.xml, MMSample—ChangePresentation2.xml) illustrating how to replace the default main presentations for Soccer and Volleyball with a higher-impact, but photo scripted versions of their respective presentations:

| <Production | |
|---|---|
| src | = “&bpsoccer;\DVD-Roster.xml” |
| > | |
| <!-- Specify the presentation replacement --> | |
| <PresentationData | |
| refId | = “PRESENTATION1” |
| src | = “&bpsoccer;\Roster.xml” |

| /> | |
|---|---|
| <!-- Specify the client media --> | |
| <DropData | |
| type | = “Directory” |
| src | = “D:\Jobs\621009\JPEG” |
| /> | |
| </Production> | |
| <Production | |

| | |
|---|---|
| src | = “&bpvolleyball;\DVD-Roster.xml” |
| > | |

| <!-- Change the presentations and associated titles --> | |
|---|---|
| <PresentationData | |
| refId | = “PRESENTATION2” |
| src | = “&bpvolleyball;\Highlights.xml” |
| /> | |
| <TextData | |
| refId | = “PRESENTATION1/TITLE” |
| caption | = “Roster” |
| /> | |
| <TextData | |
| refId | = “PRESENTATION2/TITLE” |
| caption | = “Highlights” |
| /> | |
| <!-- Specify the client media --> | |
| <DropData | |
| type | = “Directory” |
| src | = “D:\Jobs\621009\JPEG” |
| /> | |
| </Production> | |

Specify User Data for DVDs with Multiple Presentations

The exemplary product allows the user to associate multiple directories with presentations. Here is an example (MM Sample—DropMultiple.xml) illustrating multiple DropData elements:

| <Production | |
|---|---|
| src = “&bpsoccer;\DVD-Roster.xml” | |
| > | |
| <!-- Specify the client media --> | |
| <DropData | |
| type | = “Directory” |
| refId | = “SOCCER_ROSTER” |
| src | = “D:\Jobs\621009\Roster” |
| /> | |
| <DropData | |
| type | = “Directory” |
| refId | = “PICTURESHOW” |
| src | = “D:\Jobs\621009\Highlights” |
| /> | |
| </Production> | |

Each DropData element must contain a type field in a “Directory” type specification. This tells the production that the drop media resides in a directory on the operating system. The refId field contains the field identification associated with each presentation. The exact name is given with each DVD construct. The src field specifies the media base directory where the media is resident. Notice, each DropData may have a common root directory, but should contain unique drop directories based on the Presentation requirements.

In addition to the DropData specifications, users must prepare User Media when the storyboard requires captions, titles, or additional information. Individual Presentation QueCards specify the type of information required for a given DVD construction.

The file's meta-data contains most media's information. To associate meta data information to a user photos, (1) Right-click the photo's thumbnail (on Windows XP), (2) Click the Summary tab inside the Properties dialog and (3) select and edit the following fields:

| Field | Data |
|---|---|
| Title | Type associated text. For sports storyboards this is |
| | usually the player name. |
| Comments | Type associated text. For sports storyboards this is |
| | usually the player's position. |

Production Requirements XML Files

The basic concept when determining what type of information and data to associate with a storyboard is to obtain a storyboard requirements xml file. This file will always contain the ProductionRequirements as the root element, and will typically have several sub requirement information elements (Text, Image, Video, Scene, etc.) that describes the type of data that can either be used to populate a presentation, or to change information associated with a presentation. For instance, the following requirements are associated with the Legacy production:

<ProductionRequirements

| | |
|---|---|
| xmlns | = “&smg;” |
| xmlns:xsi | = “&xsi;” |
| xsi:schemaLocation | = “&smg; ../../requirements.xsd” |
| title | = “DVD - Legacy” |
| description | = “Legacy Production” |
| thumbnail | = “&bplegacy;\DVD-Legacy.jpg” |
| xlink | = “&bplegacy;\DVD-Legacy.xml” |

```
  >
  <!-- DVD INFORMATION -->
  <TextRequirements
```

| | |
|---|---|
| refId | = “DVD_TITLE” |
| use | = “optional” |

```
    >
    <StringPropertyDescriptor
```

| | |
|---|---|
| attrName | = “caption” |
| maxLength | = “32” |
| displayLabel | = “DVD Title” |
| description | = “Title for the main DVD navigator.” |
| defaultValue | = “Legacy” |
| use | = “optional” |

```
    />
  </TextRequirements>
  <TextRequirements
```

| | |
|---|---|
| refId | = “DVD_PRODUCER” |
| use | = “optional” |

```
    >
    <StringPropertyDescriptor
```

| | |
|---|---|
| attrName | = “caption” |
| maxLength | = “32” |
| displayLabel | = “Producer” |
| description | = “Name of person who is producing |
| the DVD.” | |
| defaultValue | = “Big Planet” |
| use | = “optional” |

```
    />
  </TextRequirements>
  <AudioRequirements
```

| | |
|---|---|
| refId | = “PICTURESHOW_AUDIO” |
| use | = “optional” |

```
    >
    <AudioPathPropertyDescriptor
```

| | |
|---|---|
| attrName | = “src” |
| displayLabel | = “Picture Show Music” |
| description | = “Music for the Picture Show presentation.” |
| defaultValue | = “&bppictureshow;\Audio\Omni\Omni |
| 149 Track 4-4-17.mp3” | |
| use | = “optional” |
| /> | |

```
  </AudioRequirements>
  <TextRequirements
```

| | |
|---|---|
| refId | = “DVD_CAST_TITLE” |
| use | = “optional” |
| > | |

<StringPropertyDescriptor

| | |
|---|---|
| attrName | = “caption” |
| maxLength | = “32” |
| displayLabel | = “Cast Title” |
| description | = “Title for the credits.” |
| defaultValue | = “Cast and Crew” |
| use | = “optional” |

```
    />
  </TextRequirements>
  <TextRequirements
```

| | |
|---|---|
| refId | = “DVD_CAST” |
| use | = “optional” |

```
    >
    <StringPropertyDescriptor
```

| | |
|---|---|
| attrName | = “caption” |
| maxLength | = “1024” |
| displayLabel | = “Cast” |
| description | = “Name of person presented on the DVD.” |
| defaultValue | = “ ” |
| use | = “optional” |

```
    />
  </TextRequirements>
  <!-- PRESENTATION INFORMATION -->
  <TextRequirements
```

| | |
|---|---|
| refId | = “PRESENTATION_TITLE” |
| use | = “optional” |

```
    >
    <StringPropertyDescriptor
```

| | |
|---|---|
| attrName | = “caption” |
| maxLength | = “32” |
| displayLabel | = “Presentation Title” |
| description | = “Title for the presentation.” |
| defaultValue | = “Legacy” |
| use | = “optional” |

```
    />
  </TextRequirements>
  <TextRequirements
```

| | |
|---|---|
| refId | = “PRESENTATION_DIRECTOR” |
| use | = “optional” |

```
    >
    <StringPropertyDescriptor
```

| | |
|---|---|
| attrName | = “caption” |
| maxLength | = “32” |
| displayLabel | = “Director” |
| description | = “Name of person who created the |
| presentation” | |
| defaultValue | = “Movie Magic” |
| use | = “optional” |

```
    />
  </TextRequirements>
  <ImageRequirements
```

| | |
|---|---|
| minOccurs | = “40” |
| maxOccurs | = “100” |
| seriesType | = “sequential” |
| use | = “required” |

```
    >
    <ImagePathPropertyDescriptor
```

| | |
|---|---|
| attrName | = “src” |
| displayLabel | = “Photo” |
| use | = “required” |

```
    />
    <StringPropertyDescriptor
```

| | |
|---|---|
| attrName | = “caption” |
| maxLength | = “32” |
| displayLabel | = “Photo caption” |
| description | = “Caption for this photo.” |
| use | = “optional” |

```
    />
  </ImageRequirements>
</ProductionRequirements>
```

In the example above, ProductionRequirements gives pertinent information associated with the presentation. Xlink specifies the location of the underlying production's xml file. This link should be used to specify the src attribute of the constructed Production xml file (see below). TextRequirements contains several elements that describe how to change the DVD or main presentation's title or related information. AudioRequirements specifies the default music associated with the Picture Show presentation. ImageRequirements describes the type of media that can be used to populate the Legacy storyboard. In this case, the repeatable item is an Image, which may have between 40 and 100 occurrences. Anytime a Requirement specifies a minOccurs and maxOccurs value, the returning data should be encapsulated within a DropData element.

Requirements XML files cannot be used to produce a DVD image, rather, they describe the type of data that should be returned to the product renderer. For instance, the following is a typical response where information is filled in for a legacy presentation:

| | |
|---|---|
| <Production | |
| xmlns | = “&smg;” |
| xmlns:xsi | = “&xsi;” |
| xsi:schemaLocation | = “&smg; ../../amom.xsd” |
| src | = “&bplegacy;\DVD-Legacy.xml” |
| burnFormat | = “VIDEOTS-NTSC” |
| copies | = “5” |
| > | |
| <TextData | |
| refId | = “PRESENTATION_TITLE” |
| caption | = “Our Family Legacy” |
| /> | |
| <TextData | |
| refId | = “PRESENTATION_DIRECTOR” |
| caption | = “Movie Magic” |
| /> | |
| <DropData> | |
| <ImageData | |
| src | = “d:\MovieMagic\Media\001.jpg” |
| caption | = “Photo 1” |
| /> | |
| <ImageData | |
| src | = “d:\MovieMagic\Media\002.jpg” |
| caption | = “Photo 2” |
| /> | |
| <ImageData | |
| src | = “d:\MovieMagic\Media\003.jpg” |
| caption | = “Photo 3” |
| /> | |
| <ImageData | |
| src | = “d:\MovieMagic\Media\004.jpg” |
| caption | = “Photo 4” |
| /> | |
| <ImageData | |
| src | = “d:\MovieMagic\Media\005.jpg” |
| caption | = “Photo 5” |
| /> | |
| . . . | |
| </DropData> | |
| </Production> | |

In the above example, Production specifies that a production is to be rendered and burned. The exemplary product accepts both Production and Package root elements in return XML files. src gives the location of the requested production to be burned. This value is obtained from the ProductionRequirements xlink attribute. The burnFormat and copies fields specify the burn format and number of DVD copies to produce. This information is not specified in the Requirements document and should be pre-defined by the controlling Order Entry system. TextData specifies alternate entries for the presentations Title and Director. The attributes refId and caption are obtained from the received ProductionRequirements XML file. DropData specifies the media to be used when populating the Legacy Production. Information in the ImageData structure should conform to the specifications received in the ProductionRequirements XML file.

Requirement and Property types

In the exemplary product, the following document type definition (DTD) and XML Schema (XSD) files are required when reading XML files that have a PresentationRequirements root element: requirements.xsd, properties.xsd, types.xsd and entities.dtd. In addition, presentation and data responses should have a Presentation root element and conform to the schema definitions contained in the following files: composites.xsd, scenes.xsd, primitives.xsd and data.xsd.

While systems and methods for producing multimedia utilizing presentation templates and/or multimedia object models have been described and illustrated in conjunction with a number of specific configurations and methods, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

1. A computing system for producing multimedia productions, comprising:
a computing system, said computing system including a processor;
at least one storage device; and
computer executable instructions stored to said storage devices, said instructions executable by said processor to perform the functions of:
(i) acquiring multimedia objects,
(ii) creating base element definitions for the acquired multimedia objects,
(iii) presenting to the user a set of presentation templates organized by category or theme, each of said presentation templates defining slots for user media, special effects, backgrounds, and captions,
(iv) receiving from a user a presentation template selection from the presented presentation templates,
(v) receiving from a user directions for organizing the acquired multimedia objects into the selected presentation template, said directions including the insertion of the acquired multimedia objects or related context into the user media slots of the selected presentation template,
(vi) receiving from a user a selection for a media format,
(vii) determining a production associated with the media format,
(viii) rendering a multimedia production, said rendering combining the acquired multimedia objects, directed organization, production and types of the selected presentation template, and
(ix) fixating the multimedia production to media.

2. A multimedia production computing system according to claim 1, wherein the set of presentation templates is organized in a tree structure, and wherein said instructions are further executable by said computing system to perform the function of presenting the set of presentation templates by guided navigation.

3. A multimedia production computing system according to claim 1, wherein said presentation templates further define element palettes, and further whereby said rendering utilizes the element palettes.

4. A multimedia production computing system according to claim 1, wherein said instructions are further executable by said computing system to perform the function of presenting a representation of a resulting multimedia production prior to rendering, and wherein the presenting applies the definitions of the selected presentation template.

5. A multimedia production computing system according to claim 1, wherein said instructions are further executable by said computing system to perform the function of organizing base elements into advanced elements by composition.

6. A multimedia production computing system according to claim 1, wherein said instructions are further executable by said computing system to perform the function of sharing media components with a plurality of users, and wherein the sharing considers sharing privileges.

7. A set of computer readable media containing computer instructions for operating a multimedia production computing system, the set of computer readable media comprising at least one medium upon which is stored the computer instructions executable by a computing system to achieve the functions of:
(i) acquiring multimedia objects,
(ii) creating base element definitions for the acquired multimedia objects,
(iii) presenting to the user a set of presentation templates organized by category or theme, each of said presentation templates defining slots for user media, special effects, backgrounds, and captions,
(iv) receiving from a user a presentation template selection from the presented presentation templates,
(v) receiving from a user directions for organizing the acquired multimedia objects into the selected presentation template, said directions including the insertion of the acquired multimedia objects or related context into the user media slots of the selected presentation template,
(vi) receiving from a user a selection for a media format,
(vii) determining a production associated with the media format,
(viii) rendering a multimedia production, said rendering combining the acquired multimedia objects, directed organization, production and types of the selected presentation template, and
(ix) fixating the multimedia production to media.

8. A set of computer readable media according to claim 7, wherein the set of presentation templates is organized in a tree structure, and wherein said instructions are further executable by said computing system to perform the function of presenting the set of presentation templates by guided navigation.

9. A set of computer readable media according to claim 7, wherein said presentation templates further define element palettes, and further whereby said rendering utilizes the element palettes.

10. A set of computer readable media according to claim 7, wherein said instructions are further executable by said computing system to perform the function of presenting a representation of a resulting multimedia production prior to rendering, and wherein the presenting applies the definitions of the selected presentation template.

11. A set of computer readable media according to claim 7, wherein said instructions are further executable by said computing system to perform the function of organizing base elements into advanced elements by composition.

12. A set of computer readable media according to claim 7, wherein said instructions are further executable by said computing system to perform the function of sharing media components with a plurality of users, and wherein the sharing considers sharing privileges.

13. A method for producing multimedia productions, comprising the steps of:
acquiring multimedia objects;
creating base element definitions for the acquired multimedia objects;
presenting to the user a set of presentation templates organized by category or theme, each of said presentation templates defining slots for user media, special effects, backgrounds, and captions;
receiving from a user a presentation template selection from the presented presentation templates;
receiving from a user directions for organizing the acquired multimedia objects into the selected presentation template, said directions including the insertion of the acquired multimedia objects or related context into the user media slots of the selected presentation template;
receiving from a user a selection for a media format;
determining a production associated with the media format;
rendering a multimedia production, said rendering combining the acquired multimedia objects, directed organization, production and types of the selected presentation template; and
fixating the multimedia production to media.

14. A method according to claim 13, wherein the set of presentation templates is organized in a tree structure, and wherein said the presenting of said set of presentation templates is by guided navigation.

15. A method according to claim 13, wherein the presentation templates further define element palettes, and further whereby said rendering utilizes the element palettes.

16. A method according to claim 13, further comprising the step of presenting a representation of a resulting multimedia production prior to rendering, wherein said presenting applies the definitions of the selected presentation template.

17. A method according to claim 13, further comprising the step of organizing base elements into advanced elements by composition.

18. A method according to claim 13, further comprising the step of sharing media components with a plurality of users, and wherein said sharing considers sharing privileges.
